(19) United States
(12) Patent Application Publication
(10) Pub. No.: US 2026/0112346 A1
(43) Pub. Date: Apr. 23, 2026

(54) SYSTEMS, METHODS, AND APPARATUSES FOR SYSTEMATICALLY GENERATING SKILL ADAPTED MUSICAL ARRANGEMENTS ON A PER-USER BASIS OF A COMMON MUSICAL PIECE FOR THE COLLECTIVE PERFORMANCE BY THE USERS AS AN AD-HOC BAND

(71) Applicants: Colin Van Tuyl JOHNSON, Menlo Park, CA (US); Christopher Alan CAMOZZI, Menlo Park, CA (US)

(72) Inventors: Colin Van Tuyl JOHNSON, Menlo Park, CA (US); Christopher Alan CAMOZZI, Menlo Park, CA (US)

(21) Appl. No.: 19/429,123

(22) Filed: Dec. 22, 2025

Related U.S. Application Data
(63) Continuation-in-part of application No. 18/126,324, filed on Mar. 24, 2023.
(60) Provisional application No. 63/323,426, filed on Mar. 24, 2022.

(51) Int. Cl. G10H 1/00; G09B 15/02; G10G 1/04; G10H 1/46

(52) U.S. Cl. CPC G10H 1/0025; G10G 1/04; G10H 1/46; G09B 15/023; G10H 2210/081; G10H 2210/091; G10H 2210/111

(57) ABSTRACT

Audio inputs receive in real time a live session of a plurality of a series of sounds produced by a respective plurality of musical instruments or human voices. One or more processors execute instructions to receive in real time the live session, select a respective level of musical difficulty of the piece of music for the plurality of the series of sounds produced by the musical instruments or human voices, adapt in real time the plurality of the series of sounds according to the selected level of musical difficulty of the piece of music, and orchestrate in real time the adapted plurality of the series of sounds into a musical arrangement. An audio output transmits in real time the musical arrangement.

### CLAIM OF PRIORITY

This continuation-in-part patent application claims priority to non-provisional U.S. Utility patent application Ser. No. 18/126,324, filed Mar. 24, 2023, having Attorney Docket No. 38183.602, entitled “SYSTEMS, METHODS, AND APPARATUSES FOR SYSTEMATICALLY GENERATING SKILL ADAPTED MUSICAL ARRANGEMENTS ON A PER-USER BASIS OF A COMMON MUSICAL PIECE FOR THE COLLECTIVE PERFORMANCE BY THE USERS AS AN AD-HOC BAND”, which claims priority to the U.S. Provisional Patent Application No. 63/323,426, entitled “SYSTEMS, METHODS, AND APPARATUSES FOR IMPLEMENTING “THE BAND INDABOX” AS A PLATFORM TO MAKE MUSIC CREATION (ALONE OR IN GROUPS) MORE ACCESSIBLE TO NOVICE LEVEL PARTICIPANTS,” filed Mar. 24, 2022, having Attorney Docket No. 38183.602P, the entire contents of which is incorporated herein by reference as though set forth in full.

### COPYRIGHT NOTICE

This document contains material that is subject to copyright protection. The copyright owner has no objection to the facsimile reproduction by anyone of the document, as it appears in the Patent and Trademark Office records, but otherwise reserves all copyright rights whatsoever.

### TECHNICAL FIELD

Embodiments disclosed herein relate generally to the field of music enrichment/education and computer aided enhancement of musical performances. More particularly, disclosed embodiments relate to systematically generating skill adapted musical arrangements on a per-user basis of a common musical piece for the collective performance by the users as an ad-hoc band.

### BACKGROUND

Most people do not participate in bands or play music in a group. The experience is typically reserved for those musicians who have paid their dues and achieved a high degree of proficiency. The road to becoming a proficient musician is often seen as difficult and lonely, and as a result, most do not pursue it. It has been said that 10% of people can play an instrument, but 80% wish they could. Even fewer than that 10% play music with friends or family. Most people fail to achieve the social, emotional, and psychological benefits of playing music with other people.

What is needed is a system configurable to recognize, learn, and adapt to varying levels of music-playing proficiency of users (musicians) participating in playing a musical piece.

The present state of the art may therefore benefit from the systems, methods, and apparatuses for systematically generating skill adapted musical arrangements on a per-user basis of a musical piece for the collective performance by the users as an ad-hoc band, as described herein.

### BRIEF DESCRIPTION OF THE DRAWINGS

Embodiments are illustrated by way of example, and not by way of limitation, and will be more fully understood with reference to the following detailed description when considered in connection with the figures in which:

FIG. 1 depicts an exemplary architecture 100 of the “Band Karaoke” music platform, in accordance with described embodiments.

FIG. 2A depicts another exemplary architecture 200 of the “Band Karaoke” music platform, in accordance with described embodiments.

FIG. 2B depicts another exemplary architecture 201 of the “Band Karaoke” music platform, in accordance with described embodiments.

FIG. 2C depicts exemplary users of the “Band Karaoke” music platform 299 illustrating different people, the instrument each individual chooses to play, an optional profile for each individual, a skill rating of each player's proficiency in relation to a given instrument, and a catalog of songs, in accordance with described embodiments.

FIG. 2D depicts an exemplary function of the “Band Karaoke” platform that mixes all parameters related to a given song that, when modified in concert with every participating player, creates a best fit modification of the given song for that group of players, in accordance with described embodiments.

FIG. 2E depicts an exemplary customization of the display for each player on each instrument, in accordance with the described embodiments.

FIG. 2F depicts an exemplary interface of the “Band Karaoke Platform,” in accordance with described embodiments.

FIG. 2G depicts an exemplary method of starting a band session through an exemplary interface in a scenario where one member of the band administers the system on behalf of the group of players, in accordance with described embodiments.

FIG. 2H depicts an exemplary interface for the system, in accordance with described embodiments.

FIG. 3 depicts another exemplary architecture 300 of the “Band Karaoke” music platform, in accordance with described embodiments.

FIG. 4 depicts another exemplary architecture 400 of “Band Karaoke” as a music platform, in accordance with described embodiments.

FIGS. 5A, 5B, 5C, 6, 7, 8, 9, and 10 depict additional exemplary architectures and components of the “Band Karaoke” music platform, in accordance with described embodiments.

FIG. 11 illustrates a diagrammatic representation of a machine 1101 in the exemplary form of a computer system, in accordance with one embodiment.

FIG. 12 depicts a flow diagram illustrating a method 1200 for implementing “Band Karaoke” as a platform to make music creation (alone or in groups) more accessible to novice level participants, in accordance with disclosed embodiments.

FIGS. 13A, 13B, 13C, 13D, 13E, 13F, 13G, 13H, 13I, and 13J describe the logic of music accessibility and the various components employed by the Band Karaoke Platform 299.

FIG. 14 depicts an exemplary process for practicing the logic of the Band Karaoke Platform 299 with a focus on steps 1205 and 1210 (of FIG. 12) to determine which modifications of a particular song/piece of music are needed for the members of a given band session, in accordance with the described embodiments.

FIGS. 15A, 15B and 15C depict an exemplary breakdown of the keys and constituent chords of one song (“Try” by Colbie Caillat) for an exemplary set of core instruments of a band: vocal, rhythm guitar, keyboards, bass and drums, in accordance with described embodiments.

FIG. 16 depicts an exemplary variety of scenarios where the players of a given band session have varying levels of proficiency across different instruments, in accordance with described embodiments.

FIGS. 17, 18, 19, 21, 23, 25, 27, 29, 31, 33, 35, and 37 enumerate the Scenario letter and description of the scenario characteristics. Each example instrument is listed and next to it is also noted the example levels of proficiency of the players playing those instruments in the given band session.

FIGS. 20A, 20B, 20C, 22A, 22B, 22C, 24A, 24B, 24C, 26A, 26B, 26C, 28A, 28B, 28C, 30A, 30B, 30C, 32A, 32B, 32C, 34A, 34B, 34C, 36A, 36B, 36C, 38A, 38B, and 38C are also each specific to a given scenario (C through I) and provide a visual to the commentary given in the preceding figure.

FIG. 39 depicts an exemplary illustration of how fully produced songs are comprised of separate stems for each part, in accordance with described embodiments.

### DETAILED DESCRIPTION

Disclosed herein in a computer-implemented method and system performed by a Band Karaoke Platform (“platform”) that automatically creates custom arrangements of music on the fly (e.g., in real time) according to the proficiency of the specific band members (without requiring the generation of new arrangements of music) via which to make all the parts easy, intermediate or expert, as needed. The platform automatically adjusts the music for all band members dynamically, instrument by instrument, to find the intersection point where everyone participating can comfortably play alongside each other, even if the players are of varying levels of proficiency-some expert and some beginners (e.g., similar to the manner in which a skilled arranger/composer would be able to manually rewrite each part of a song to match the skill level of the players of each instrument, but this is painstaking, time-consuming, and impractical for a real time experience). The platform may automatically modify and present notation (e.g., instructions) to match the preference of each player of the band, even if every member of the band wants a method of notation that is distinct from the notation used by every other member of the band without requiring the participants to adapt to a one-size fits all approach in which the same notation method is utilized for all parts. The platform may automatically serve instructions for a single song to multiple players at the same time to allow synchronized musical performance as opposed to prior techniques in which consumer music apps serve music notation to individual musicians without synchronizing with other musicians in the performance of a given song. The platform may modify all the parts/stems of a song through key changes, transpositions, arrangements, use of assistive technology, etc., to create a set of accompanying music that complies with the custom arrangement assembled for the particular band members/players of a given session, and thus allowing for the seamless mix of player performance and original music for all parts to create a coherent performance in real time that sounds great as opposed to prior known consumer music apps that allow transposition or key changes that do not adjust the originally recorded music to match the new arrangement or which modify/adjust the originally recorded music with a change in key, etc., but do so only on a player-by-player basis and not as a coherent arrangement for all members of the band.

Described embodiments enable even early learners to experience being “in the band.” Rather than requiring would-be band members to become proficient using conventional instruments and meet standards of musical proficiency, the described embodiments open the door for early learners to comfortably participate in the band by automatically finding the intersection point of every band member's proficiency, and then providing them with the tools to mix their playing into a recording of the original performance and filling in any missing or sub-par band parts so that every performance sounds fully produced and enjoyable to hear. This encourages players to play more. This transforms the experience of music for most people from passive listening to active participation.

The described innovations and in particular, the use of the computer-implemented “Band Karaoke” Platform 299, operate to fast-track each player's sense of belonging to the band, and provide access to the experience of the joy of making music together with other people.

One inventor observes that after a career as a professional musician, he repeatedly sees musicians bonding for life with other musicians with whom they perform. “Music is more fun with friends,” said one musician. In an age of increasing digital isolation, Band Karaoke is an activity that families and friends can share together. With frequent use, players passively become proficient musicians as they have fun without having to “pay their dues” in the conventional sense of painfully practicing their instrument as so many did growing up. Furthermore, Band Karaoke creates an open invitation to join. If one family member starts playing in the living room, other family members or friends can easily walk up and join in subtly expanding the regular joy of playing music together. The contribution to society will be vast if greater numbers of people receive a regular dose of the endorphins that come with performing in the band.

In the following description, numerous specific details are set forth such as examples of specific systems, languages, components, etc., to provide a thorough understanding of the various embodiments. It will be apparent, however, to one skilled in the art that these specific details need not be employed to practice the disclosed embodiments. In other instances, well-known materials or methods have not been described in detail to avoid unnecessarily obscuring the disclosed embodiments.

In addition to various hardware components depicted in the figures and described herein, embodiments further include various operations which are described below. The operations described in accordance with such embodiments may be performed by hardware components or may be embodied in machine-executable instructions, which may be used to cause a general-purpose or special-purpose processor programmed with instructions to perform the operations. Alternatively, the operations may be performed by a combination of hardware and software, including software instructions that perform the operations described herein via memory and one or more processors of a computing platform.

Embodiments also relate to a system or apparatus for performing the operations herein. The disclosed system or apparatus may be specially constructed for the required purposes, or it may use a general-purpose computer selectively activated or reconfigured by a computer program stored in the computer. Such a computer program may be stored in a non-transitory computer readable storage medium, such as, but not limited to, any type of disk including, optical disks, flash, NAND, solid state drives (SSDs), CD-ROMs, and magnetic-optical disks, read-only memories (ROMs), random access memories (RAMs), EPROMs, EEPROMs, magnetic or optical cards, or any type of media suitable for storing non-transitory electronic instructions, each coupled to a computer system bus. In one embodiment, a non-transitory computer readable storage medium having instructions stored thereon, causes one or more processors to perform the methods and operations which are described herein. In another embodiment, the instructions to perform such methods and operations are stored upon a non-transitory computer readable medium for later execution.

The algorithms and displays presented herein are not inherently related to any particular computer or other apparatus nor are embodiments described with reference to any particular programming language. It will be appreciated that a variety of programming languages may be used to implement the teachings of the embodiments as described herein.

According to the described embodiments, the computer-implemented “Band Karaoke” Platform 299, as described in detail below, provides core functionality entirely absent from the known art of record. To be clear, there is no system known today which provides real-time user skill adapted musical arrangements. Moreover, no system known today incorporates assistive aids such as system directed use of a capo or system constrained player demands, such as eliminating more difficult notes, skills, chords, etc., much less a system which performs these functions and permits an ad-hoc band of users with differing skill sets to engage in a “jam session” together, be it for mere enjoyment or for the production of a musical performance for later refinement and playback.

According to the embodiments set forth herein, the “Band Karaoke” Platform 299 provides at least the following capabilities (not all are required for an embodiment):
1) The “Band Karaoke” Platform defines a group of individuals as being in the same session so that its synchronizing system works for each member in the session together with all the other members of the session, while accounting for each individual's instrument (including vocals) as well.
2) The “Band Karaoke” Platform synchronizes its interface(s) across multiple individuals (operating as members of the ad-hoc band) who each have chosen an instrument for a given session.
3) The “Band Karaoke” Platform tracks each individual's level of proficiency on the instrument they have chosen to play during a given session and keeps track of each player's proficiency changes. Instruments selected may be physical (e.g., real) or virtual (e.g., simulated), and when physical, an instrument can also be characterized by an assistive technology that is added to the instrument to simplify its operation, thus adapting that physical instrument to the skill set or proficiency of the user having selected it for the given session. For example, a capo may be applied to a guitar.
4) The “Band Karaoke” Platform coordinates and orchestrates the arrangement of the music (together and for each player) so that each member's part works together with the whole, while at the same time, reflecting the individual's player's level of proficiency for that physical (e.g., real) or virtual (e.g., simulated) instrument.
5) The “Band Karaoke” Platform modifies musical arrangements to adapt or tailor them to match a player's proficiency while at the same time coordinating with and being compatible with the other players'levels of proficiency, for instance, by finding the best fit modifications across what every player needs given their skills.
6) The “Band Karaoke” Platform displays a custom arrangement according to each individual player's preference, using a preferred presentation of the many ways to represent and notate musical arrangements, such as classic clef, Tablature, key or fret diagrams, colors, etc., with different presentation formats simultaneously adapted to each of the individual members of the ad-hoc band for that session. For instance, each member may see a different notation format or may be presented an overlapping format with different complexity adapted to that unique player's skill set.
7) The “Band Karaoke” Platform plays the original recording of each instrument/part louder or softer in the overall mix according to each individual's preference so that the ensemble always sounds good collectively as a band, even if a given player is scarcely able to play the simplest arrangement.
8) The “Band Karaoke” Platform provides the ability for players to pair the system with physical instruments (or instrument-like input devices) or use virtual instruments (e.g., synthesized digital representations of instruments or simplifications of instruments) that are part of the interface or are separately attached.

The Experience: The “Band Karaoke” Platform with the above characteristics and the technical capabilities which are described in greater detail below, allow a group of people to sit down and play music together, even if they are just beginners or complete novices playing physical instruments or for participants that are playing on virtual or simulated instruments. Even children and those having no musical expertise whatsoever, can join in a musical rendition through the use of user-adapted musical arrangements generated by the system which require no prior knowledge of musical notation whatsoever, for instance, utilizing colors, positional key mappings, or even pictures of animals or other simplistic icons which are easily recognizable by children and may then be intuitively corresponded to a key position, timing, or other required action by the child or novice player.

Conversely, for players that are highly proficient musicians, the system's interface will generate more customary and sophisticated nation for those experienced players, which thus allows them to fully perform their part as a proficient musician ordinarily would. Notably, however, for players that are not skilled, the system's interface gives those inexperienced players the ability to “participate” in the music performance with more experienced players by giving those inexperienced players much simpler ways to make sound that is complimentary to the final performance, despite potentially having vastly different experience levels. To be very clear, this means that an inexperienced player can participate in a rendition of the same song and at the same time as a more experienced player who is also playing the same song at the same time. The sounds of the less experienced player (though perhaps having less depth and range) will mix and harmonize with the sounds produced by the more experienced player, thus resulting in a cohesive rendition of the musical performance, but also providing a fun experience for all players involved regardless of their experience level with a given musical instrument.

The experience of “participating” is key to the enjoyment had by all players because the final product (the performance) gives the group of individuals who are in the session together the sensation of creating that product/performance together. This joint endeavor cultivates a sense of emotional connection and belonging among the members. From this positive emotional experience, a secondary benefit of this system is that individuals may cultivate a personal interest to further their study of music. There are endless pre-existing ways in which an individual can study music. Nonetheless, the “Band Karaoke” Platform provides a nearly universal gateway into any or all these training systems. The “Band Karaoke” Platform is differentiated from those training systems, however, as no prior platform provides the ability for users having vastly different levels of experience to jointly participate in a musical performance (e.g., a jam session) such as described in greater detail below, through the systematic generation of skill adapted musical arrangements, generated by the system on a per-user basis for a common musical piece, and for the collective performance by the users as an ad-hoc band.

Hardware: The hardware provided by the “Band Karaoke” Platform also play a part in the benefits yielded by the overall system. According to certain embodiments, the system resides within a physical hub that each physical instrument is plugged into, and it is the centralized physical hub which then performs the tracking of each individual's proficiency per instrument, performs the modifications to each part's arrangement, and further provides the output display to each individual member, regardless of whether this output is to a personal screen such as a smart phone or tablet or is projected to a larger common screen shared by the participants. In yet other embodiments, the system performs the same functions alluded to above and described in greater detail below, except that some of the functioning of the system is distributed across devices, with multiple user-devices such as mobile computing or electronic devices, smart phones, tablets, or PCs, that each display and receive user input, thus permitting the various band players to interact with the system to authenticate, load profile data, provide configuration data (e.g., such as proficiency levels) and then receive via an output display to the personal device, skill adapted musical arrangements generated by the system specific to that user's proficiency on a specific instrument.

The described embodiments enable the system to interact with each player individually, in which each player has a personal device that both displays the instructions to the individual and receives that individual's input. In certain embodiments, the device may be used as the instrument itself, providing a simulated digital representation of an instrument, and thus inputs received are not only configuration information for the system, but also inputs to create sound from the virtualized digital representation of the instrument. In other embodiments, a physical instrument is played and the personal device uses its microphone as an audio capture device to pick up the sounds created by that player's rendition on their particular instrument, and then the sound is mixed with other players instrument stems or sounds. In variations of these embodiments, the “Band Karaoke” Platform monitors sounds produced by each player's individual instrument, thus tracking multiple stems on a per-player or per-instrument basis via the corresponding player's personal computing device, however, the system performs no mixing or manipulation of the stems themselves, allowing the live performance to simply be limited to the sounds produced by the instruments. However, even in the absence of active stem manipulation or mixing, the system will continue to monitor the stems produced by the individual players and update profile data for those players, such as proficiency with given keys, chords, skills, songs, instruments, etc., in which case this information will inform future sessions by the same player as the system will have a deeper knowledge base of that individual player's range of expertise and skills.

A song stem, or simply, a stem, is an individual musical element that, when layered together with other stems, creates a complete song. A stem can include single instruments, like a snare drum or bass line, or a collection of multiple elements combined as one track, such as vocal harmonies. Stems are useful in the disclosed embodiments as they allow for more flexibility in mixing and editing, enabling the disclosed embodiments to work with specific parts of a track. For example, a drum stem would include all drum parts mixed together into a single file.

Stems can be a type of audio file that breaks down a complete track into individual mixes. This allows the disclosed embodiments to control each of the particular mixes for a production. Stems tend to break down into four tracks, usually covering the melody, instruments, bass, and drums. When the song stems are played simultaneously, without any changes, the track should sound like a finished version—or at least as close as can be. This is why the disclosed embodiments may use music stems when creating a musical arrangement for a session. It's a manageable format to work with.

According to yet another embodiment of the “Band Karaoke” Platform, the system distributes computing across a plurality of mobile devices using a mobile app which is linked amongst the players via a common code, key, social media, common WiFi, or other techniques permitting each of the devices to collectively recognize one another. With such a mobile device-only group experience, or one that mixes and matches players with physical instruments and with other players using their phones for both display and virtual digital instrument input, each of the individuals using their personal device for both a display and input received from an physical instrument, then the personal device may either receive input from the physical instrument through a wired connection or through a wireless connection, or alternatively, simply by listening for the audio signal from the instrument via an audio capture device (e.g., microphone) of the player's personal mobile device. Stated more simply, players having the app running and linked for a band session can either play a digital representation of their instrument on their phone, or play a physical instrument which is hardwired to the phone via a cable or dongle, wirelessly linked to their phone, or the phone may simply use its integrated microphone as an audio pick up to capture the acoustics of the physical instrument. Regardless of how captured, sounds produced by the instrument will be analyzed by the system in terms of timing, intensity, tonal precision, and other metrics via which to assess that player's proficiency and improvements in proficiency over time.

Non-Adaptive Implementation: According to certain embodiments, the “Band Karaoke” Platform may be optionally configured into a non-adaptive mode, in which a simplified variant of the application does not actively listen for the sounds produced by the individual player's instruments. However, even with this non-adaptive configuration, the system still displays user skill-adapted instructions to each individual on a per-instrument and per-user basis to facilitate the group rendition of an ad-hoc band which presumably has players of varying degrees of musical expertise. Thus, rather than measuring a player's proficiency and tracking changes in that player's proficiency automatically over time, the system processes the display of instructions and musical arrangement according to a player-selected difficulty level of the piece of music, such as “beginner to advanced” or degrees of proficiency such as “choosing a number on a scale of 1 to 5” corresponding to the player's self-reported proficiency for a given instrument. For instance, a cloud connected service for which the players subscribe to a paid service may offer enhanced functions including adaptive listening whereas a free or lower-tier subscription service may provide players with only the non-adaptive variant of the same platform, thus having certain paid features restricted from use. In such non-adaptive configurations, if players are using virtual instruments, then the system does not actively track of how accurately the player hit the input in time or the precision of the musical chord or note produced by that player. This may be especially true with a cloud-based subscription model in which the system records the musical rendition and transmits a representation of the player's stem away from the user's personal device and to a remotely located data center for off-device processing and analytics, given that such processing consumes additional resources and incurs a cost. However, with a paid subscription, it may be financially viable to provide these enhanced services (e.g., adaptive listening) for the player.

In yet other embodiments, the “Band Karaoke” Platform may display instructions on a common screen, such as a large family room television screen or via a projector in a karaoke venue. In such cases, the input device may be an instrument (or an instrument with assistive technology attached), a simplified input device that is equivalent to a joystick, or even an interface on a personal device like a smartphone or tablet that displays a digital instrument or instrument simplification. For example, in a larger venue with a common display screen (e.g., a family room TV during a party or a karaoke bar), the “Band Karaoke” Platform can accommodate dozens of participants in the band by having several band members with physical instruments play a rendition while other members in the “audience” themselves become players in the ad-hoc band through the use of synthesized digital representations of instruments which are linked into the “Band Karaoke” Platform via the app, and then their “sounds” by playing the digital representations of instruments are generated by the system and integrated into a common mix which is then projected through the speakers. In such a way, audience members can have an active role in producing sounds as part of live rendition provided by a significantly more experienced band. The sounds of the players on the digital instruments may be complex sounds, such as winds and stringed instruments, or can be simplistic sounds, such as clackers, shakers, ribbed percussion instruments, simple drums, etc.

Coordinating Heterogeneous Integration Platform: While there are other music apps that allow individuals to select music to play and choose a preferred notation style for their own individual playing, there simply is no prior system that accommodates a given group of individuals having differing levels of musical proficiency who want to play together. Conversely, the “Band Karaoke” Platform specifically captures and integrates this information to generate the transformations necessary to permit that group to chose instruments, regardless of whether they have more or less proficiency on those instruments, and then effortlessly receive instructions that are skill-adapted to each individual's needs, so as to permit that individual ad-hoc band member to be a productive contributor to the group experience of participating in the making of the music together.

According to yet other embodiments, the “Band Karaoke” Platform serves as the coordinating layer among multiple separate instances of other music app through a public API, which permits those third-party musical rendition apps to link with the “Band Karaoke” Platform. In such a way, the “Band Karaoke” Platform can operate as an integration layer across separate multiple instances of different music apps. Individual players having profiles on the “Band Karaoke” Platform are tracked over time, capturing those individual's proficiency on a per-instrument basis, and the “Band Karaoke” Platform through the public API further operates to inform the third party apps which modifications to make, and provides instructions via which to synchronize the timing of the music across the separate instances of each app.

OEM Branding of Cross-Functionality: According to other embodiments, the core functionality of the “Band Karaoke” Platform is licensed to third parties for reproduction within their own existing apps or for reproduction as re-branded stand-alone app. For instance, the “Band Karaoke” Platform's functionality may be integrated into the likes of Apple music or Spotify, each of which have existing licensed music catalogs, as well as some limited features to, for example, decrease the volume of the vocals on a pre-existing track, thus permitting users to sing along with songs, without having to sing over the original artist. Such third-party apps greatly benefit from the enhanced and more sophisticated functionality and analytical capabilities of the “Band Karaoke” Platform, such as those described in greater detail below. For instance, if licensed and integrated locally or linked to the “Band Karaoke” Platform via the API, then the functionality of the “Band Karaoke” Platform as described here allow multiple Apple Music users to play the instruments of given songs together even if the participants were of varied skill levels. The digital virtual instruments also allow users to dabble in “participating in the music making” without having physical instruments, until they are ready.

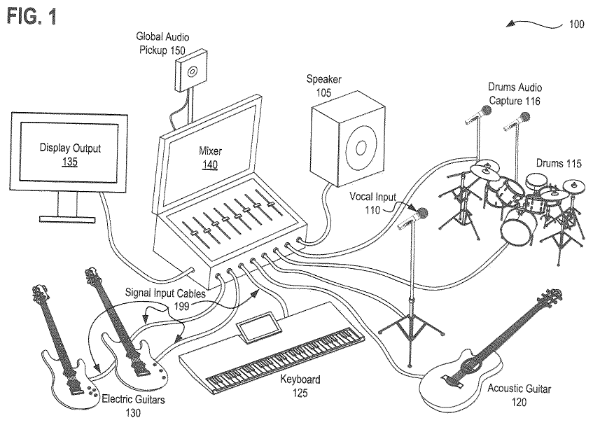

FIG. 1 depicts an exemplary architecture 100 of the “Band Karaoke” music platform, in accordance with described embodiments. The “Band Karaoke” Platform, or simply, Band Karaoke, includes a mixer 140, a display output 135, a global audio pickup 150, a speaker 105, a vocal input (e.g., microphone) 110, a set of one or more electric guitars 130 with respective hard-wired signal input cables 199 into the mixer, a keyboard 125 also having a hardwired signal input cable 199 into the mixer 140, an acoustic guitar 120 which as shown has a hard wired signal input cable 199 into the mixer but may alternatively utilize an analog audio capture device such as a microphone which is then input into the mixer 140, and finally, a set of drums 115 are depicted which lack a direct signal input cable and are thus providing their stem or acoustic sound produced into the mixer 140 via the drums audio capture 116 device, as pictured.

Band Karaoke enables new music learners to play alongside experienced musicians with confidence and fun and rounds out the band.

Band Karaoke acts as conductor, musician and instructor all in one, filling in for any missing band members to always create a fully produced performance, and keeping less experienced members playing along with confidence and fun.

For early learners of all ages, Band Karaoke provides best-fit arrangements that meet them where they are and allows them to confidently play alongside family and friends, even if these band mates are more experienced. For advanced musicians, the Band Karaoke platform fills in for any members of the band who may be missing and makes the band complete.

The described embodiments allow all members to play together with ease is that the solution calculates what modifications are needed to each individual part in order that everyone sounds great together at whatever level of ability they have, and then it makes those adjustments to the music in real time so that they group does not need to make those modifications themselves. Further detail below describes how the orchestration of each individual player's part may need to be modified, transposed, etc., to allow the modifications for the least expert players.

The “Band Karaoke” Platform solution generates and then serves the modified orchestration instructions to every band member as an output instruction to the corresponding band member as part of its core functioning. The “Band Karaoke” Platform can make these dynamic adjustments to the orchestration of the music as the band members change to different songs or as the ad-hoc band re-shuffles the composition of the band members and instruments.

The “Band Karaoke” Platform accommodates these changes by performing analysis as part of initiating each new session and then again, the platform serves these modified instructions up to each band member, accommodating the instrument or part each band member is now currently playing as well as the band member's level of proficiency for that instrument, in near real time, so as to minimize friction or delay for starting each new song.

The “Band Karaoke” Platform operates to give every member the experience of productive contribution to the ensemble and further operates to produce a pleasing musical performance that motivates the members to keep playing music together, consequently resulting in far more than merely a “game” where the players are striving to accrue points by successfully completing video-game-like challenges of dexterity.

Band Karaoke Solution: A hardware hub, digital Artificial Intelligence (AI) technology and a curated song library of band parts gives life to the right instruction for each player. The “Band Karaoke” Platform also processes music files found from any external source (YouTube videos, Apple Music song files, mp3 files, etc.) and reprocesses them into their component parts to deconstruct them and modify and customize them to match each player's level of proficiency.

User Interaction/Game Play: The player profile AI serves to each player the right combination to constructively contribute to a cohesive band performance.

Technology Stack: Camozzi music philosophy, HW hub, personalization, music library of song parts, tutorials, assistive tech and AI.

Features and Functions: The core novel, non-obvious, unique and special hook of Band Karaoke is that it enables a group of people to play music together in a band even if they have varying levels of ability with some or all of the following features and functionality:
1) A device that does a combination of some or all of the following functions:
   a) Either loads songs in a deconstructed format, or deconstructs every song it plays into its component parts (stems),
      i) Either through an automated process
      ii) Or a manual process
   b) Constructs modifications to every part (or at least understands what modifications need to be constructed): creates arrangements, transpositions (key changes), instructions, assistive technology instructions, chord and note adjustments, etc. that make the part easier or more difficult to play to match a player's specific proficiency.
   c) Tracks every user's proficiency for each instrument.
   d) Calculates combinations of modifications to each song part (stem) for a given group of players to intersect at the common domains of proficiency.
      i) Player A—expert bass player
         (1) Serves a complex bass arrangement that is compatible with Player B's modification—i.e. transposed into the same key as the key required by Player B's modification, etc.
      ii) Player B—novice guitar player
         (1) Serves a simplified modification of guitar that may include transpositions into a different key than the original to find easier chords and/or strumming patterns, or that is compatible with an assistive technology like a Chord Buddy that is pre-configured to play only a fixed subset of chords, etc.
         (2) Player B's profile informs the system what aspects of musical play that player can perform, and it modulates its orchestration/modification of its instructions to match (or slightly push) that player's proficiency.
      iii) Remaining players
         (1) This process is repeated for all players present in a given session. The final musical arrangement/modification/orchestration presented to each band member is the one that intersects with every player's level of proficiency, enabling them to effortlessly participate in the band experience simply by following along with the instructions served to them.
      iv) The point is that all players receive personalized instructions that are compatible (for a coherent musical performance) with the other “band” member's personalized instructions, while all supporting their collective performance of a given song.
      v) Early versions of the device allow the players to declare their own level of proficiency (beginner, intermediate, expert, or maybe other gradations). Later versions listen to players'nuanced skills and recommend renditions and part/stem modifications that fit the player's nuanced abilities based on what the system detects the player can perform.
   e) Plays the song while serving up modified instructions to each player that matches their personal proficiency for that specific song (either to a central display or an individual display for each player, or both.) See below for more detail on modified instructions.
   f) Optionally allows the players to adjust the volume of their playing in relation to the volume of the original part (stem) so that the output blends the original part (stem) with their playing of the part in a way that matches their preference.
   g) Optionally allows individual players to use the described functions to play their part accompanied by some or all the underlying stems of the song and optionally create recordings of their performance with or without any of the underlying stems to individually practice and record their performance.
   h) Optionally allows individuals who indicate they are members of the same band session to remotely perform and record their part and then mix any or all parts back together for a recording of their collective performance even though the recordings of each player's part occurred asynchronously.
   i) Optionally mixes all the parts of the song back together into a final fully produced song, where each player's performance is showcased in relation to the original part (stem) to the player's preference (all, nothing, or a blend of original and player's performance) and then combined with all the other parts for the fully produced song. Where active mixing of all the parts is not conducted, ambient performance of each player's part and any combination of the underlying stems for some or all the parts results in an ambient experience of the group's participation of the song that is pleasing to experience even if it is not formally remixed.
   j) Where players are not available to play a given part of a band, the device optionally fills in with the original part (stem) so that every part of the band is mixed into the final performance, and the players who are present in the band (even if it is only 1 or 2 players) sound as though they have all band members present for all parts of the band.
   k) Unlike other ways of encountering music where one must rise to the difficulty of the piece of music to participate in a group performance, Band Karaoke adjusts to each player's level and then backs up that person so that they sound great every time, even as beginners.
   l) Optionally records the audio and/or video of the final produced performance of the band.
   m) Optionally facilitates the sharing of performance recordings through common methods (like sharing on social media, creating CDs, etc.)
   n) Optionally facilitates royalty management of sharing/selling recordings as required by royalty requirements/agreements.
   o) Optionally provides feedback to the band in the form of a score or applause or some other measure to allow the group to compare their abilities to that of other bands performing the same song in some form of rankings that is appropriate for different strata of players of varying levels of proficiency.
   p) Optionally tracks and stores player proficiency and aptitude for current and downstream proficiency matching and generating appropriate instructions for each person.
2) Modifies instructions to each player that matches their proficiency
   a) The format of modifying instructions can be standard, personalized, crowdsourced, curated, customized based on a player's preference, or based on a content creator's preference. Content creators might be the authors of the original song, or someone who has deconstructed a pre-existing song for serving into this system. A content creator might be someone who has an innovative way of deconstructing a song to facilitate new learners' easy performance.
   b) By way of example, the companies that record karaoke tracks for pre-existing songs will record the song anew with their own studio band, recording each instrument and part separately, and then mixing all parts together into a final produced song. By turning off the vocals, they have a mix that singers can sing against with the instrumental karaoke backing. In this case, a karaoke company that provided all the parts separately (stems) into the system is an example of a content creator tailoring their content to comply with the format of the system. Each stem can be adjusted into different keys. The creators can provide alternative arrangements that are easier and harder. They can also add instructions for players to follow.
   c) The format of the instructions might comply with a defined standard or be specific to the content creator's preference. This flexibility allows the system to evolve as content creators, educators and players become increasingly sophisticated in how they prefer to present music to players. With time, content creators might decide that new and different ways/formats of presenting instructions are more effective at supporting learners/players of different/varying levels of proficiency
3) What distinguishes this device from existing audio mixing technology is that:
   a) It calculates and serves the instructions for the music to each player to match the exact abilities of the players so that everyone feels they can participate and contribute productively.
   b) The content (music, parts, modification instructions, etc.) can come from a variety of sources:
      i) A curated library where all the modifications have been pre-crafted by experts
      ii) Auto-generated from computational analysis of music recordings and deconstructed through computational means to enable effective reassembly into part-specific, player-specific instructions for each player.
         (1) Processing of music recordings (found on the internet, uploaded by users, etc.) is auto-generated allowing players to find any recording they want to play, and receive instructions for playing along through the Band Karaoke framework. iii) Crowd-sourced content from a community marketplace
         (1) See below for more detail.
   c) Every music service that enables listeners to hear recorded performances of music will provide the necessary tracks and metadata to all songs so that everyone can play along as they listen. An analog of this functionality is that as of 2021, lyrics (in simple display or karaoke format) are now available for most songs on streaming services like Apple Music and Spotify. In the future, Band Karaoke Platform 299 will enable players or musical recordings or music services of all kinds (like Apple Music, Spotify, etc.) to present instructions out to Band Karaoke-platform-enabled displays or devices that allows a group of people to effortlessly play along (alone or in a group of players—their band) on their own instruments as easily as they can sing along with the lyrics today.
   d) As computational processing speeds increase and connectivity latency decreases, this functionality can be served through the Band Karaoke Platform 299 to displays and devices in real time to give players the ability to play their instruments alongside music that occurs in the ambient environment.
      i) First, this might take the form of a sampling functionality that identifies a song playing on the radio in the same way currently enabled by services similar to Shazam (that will listen through a microphone to a short clip of a song that is playing in the ambient environment) and then match it to the song and artist name and report this to the user. If a known song is identified by the Band Karaoke Platform 299 in this manner, the Band Karaoke-enabled device will detect where, between the start and finish, the song is playing and display at the same time as the ambient song plays the instructions that match a given player's preferences for instrument, modification, assistive technology, etc. This allows the user to play alongside the ambient song with instructions that match their needs. This can be offered to the individual player, or to a group of players who have identified themselves as a band for a given session.
      ii) Later, this as computational processing speed continues to accelerate, the Band Karaoke Platform 299 will generate instructions to the ambient song based on computations and calculations conducted in real time while the ambient song plays. This allows the Band Karaoke Platform 299 to support players interested in participating alongside live performances that have not been pre-recorded or pre-profiled by the Band Karaoke Platform 299.
4) Personalized Player Proficiency Matching Platform
   a) Optionally captures proficiency by capturing and indexing how well a player hits given notes, chords, arrangements, etc.
   b) Optionally allows players to manually self-report their musical proficiency through a variety of means. The variety allows users to find a (or maybe even develop their own) method of rating themselves that works best for them.
   c) Creates a central database of proficiency that can be accessed by all licensees of the platform to allow portability between applications or other systems that support group music creation. (For example, perform well playing in one smart device application to expand one's abilities, and another app will recognize this new proficiency and serve content that reflects the new level.)
   d) The service is application agnostic. It starts with Band Karaoke, but can be integrated into all other apps, services, devices, etc. too. By way of illustration, a couple of examples below illustrate possible applications. This list is exemplary only, not exhaustive nor exclusive.
      i) One application is described herein as Band Karaoke that provides a method for a group of individuals of different musical proficiency to casually join a recreationally band session and participate together in performing a song.
      ii) Another application can be facilitating the key changes across a professional performance of an entire band or orchestra when a subset of the group needs an adjustment to accommodate an area of difficulty in the piece of music. This application may be relevant for orchestras who have a singer who needs accommodation to bring the music within the vocalist's range. If the vocalist has a cold and can't hit a high note, this accommodation may be required on short notice. The Band Karaoke Platform 299 can rapidly adjust all the musicians'notations for a given performance.
      iii) Many other types of applications are possible and contemplated by this invention.
   e) SDK to connect with other tutorial apps or systems to enable their own “band mode.” Includes:
      i) Optional technology that measures player proficiency
      ii) Optional technology that reports out the player proficiency to define what level of part modification matches the proficiency
      iii) Gives licensee app/service/device/etc the ability to leverage the player proficiency info when selecting song parts for each band player to play.
      iv) Gives licensee app/service/device/etc the ability to generate and serve the modified parts/stems as dictated by the proficiency matching platform for each player and then capture and remix all parts and player performances into a fully produced song playout.
      v) Provides metadata on different songs/music that allows the licensee app/service/device/etc to display personalized instructions for each part of every song.
   f) Proficiency data on user accounts managed and maintained by a single standard organization that makes it available to all systems (i.e. app providers) to give users a seamless experience moving from application 1 to application 2, as an example. (Similar to Dolby sound technology licensed and installed on A/V equipment from all manufacturers.)
5) Hub/Box/etc. (Optional)
   a) Optional built-in display screens, and/or leveraging smart device/tablet screens, or larger projection/display devices (i.e. family flat screen TV/projector) as add-on
   b) Optional built-in cameras and microphones, and/or leveraging external devices
   c) Optional built-in speakers or external—both directions—monitor: toward players, and performance: toward audience
   d) Optional headphones option for all players for silent practice, and physical or virtual input devices to adjust the in-ear volume and mix of all parts
   e) Optional ports for all instruments
   f) Optional on/off buttons and mix sliders/knobs for each channel/part
      i) Virtual—digital on a screen only
      ii) Hardware—physical buttons, sliders, knobs
   g) Optional outputs for all ports that connect via wire (to reduce latency) and wirelessly to personal devices that display the synchronized instructions to each player personally for the instrument they've selected.
   h) If using a digital design, the hub/box/etc. optionally uses one or two tablets to provide the full range of required displays and interface controls
   i) Optionally daisy-chains to other hub/box/etc. to expand the number of instruments/parts that can play along in a single session (as may be needed for any band of more than 8 players—add one more for up to a 16 piece band, two more for up to a 24, or add three more for up to a 32 piece band.)
   j) Physical and virtual hubs communicate remotely in different physical locations to allow players who are not in the same physical space to play together using the orchestrations/player proficiency matching platform. This may be less practical or appealing as connection over the internet experiences latency from today's internet connection. It may be more practical and appealing in the future as latency in the network shrinks.
   k) The optional hub may originally be designed and built by Band Karaoke, but its core functionality is licensable to other hardware manufacturers, so that any manufacturer can create devices that support the capability.
   l) As sensor and wireless technology matures, the functionality of the hardware hub may be made available in a virtual capacity as well that connects to instruments wirelessly, rather than through wired connections, or through audio (or some other method of) sensing only. The “hub” may become a function located on a computational chip or other form of processor, rather than in a wired hardware hub.
6) Content Sharing and Publishing Platform
   a) Marketplace
      i) Crowdsourced content from a community marketplace
         (1) Users of the Band Karaoke may create instructions and modifications of their own and share them via a marketplace infrastructure for free or for a fee (on their own compositions/recordings or on those written and/or performed by others).
         (2) Users/content creators who have innovative ideas about how to guide and teach music to new learners can still utilize this platform to publish content using their own particular instruction format. The personalized player proficiency matching platform can still match modifications for each player of a given session and serve it up using the particular instruction format.
         (3) As player proficiency becomes specifically profiled, content creators may offer general or highly-focused instructional content to help players work through their progressive thresholds of learning.
         (4) The format of instructions (prompts, music score, etc.) themselves can be defined by content creators to allow innovation in presentation or pedagogy.
      ii) Expert musicians can contribute suggestions on how to play particular parts of a song/piece of music.
         (1) This can take the form of a musician's own signature styling, fingering, etc.
         (2) Preferred instruction format
         (3) Accompanied by a video tutorial
         (4) Available as an in-home video tutor
         (5) Available as a tutor/instructor on call for a virtual video call and lesson session
   b) Automated generation of the modifications (a la Chordify profiling of a song.)
      i) Auto-generated from computational analysis of music recordings and deconstructed through computational means to enable effective reassembly into part-specific, player-specific instructions for each player.
         (1) Processing of music recordings (found on the internet, uploaded by users, etc.) is auto-generated allowing players to find any recording they want to play, and receive instructions for playing along through the Band Karaoke framework.
         (2) The auto generation of proposed ways to perform different parts of a song can be created to support different levels of proficiency.
   c) Uploaded as part of new content-songs
      i) Music publishers (independent, traditional publishing labels, or other means of publishing and distributing music that have not yet been conceived) can provide a version of a fully produced piece of music, also provide all the individual parts/stems and well as suggestions on logical modifications to each part/stem to support playing along by musicians of differing proficiency.
   d) Available on all music services/apps/devices/etc.
   e) Content creators can use this platform to build and distribute their own preferred teaching/coaching methodology based on the group “play along as a band” music experience.

Band Karaoke Operations and Methodology: Band Karaoke streamlines music play so every participant can be an included member of the band as easily as playing a family board game, productively contributing to the collective performance at a level that is right for each participant's individual skills.

Collaboration and mutual support to perfect the song “wins the game.”

1-8 players, or more with daisy-chained Band Karaoke expansion packs, hubs or virtual configurations that allow as many players to participate as desired.

All the typical instruments for each song (track) comprised of individual recordings for each instrument/part (stem) that makes up a fully produced band that can be dialed up or down to support each player.

As individual player skills grow, they can turn down the recording of the stem for their instrument and perform more of their part independently.

The product of every performance is a fully produced song that is fun to listen to and create, encouraging players to keep playing as their skills grow naturally.

FIG. 1 depicts an exemplary architecture 100 of the “Band Karaoke” music platform, in accordance with the described embodiments;

In this configuration, the hub is the central mixer 140 for all parts of a band. The device contains the recordings of the original stem for every part of any song that is being played. It also provides input jacks for all the instruments the players will use. There may be a separate jack for lead guitar, bass, keyboards, rhythm guitar, drums, vocals, and backup vocals. The sliders indicated on the top of the box are used to adjust the volume of the instruments and the volume of the stems for each song. The inside of the lid may include a display screen that gives the instructions for each instrument according to the modifications dictated by the Band Karaoke Platform 299. In one embodiment, an external monitor can be used to display a larger version of the instructions for the players of the band to reference while playing their instruments. A camera is also connected to record the session. An external speaker is also connected to broadcast the mix of the individual parts for all players and the underlying stems modulated to a volume level that makes the final performance sound like a fully produced song, or sound like whatever mix is pleasing to the players. All these inputs and outputs are optional. Any combination of any subset of these components may be used to deliver the Band Karaoke experience.

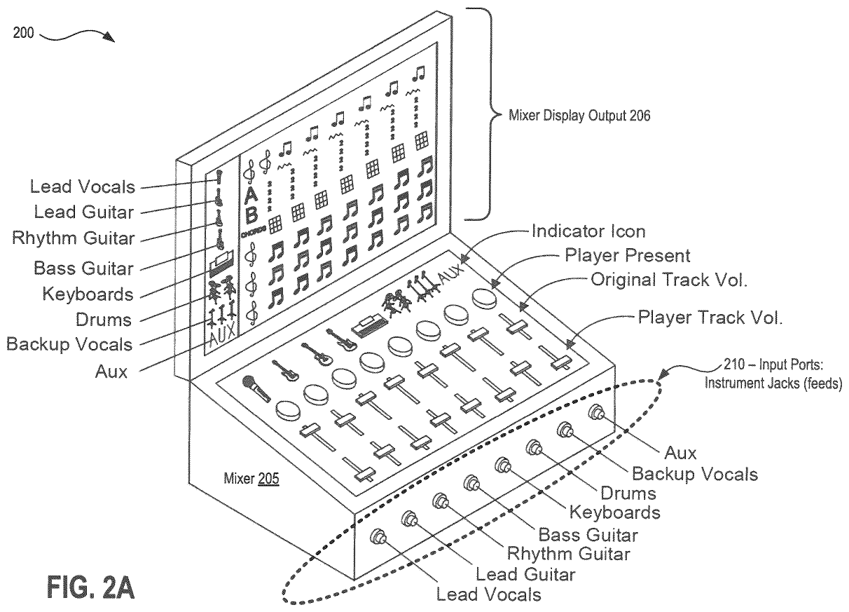

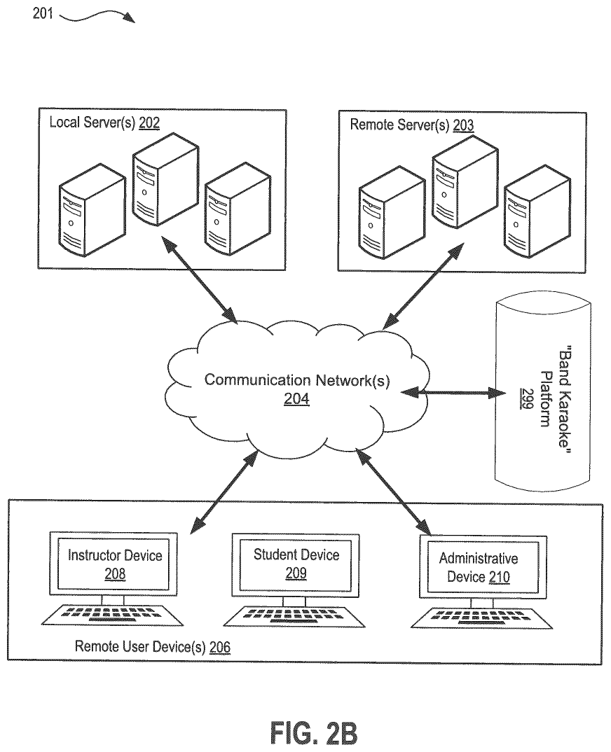

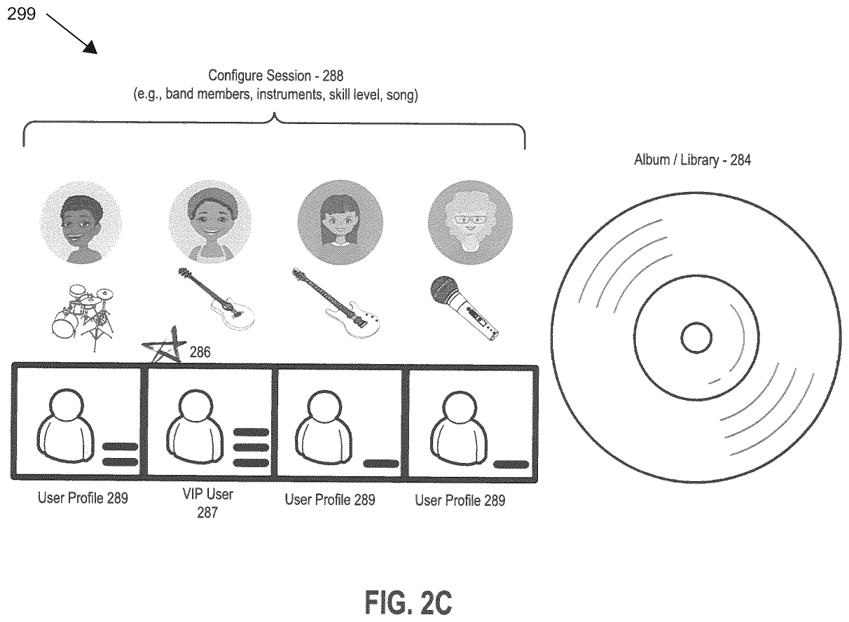

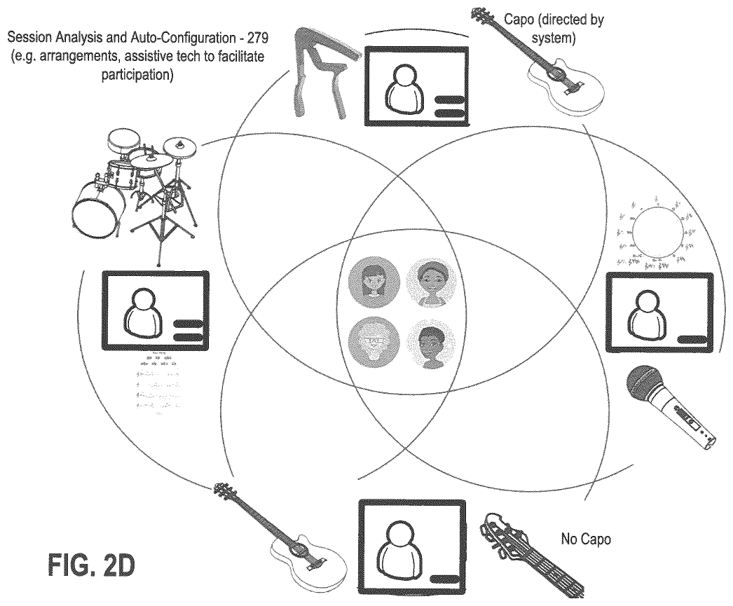

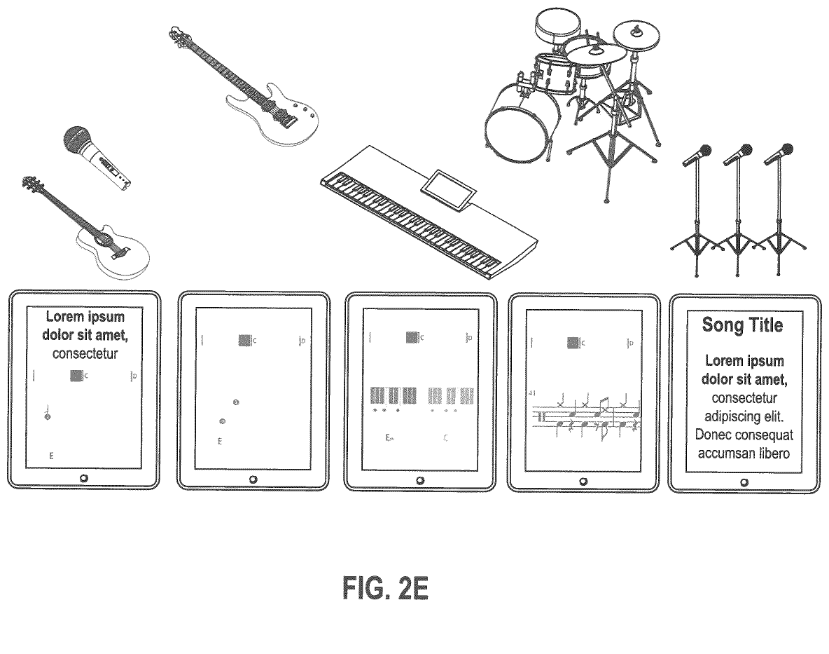

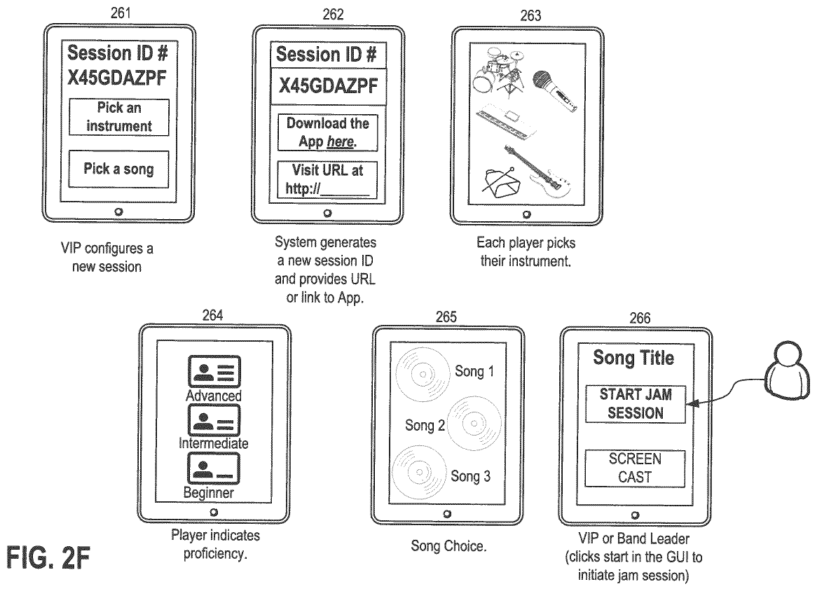

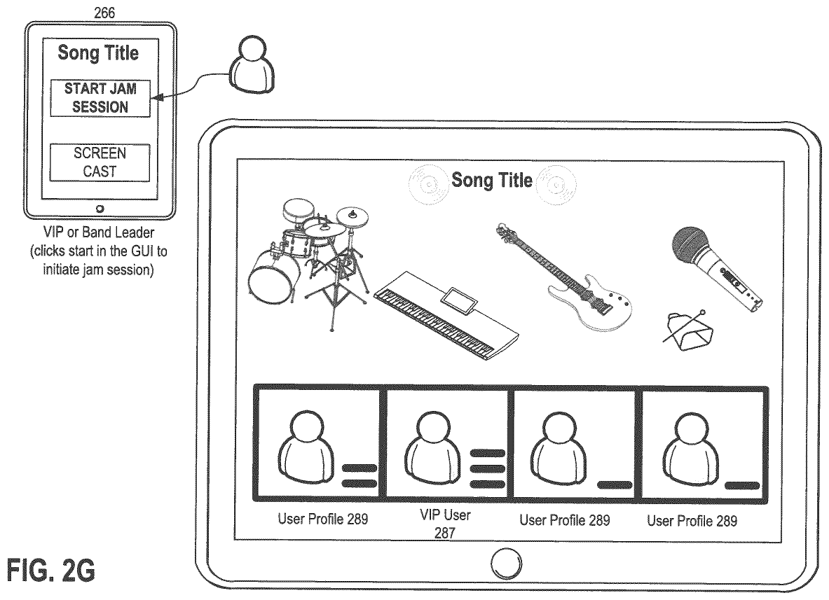

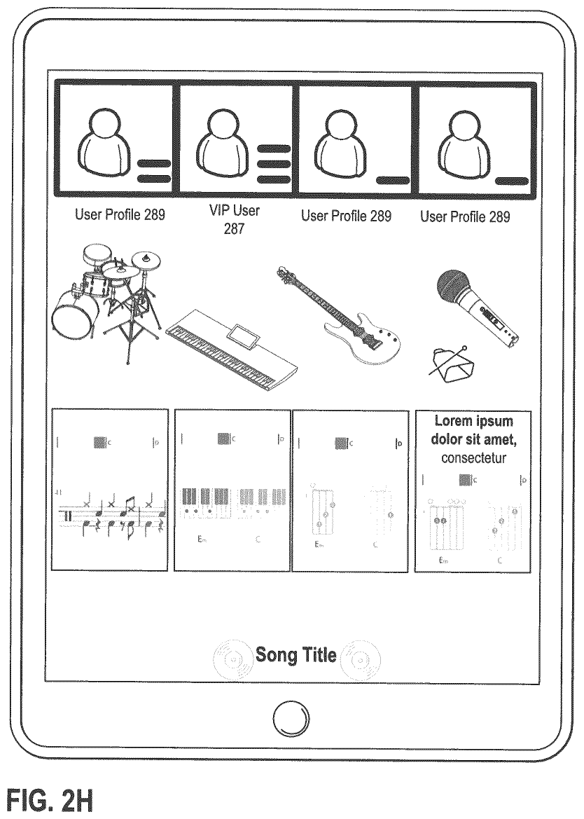

FIG. 2A depicts another exemplary architecture 200 of the “Band Karaoke” music platform, in accordance with described embodiments.

In this embodiment, the mixer 205 hub supplies physical jacks, feeds, and input ports 210 via which to connect instruments, and then outputs to the external display, speakers, individual displays for each player, etc. The flip up mixer display output 206 shows the music customized by type to each instrument and player preference. The lower surface of the mixer display output 206 provides a touchscreen interface that allows the players to indicate which instrument has players present who will play that instrument, and the sliders are the interfaces to mix the original part (stem) with the player's part by adjusting the volume levels to the appropriate point for each.

FIG. 2B depicts another exemplary architecture 201 of the “Band Karaoke” music platform, in accordance with described embodiments. Local servers 202 may automatically retrieve and enter input data to Band Karaoke Platform 299 or may track localized data on behalf of Band Karaoke Platform 299.

Similarly, remote servers 203, which may take the form of cloud based remote storage or may take the form of remotely located client-server repositories. A content creator may elect to upload customized content into the “cloud” in which case, such content is stored on the remote servers 203 and operable upon and retrievable by Band Karaoke Platform 299, via the cloud based remote servers 203, as needed.

Similarly, machine learning models, training data sets for learning by machine learning models, configuration parameters, account profiles and credentials, etc., may likewise be stored on the remote servers 203 within the “cloud,” and thus be retrieved from the remote servers 203 and used to train, fine-tune, or to further enhance the predictive outcomes generated by the machine learning analytical models as well as support execution of specialized algorithm as applied via Band Karaoke Platform 299.

Either or both local servers 202 and remote servers 203 may contain data about songs, player profiles, proficiency data, player progression and preference data, adjustment and modification data for songs, transpositions, assistive technologies, capo impacts, instrumentations, arrangements, underlying recordings of fully produced songs, underlying recordings of each instrument/part's stem, data about how notes and techniques relate to each other and their logical progressions of player difficulty in connection with a piece of music, etc. Servers on the Internet that host recordings of music that bands want to play may also be part of remote servers 203. Some or all of this information may also reside in Band Karaoke Platform 299 where the system algorithms find which combinations of relevant variables result in a best fit for the specific members of a given band session.

Still further depicted are the various remote user devices 206 which communicate with Band Karaoke Platform 299 and with the local and remote servers (202-203) via the communications network 204. For example, the depicted user devices 208-210 may be located at an instructor's home or school, a student's home or workplace, or an administrator's home or office. In particular, the figure depicts the instructor device 208, a student device 209 via which a student may interact with a student specific GUI, and an administrator device 210 via which an administrator may interact with an administration GUI and dashboard, for instance, to configure preferences and settings, or to configure and select multi-media content, or to electronically engage with system participants.

The remote user devices 206 depict desktop computers, but they are exemplary. The user interface devices may take any form, including a purpose-built mixing hub like those depicted in FIGS. 1 and 2A, personal smart phones or tablets, AR (Augmented Reality) glasses, or any other device, or combination of such devices.

When players join a band session, pick an instrument, inform the system of player proficiency by instrument through simple selection or saved data and diagnostics, and indicate their difficulty preferences, the Band Karaoke Platform 299 calculates and reports the best fit combination of parameters to be played and displayed by the user devices 206.

FIG. 2C depicts exemplary users of the “Band Karaoke” music platform 299 illustrating different people, the instrument each individual chooses to play, an optional profile for each individual, a skill rating of each player's proficiency in relation to a given instrument, and a catalog of songs, in accordance with described embodiments.

As shown in FIG. 2C, users may configure their session 288 to represent considerations that users bring to a typical session using the Band Karaoke Platform. The four individuals depicted may be a group of four friends, but the group may be of any size. Each may bring a desire to play a particular instrument in a given session 288. By the same token, one or all of these individuals might change the instrument they wish to play in a session. The Band Karaoke Platform 299 can account for a user swapping from one instrument to another via modification of the configured session 288, thus updating their user profiles 289. Star 286 depicted in FIG. 2C represents that one user typically is the director or band leader for a given session, identified here as the VIP user profile 287. This individual coordinates many of the details on behalf of the whole band. In others points, this person is described as the VIP 287, or may alternatively be named the position, such as “Music Director” or “Leader of the Band” or “Band Director,” etc. The squares below each instrument represent profiles 289 for each player. The profiles 289 need not be personally identifiable to an actual person. Rather, each profile 289 serves as the repository of proficiency data for players by instrument, for instance, storing their user-specific session information as meta data within the respective profiles 289.

A player may have an expert proficiency on guitar, and yet, they may be merely a beginner on the drums. The profile 289 tracks and catalogs this data as corresponding to and thus specific to each user's profile. The VIP status is also recorded within the profile, but this may be altered from a default position or may be separated from the profile 289 depending on the implementation. If a player does not maintain a profile 289, the player can inform the Band Karaoke Platform 299 manually at the start of the session, as further explained below, for instance, through a guest profile.

In accordance with one embodiment, the VIP user 287 runs the configured session 288 from a phone app and everyone else can follow along on a screen cast. If other players also have the app, they may also join the session and display their personalized interface. Startup is purposefully made to be low friction, thus increasing user engagement and delivering greater functionality and satisfaction to the participating instrument players.

The stacked horizontal lines inside each profile square reflect the proficiency level of the player on the particular instrument shown. The left-most player choosing the drums in this image is a medium/intermediate proficiency. The second from the left player with a star 286 playing the guitar is at an advanced or expert proficiency, at least with respect to the acoustic guitar depicted (and may be a lesser or greater or similar proficiency for other instruments). The third from the left player choosing the bass is a beginner and has one bar. And the right most player choosing vocals is also a beginner and has one bar.

The number of gradations of proficiency depicted in FIG. 2C as beginner (1 bar)/intermediate (2 bars)/advanced (3 bars) are simplistic but may be reformatted to be of any design, rating or resolution, including more bars to indicate increased levels of proficiency or more nuanced degrees of proficiency.

The album or library 284 represents a virtualized record store, representative of a collection of songs in digital format, or whatever other format is appropriate for the system implementation. Physical media may also be utilized depending on the implementation. For instance, the album or library 284 may be a representation of either a collection of songs in a curated library of songs, or of audio/video files found from any source (i.e. posted on the Internet, uploaded from one's own collection, etc.) that contain music.

FIG. 2D depicts an exemplary function of the “Band Karaoke” platform that mixes all parameters related to a given song that, when modified in concert with every participating player, creates a best fit modification of the given song for that group of players, in accordance with described embodiments.

For instance, as shown here, the Band Karaoke system performs session analysis and generates an auto-configuration 279 specifically for that particular session, such that the system determines what combination of transpositions, arrangements, and assistive technology allows everyone to easily participate.

Once the system knows who is playing what instrument and which song the group wants to play, it finds a best fit modification of the music that matches everyone's abilities so that everyone can participate. The scenarios depicted indicate how this is done once the system knows each profile's level of proficiency on a given instrument. If the system does not have an input specifying any given player's proficiency, then it may apply default settings. Alternatively, the system may prompt for basic information, such as proficiency for a given instrument. For example, when the system is missing a profile for a given player, the player is prompted by the system and the player then responsively indicates whether they are beginner, intermediate, or advanced (or some additional gradation of proficiency) and the system then uses this data for this session. For example, this information may be stored within a temporary guest profile, to permit the system to complete the session analysis and generate the auto-configuration 279 as required for that particular session.

As shown here, different parameters are modified and optimized to create an arrangement unique to every song, as well as the related steps that players must take or additional assistive devices players must use, as determined by the system, to be the most accessible configuration given the specific individuals in that band session.

For starters, each player has indicated an instrument they will play. Each player has a proficiency playing that instrument stored within their profile or will be requested by the system for their proficiency with that instrument. Given the determined proficiency, adjustments are made by the system to make the song easier to play for the collection of players. Specifically, the arrangement may be modified by the system, outputting a format easier for a given player to understand. Similarly, the key may be modified by the system. An assistive technology may be specified by the system which is to be added for a given player on a given instrument, such as through the directed use of a capo, as specified by the system, which is to be affixed to a guitar for a less experienced player, thus making a given musical piece more accessible to, and easier to play by, the less experienced guitar player.

A capo, which is short for capodastro, meaning the “head of a fretboard” is a device a musician uses on the neck of a stringed (e.g., fretted) instrument to transpose and shorten the playable length of the strings, which thus raises the pitch. It is a common tool for players of guitars, mandolins, mandolas, banjos, ukuleles, etc.

The system, pursuant to conducting its session analysis and generating its auto configuration 279 for that specific session, may determine that a chosen song can be played, but that a less experienced player benefits from the use of the capo, and thus, the system prompts and directs the less experienced player to attach the capo and also provide instructions regarding how and where to attach the assistance device. Because the system determines and directs the attachment of the capo, it may then be assumed by the system that the guitar is modified for the less experienced player, and thus, a simpler arrangement and modified key, as well as possibly different chords, may then be selected by the system as part of the auto configuration generated, resulting in a unique and experience adjusted arrangement and composition being presented to the player in question. Other devices and assistance aids may similarly be applied, such as minimizing or eliminating the use of the soft, sostenuto, and sustain (e.g., left, middle, and right) pedals on a piano or constraining the keys utilized, or eliminating the use of the sharps and flats or half-step (e.g., black) keys on the piano for a given musical composition. To be clear, a musical composition for a given song may call for the use of sharps and flats, or the use of pedals, or the non-constrained and more expansive chords and keys available on a guitar. Nevertheless, the system, pursuant to conducting its session analysis and generating its auto configuration 279 for that specific session, may nevertheless generate a less complex composition for a less experienced player using assistive aids, while simultaneously providing a non-modified and thus more complex variation of the same song to a different player of the same instrument. Similarly, a different musical notation or arrangement may be depicted for different players of the same instrument or for different players which play different instruments.

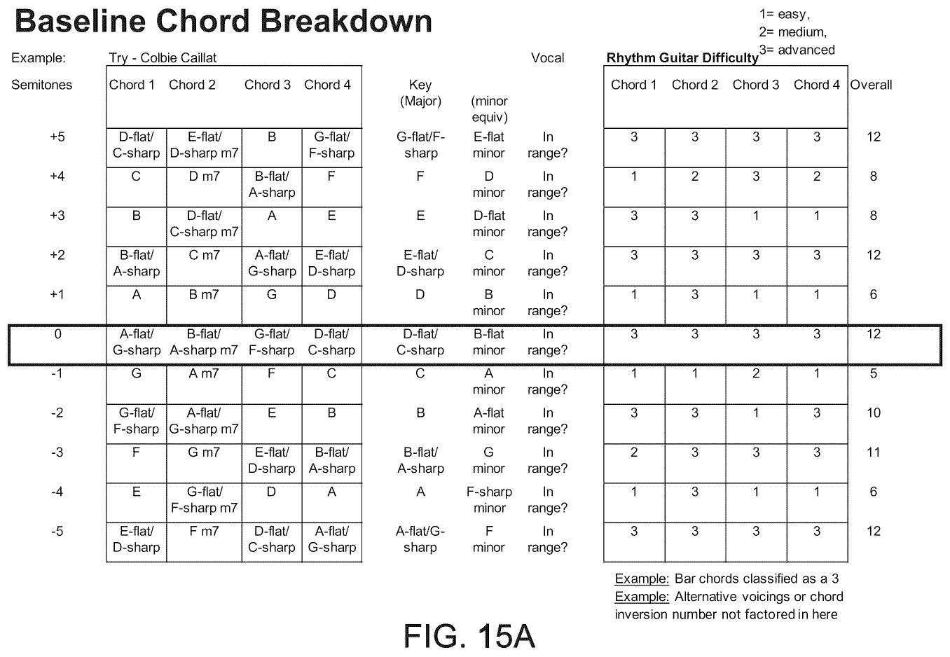

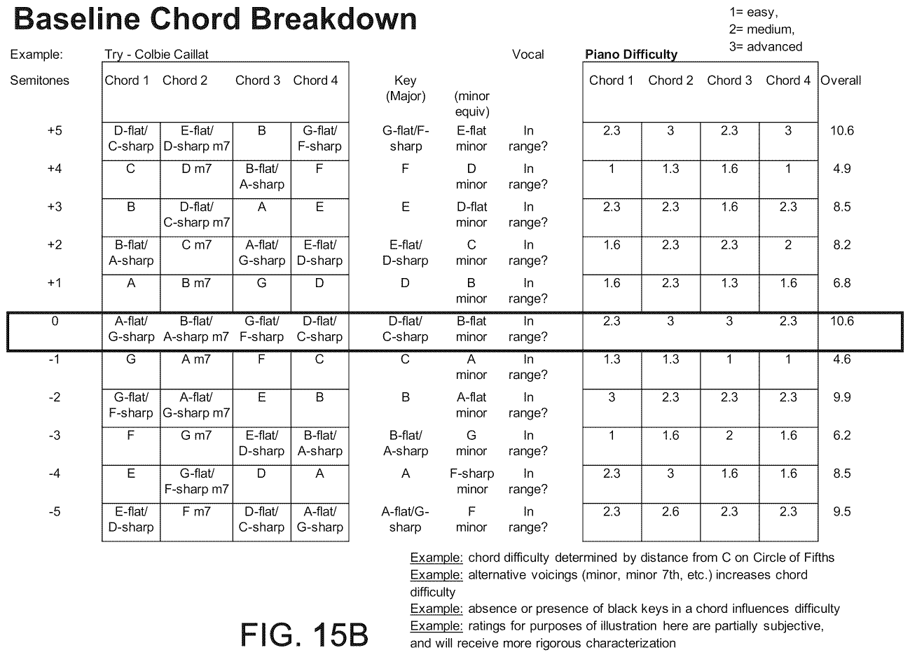

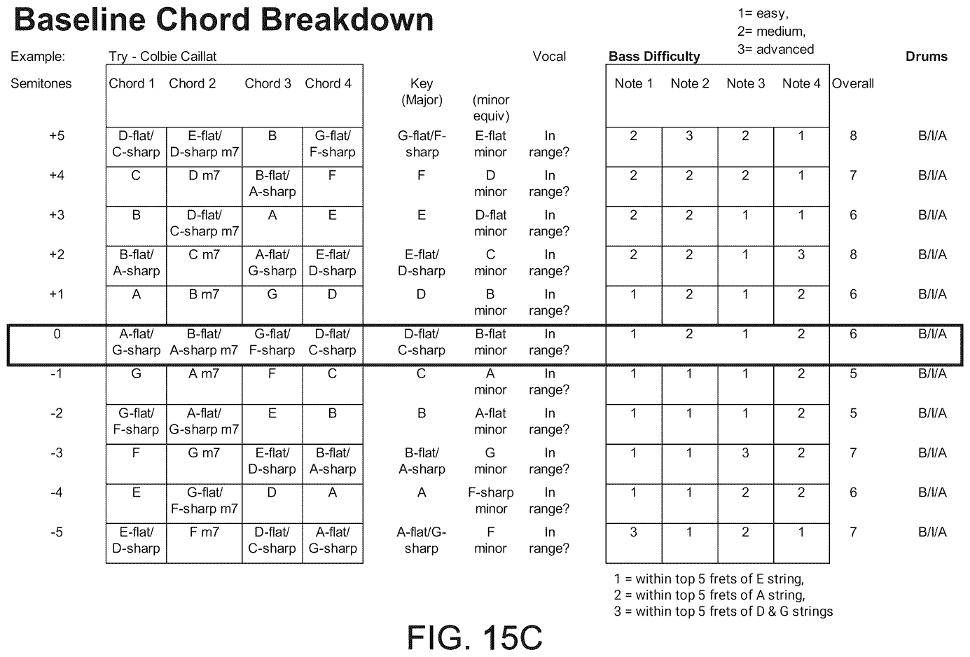

As illustrated in FIGS. 15A-38C, variety of parameters are therefore illustrated that result in a best fit for all the players to participate in a given song, as directed by the system and represented within the auto configuration 279 generated by subsystem for that particular session. The players in the middle are representative of the overlap that is possible when the songs and stems are all adjusted in conjunction with each other, and instructions are displayed to the player that reflect this intersection zone.

FIG. 2E depicts an exemplary customization of the display for each player on each instrument, in accordance with described embodiments.

Once the modifications for the overall piece are known, the system feeds to each player the appropriate instructions that match their preference and ability level. Other exemplary displays may take any alternative form beyond an app on a phone, such as on a big screen TV, projected through an AR (Augmented Reality) device, or other implementation.

As shown in FIG. 2E, every instrument part has its own presentation of the instructions to the player for the instrument they are playing. The format of presentation can be customized or reformatted to match player preference and proficiency level. There may be standard presentation designs, and there can also be designs customized by players or by other content creators. Individuals might make their personal presentation style or technology available on the Band Karaoke Platform 299 for other players to experience and use.

Specifically depicted in FIG. 2E are both lyrics and chords for the guitar player with vocals on the left, second to left depicts only chords, third from left depicts a simplified piano key position map for a novice keyboard player, fourth from the left depicts a drummers notation, and the right most presentation provides the lyrics and timing (depicted by boldface typefont).

A child friendly presentation may utilize colors or even pictures of animals which are mapped to a child's instrument, such as colors corresponding to a toy xylophone, or animal sounds on a “See-And-Say” toy.

Similarly, but with respect to a more sophisticated musical palette percussion timings may be provided for a particular player supplementing a rendition of the song “The Reaper” made famous by Blue Öyster Cult, thus truly bringing to life the words of Christopher Walken as Bruce Dickinson in the SNL Skit “More Cowbell,” when he uttered: “ . . . I'll be honest fellas, it was sounding great. But, I could've used a little more cowbell. So, let's take it again,” at which point the skillful band yet again plays the song “The Reaper,” while the character of Will Ferrell enthusiastically bangs on a cowbell.

While the skit itself may appear somewhat silly, the example is illustrative. Implicitly, the cowbell playing character is a significantly less experienced musician, playing along in a rendition of the song “The Reaper” with what is obviously an extremely experienced band. Nonetheless, the inexperienced player is welcomed and the overall enjoyment had by the band members and the inexperienced player are heightened, not merely by hearing the well known song, but due to their participation in the actual creation and live rendition of that song and the welcoming and enthusiastic participation of the inexperienced player.

The issue is thus presented, just how does Will Ferrell's character know how and when to percuss or “strike” the cowbell, so as to be in-synch with the remainder of the band, and so as to satisfy the demands of Christopher Walken's character mixing in the studio when he implores the band yet again, “ . . . Really explore the studio space this time . . . I'm telling you, fellas—you're gonna want that cowbell on the track!”

One solution to this problem is the technological method described herein, insomuch that the system conducts its session analysis and generates its auto configuration 279 for that specific session, recognizing the proficiency level of the inexperienced player playing the cowbell, and then as part of the presentation for that specific cowbell playing player, the system provides a percussive timing, so as to ensure both a sufficient quantity of cowbell for the rendition (configurable as defaults or by the VIP player or band leader) as well as the timing for the cowbell strikes. A more experienced player of cowbells may similarly be provided with not just timing, but also intensity of the cowbell strikes, or if a more experienced player is indicated by the player's profile, then the system may also specify advanced cowbell techniques such as reverberation, muffling, and timbre alteration via muting techniques.

Similar examples are contemplated for renditions of “Dueling Banjos,” albeit supplemented by a player enhancing the player experience, fun, and enthusiasm of the rendition by the more experienced banjo players through the contribution of musical spoons.

In such a way, the system can thus blend the original stem up or down based on proficiency for a fully produced performance of rock star fun. In an exemplary jam session with each player's chosen instrument, two friends who are early learners on vocals and bass may configure their original stems to play less strongly, through a reduction in complexity and also potentially a reduced mix volume, whereas the more proficient and experienced players on the drums and guitar may configure the original stem to play at an original complexity and original volume. For instance, the brother and sister are more experienced with the guitar and drums, so they dial themselves in more heavily over the original stem. This may be indicated by graying out the image of the band member silhouette via the GUI presentation to indicate that this is fading out the underlying stem.

However, these options may be altered, for instance, to bring a less experienced vocalist into prominence for the rendition of the song or for merely part of the song, to highlight that player's contribution, notwithstanding the lack of proficiency.

In such a way, the “Band Karaoke Platform” 299 modifications allow everyone to participate, and volume levels of the players performance versus the underlying stem allow a fully produced performance by the group, in accordance with described embodiments.

Exemplary GUI representations may include the silhouettes of black and white illustrations to represent the individual stems of each component part of the original recording. For example, given five parts of an original band, but only four players, the system may nevertheless achieve a full-band production sound for the group by turning on the stem for the male vocalist at full strength. The girl playing the bass is a beginner in such an example, and thus appears with one bar in her profile card to represent that the Band Karaoke Platform 299 recognizes her as a beginner on the bass. Thus, the image of the back and white figure behind her may be represented to the GUI via full color saturation because the stem of the bass part is likely to be left to play at full strength to assist the bass sound in light of the girl's proficiency level of beginner.

The same may be represented of the girl who is performing the lead vocal part. She is also a beginner in such an example, and so the stem is left at high volume—represented by the underlying silhouette image at full color saturation. The images of the girl playing guitar and the boy playing drums both indicate intermediate proficiency with their two bars on their profile cards, and the silhouettes are represented at fifty percent color saturation because the stem recording is dialed down in volume to allow the boy and girl's personal performance on their instruments to shine through more strongly.

Notably, it should be understood that while the system may very well be utilized in a professional studio environment, it is nonetheless adaptable and is specifically envisioned, as being utilized by novice players and especially by a mix of novice players participating in a rendition with more proficient players, by providing assistive mechanisms to the less proficient players and configurably altering the contributions of the more proficient and less proficient players in such a way as to provide a cohesive rendition by the mixed proficiency group. Fundamentally, promoting inclusion and contributions of the less experienced players creates increased engagement and thus, a significantly more fun experience, for all that are involved.

In the context of music and audio production, a stem is a discrete or grouped collection of audio sources mixed together, usually by one person, to be dealt with downstream as one unit. Each instrument in a musical composition may have its own stem. An audio engineer can mix stems to create a final production. The disclosed embodiments, in the same manner, can mix individual player inputs as a stem. A single stem may be delivered in mono, stereo, or in multiple tracks for surround sound. Thus, when mixing music for recordings and for live sound, a stem is a group of similar sound sources. When a large project uses more than one person mixing, stems can facilitate the job of the final mix engineer and in the context of the Band Karaoke Platform 299, the stems can be manipulated and configured by the system autonomously or by the players, for example, to promote a given instrument's contribution to be more dominant or to lessen the contribution of a given instrument to the overall rendition.

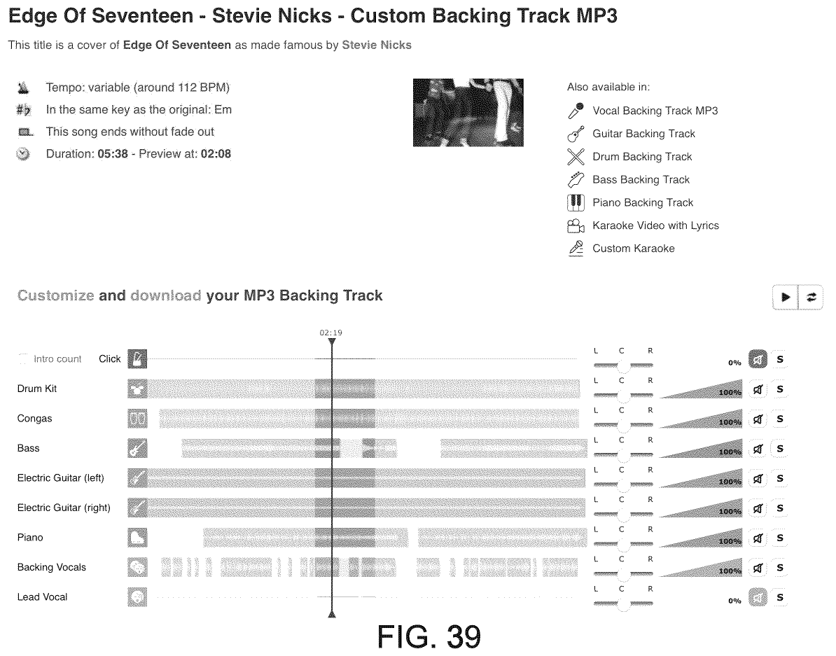

Stems may consist of one or all the string instruments, a full orchestra, just background vocals, only percussion instruments, a single drum set, a single string instrument, or any other grouping that facilitates mixing. As shown here, each instrument contributes its own isolated stem (e.g., via sound pickup for that instrument or the digital feed or analog feed into the mixer) which in turn facilitates the ability of the system to lessen or promote the contribution of a single instrument's stem which, in the context of the Band Karaoke Platform 299, results in diminishing or promoting the contribution of a single band member. FIG. 39, discussed further below, illustrates how stems are used in Band Karaoke.

FIG. 2F depicts an exemplary interface of the “Band Karaoke Platform,” in accordance with described embodiments.

For instance, as depicted here, one member using the system is the VIP or band leader and is permitted to initiate the jam session, upon which, the system begins broadcasting it to the other players, or all members, who are using the system together.

In this configuration, the exemplary combinations are that one individual coordinates the session on behalf of all the band members using their interface to the system, and everyone else follows along by looking at the common interface. The second exemplary combination is that every member of the band has an interface device that allows them to have a dedicated display for the instructions they personally need to perform their part of the collective performance, as well as provide the initial configuration variables (such as providing proficiency or authenticating so that the system has their corresponding and previously created profile, etc.).

While these two exemplary configurations of Band Karaoke Platform 299 deployments represent two points on a spectrum of different combinations, a full variety of different permutations of Band Karaoke Platform 299 and user interface device 206 deployments are permissible, such as some but not all players having their own device and interface, whereas others, such as a group of vocals, utilize a common interface, etc.

Similarly, a control hub and physical mixer may be utilized, however, the system may also be utilized without dedicated hardware. When there is no hardware hub to serve as a mixing station for all the instruments, it is still possible to play along with the music when given the individualized instructions. The following is an explanation of how the system works without a hub, as the centralized hub is an optional add-on that makes the recording and mixing of all the parts and stems easier and higher quality, but is not strictly necessary. The underlying play experience and interaction remain largely the same for the instrument players themselves.

If only one control interface is present, it is designated with the role of coordinator, which is referred to as the VIP or band leader, and is thus enabled with the authority to configure and start the session.

Where only the VIP has the app, the following sequence occurs:
Firstly (1) at element 261, the VIP initiates the jam session, causing the system to generate and share a session number. The session number (shown here as X45GDAZPF) provides a mechanism via which all the other players indicate to the system that they are joining the same session. Other mechanisms may be utilized, including automated Bluetooth ID matching, geo-location, social media connections between players, etc.
Secondly (2) at element 262, each member goes to common URL and inputs the generated session number.
Thirdly (3) at element 263, once the players have joined the session, they pick the instrument they wish to play during the session. As shown here, each member picks instrument by selecting or identifying that instrument to the system through the GUI provided upon visiting the common URL.
Fourthly (4) at element 264, each member indicates their ability level or if needed, the VIP can also configure this or any of the parameters from the VIP's own interface.
Fifthly, (5) at element 265, the band leader or VIP picks a song. Alternatively, someone in the session indicates which song they will play, by taking turns, rotations, choice allocation by the app, choice allocation by the VIP or band leader, etc. Similarly, the system can display two or three choices selected by the VIP which are then voted upon by the players and determined by consensus or majority vote. As shown here, while the person is indicated as the VIP, a different individual has chosen the song. In other embodiments, the system may need to restrict song selection based on the capabilities and proficiencies of the players included in the common session, in which case, the session takes all the input from the other players and finds the best fit modification of the song to allow everyone to participate.
Sixth, (6) at element 266, the band leader or VIP then screencasts all parts to a common display device, such as a large family room TV or a karaoke display console and initiates the jam session by clicking “start jam session.”

Finally, the group then plays along with the song immediately upon the band leader or VIP initiating the start of the session.

FIG. 2G depicts an exemplary method of starting a band session through an exemplary interface in a scenario where one member of the band administers the system on behalf of the group of players, in accordance with described embodiments.

Specifically, the VIP or band leader, using their own device or even the common larger display interface, sets all the players, their proficiencies (or associated profiles), their chosen instruments, and chooses the song, and then initiates the jam session.

As depicted, the left most player will play the drums, the second from left is on the keyboard, the third from left will play the electric guitar, and the rightmost player will provide vocals combined with, in this particular session, “more cowbell.”

FIG. 2H depicts an exemplary interface for the system, in accordance with described embodiments. Specifically shown here, is a single individual or actor (VIP or Band Director) configures a band session for a group of people/players, and the system that includes the Band Karaoke Platform 299 is able to present instructions to all participants even if the participants themselves do not have personal user interface devices 206 nor personal profiles on record with the system.

In this example, the interface for each player is a common large screen TV like those found in a family's living room. This example illustrates how the VIP/Band Director sets up the band session and enables each member to pick an instrument and indicate their proficiency.

In this example, the exemplary method of invoking the Band Karaoke Platform 299 is to use a smartphone app that allows the coordinator (VIP/Band Director) to start a session with the click of a button.

Once the system is informed of what music to play and has made modifications to match every player's ability, it then displays that information in a format that everyone can see it. In this instance, assume that everyone sits in the same room and can see a single big screen TV. In another instance, it may be that everyone has their own screen where their own part is displayed but playing in concert with everyone else. In another instance, one can imagine this happening over time and space. Individuals may sit in different locations and have this collective experience, for instance, with each player contributing their part in real-time via a connected Zoom session or Skype or Microsoft Teams. They may also play their part asynchronously and record their part to be later synced with everyone else's parts. The output of this interaction is a final mix of everyone's performance mixed together.

In such a way, all the players of the band are watching the single screen for their cues and musical arrangements tailored to their abilities. As shown here, the icons at the bottom indicate that the instructions provided for each instrument/player combination are for their level of proficiency, as reported by the user to the system via their profile or guest profile. Additionally, the system indicates via the interface that it plays the full stem for certain instruments without adjustment, such as for keyboard and backup vocals.

In other embodiments, such as where each individual player has their own individual display device, such as a phone, tablet, etc., then the following interactions explains how the system serves the instructions to each person's individual display device.

First, as before, the players have a way to join the same session, either by sharing a code or otherwise connecting the display devices to each other, such that the system establishes who is part of a given session. Next, each of the players indicates which instrument they plan to play but do so from their own devices.

Similarly, players also have a way of indicating their proficiency in each instrument. This can take the form of a self-report rating where each player uses a rating system. For instance, one player may be beginner, intermediate, advanced or some derivative thereof. In alternative embodiments, the system enumerates specific notes, chords, or skills that a player has mastered. The system may rely on self-reporting from the player, or with certain implementations, the system prompts the user to play through a series of notes, chords, skills, etc., responsive to which the player demonstrates their proficiency by playing back the notes, chords, or skills as prompted by the system. The system monitors the playback via an audio capture device, such as a connected microphone, and evaluates the precision and accuracy of the reply by the user against an optimized baseline. Proficiency overall or proficiency for the individual notes, chords, or skills is then determined based upon various determinable factors, such as timing, pace, synchronization, tonal quality, pitch, intensity, duration of tones, precision of tone or the deviation from the optimized baseline. The system keeps tally of the player's individualized repertoire within the player's profile as associated with the chosen instrument. Various modes are also configurable at the user's discretion, such as practice mode where a player improves upon known skills, enhancement mode where a player is introduced to new notes, chords, or skills as prompted by the system, jam mode where the musical arrangements presented to the user correspond with those notes, chords, or skills for which the user has the greatest efficiency, so as to minimize mistakes as well as stress to the player during the jam session, and so forth. Other enhancement modes may be more nuanced for a given player, such as improving pacing or improving timing or harmonization, or finger placement precision on the fret (evaluated by tonal quality and alignment to the prompted note or chord), and so forth. Similarly, the system monitors a player's abilities and automatically captures the players change in proficiency over time, assuming an active profile is known to the system for that user.

In other embodiments where a user's profile is empty, new, or missing, the system may establish rudimentary defaults for the user so as to minimize friction and enable the player to join into a jam session with minimal configuration, subsequent to which, the player's profile is populated to overwrite the defaults over time, as the system observers the player's proficiency with various notes, chords, or skills as prompted by the system or as presented by the system within an arrangement performed by that player.

Consider for instance, a player that can play the notes E, F, G, A, B on the bass with novice proficiency, whereas a more practiced musician has more notes they can play. The rating of proficiency is categorized by different criteria, such that certain pieces of music played flawlessly (e.g., matching an optimized baseline or within a threshold deviation from the baseline note, chord, etc.) reflect meaningful levels of skill that can be utilized by the system for the purposes of proficiency determination for that player or proficiency matching to a song or musical arrangement in question.

Continuing with the sequence of initiating a new session where each player has their own device, ultimately the choice of song is input to the system, either by human input or some other programmatic means, be it from voting, player choice, band leader choice, or system choice in which a song which aligns with the proficiency levels of the players involved is chosen.

Next, the band leader or VIP broadcasts the session to the family TV, but this is optional if all the friends and players have their own apps already running or if all players and observers have their own device and have the app already running. For instance, the TV screen may be unnecessary entirely when all the players have their own personal display devices or when all players are participating remotely from one another or asynchronously. Absent a hub or other separate speaker device, one can imagine the keyboard stem and backup vocals played out of the TV speakers, while other player's respective stems may be played out of their own display device, or out of the TV, or both, or from some other source, such as a studio “monitor” type speaker. To the extent that each personal display device also has an ability of capturing audio through wired connection or microphone, the performance of each player can be captured and either live streamed or recorded for post-performance mixing.

Ultimately, practice of the “Band Karaoke” music platform, enables both in-person bands and virtual bands, as well as a mixture of both in an ad-hoc band formation format. The result of which means that even new learners can play alongside experienced musicians where everyone can have fun. “Practice” becomes “Play.” Participation in the music begets connection and belonging. If desired, then conventional game play can be simulated with scores and rankings to entice competition. One person can practice on their own, or play and record all parts, for subsequent mixing (e.g., post production), aggregation, and playback. Each player can separately record their own respective part asynchronously and the “Band Karaoke” music platform can mix the compiled playback. Original pre-recorded stems may be utilized to fill in gaps of missing or inexperienced band members. And jam sessions permit limitless interpretations of existing music to create unique covers of well-known songs.

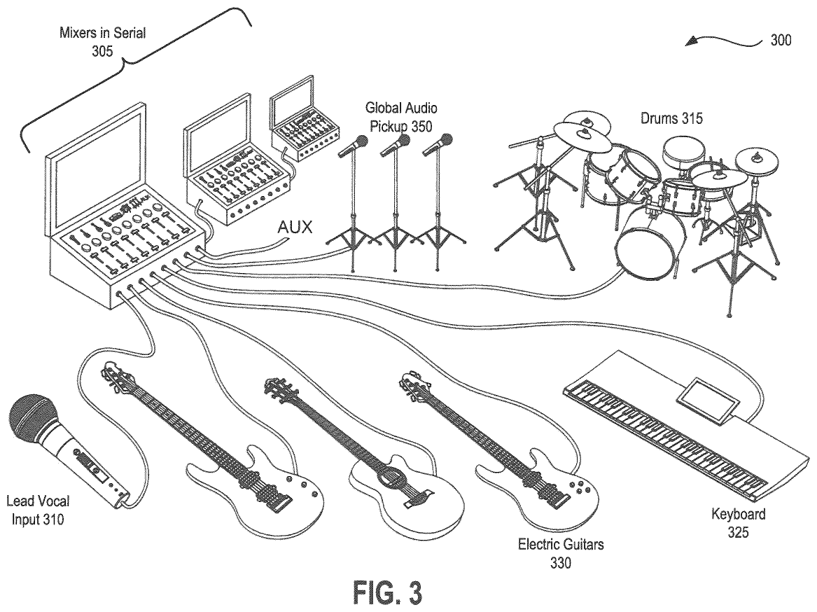

FIG. 3 depicts another exemplary architecture 300 of the “Band Karaoke” music platform, in accordance with described embodiments.

This image represents how the exemplary architecture of FIG. 2A looks when connected to instruments in the way depicted by FIG. 1. While FIG. 3 uses lines to represent wired connections between the exemplary architecture of the device 200 depicted in FIG. 2A, the connections may also be wireless. Of particular note is that if the mixing device nominally has eight ports for different instruments and microphones, then stringing additional mixers together in serial as depicted by element 305, provides a daisy chain configuration which expands the number of ports to support more instruments and microphones. The nominal number of ports per device may be different, for instance, with home variations of the mixer having fewer ports and with professional variations having a greater number of ports. The mixing device may also be a non-dedicated mixer, such as a computer, smart phone or tablet which can wirelessly connect with numerous instruments simultaneously or with a limited number of devices via a wired connection.

Also depicted here is the ability to adjust the volume of the original underlying stem for each instrument. Here the VIP can dynamically adjust the volume of the stem for the bass, or the bass player herself can adjust volume of the stem for her instrument as she likes. These adjustments may be done via the instrument itself when such an instrument is configured with a volume control, as well as via the mixer using the mechanical sliders corresponding to each input, or via a software GUI interface using a GUI slider at each player's app or through a VIP player's GUI which permits selection of a player and their instrument and an associated slide mechanism via which to increase or decrease the contribution (e.g., proportional volume) of that player's stem for the collective rendition of the song.

When configured with capture, amplification or recording of the player's own performance, then the display device can further capture the stem as an input and route it back to the main mixer as an input where mixing and post-production can then be completed. If there is a hub or centralized mixer, as is depicted here, then the performance can be compiled or further configured using that centralized mixer or later in a post-production environment that uses the recordings from the session to create a final, fully produced performance and/or recording. Again, it is possible due to the stems being separately identifiable both in sound and time, such that they can be later arranged if the musical rendition is to be later modified or optimized. In other instances, modifications such as increases or decreases to stem volume for a given instrument are ephemeral, such that they apply only to that particular live session, and are neither captured nor needed for subsequent post-production. This is especially true when friends and co-band members are merely having fun by engaging in a collective jam session.

When using a self-rating system, the levels may be broken down into beginner, intermediate and advanced. However, in other embodiments, even with a self-reporting system, many subtler gradations of proficiency may be indicated to the system from the players through a similar or different interface, such as a slider bar, or various check-boxes for skills, keys, notes, and chords for which the user affirms their proficiency. Alternative embodiments for capturing proficiency ratings include having the user select on the interface the list the notes or chords one is comfortable playing at the time of selecting an instrument. Another embodiment permits the user to select from a list the songs that player is comfortable playing, from which the system can then extract what proficiency and skill levels the player possesses.

In certain embodiments, the coordinating player (VIP/Band Director) identifies to the “Band Karaoke Platform” 299 the song the band wants to play during a given band session through an interface in a scenario where one member of the band administers the system on behalf of the group of players, in accordance with the described embodiments.

The Band Karaoke Platform 299 utilizes various ways to catalog or reference songs. In certain embodiments, the platform provides a couple different songs with similar names in its library responsive to the coordinator (VIP/Band Director) having searched for an input string, such as “Edge of Seventeen,” with the system applying a lookup and soft matching algorithm for that term to then display whatever options are available.

The Band Karaoke Platform 299 further provides broadcasting instruction data to a display device that all members of the band can see during a given band session through an exemplary interface such as where one member of the band administers the system on behalf of the group of players.

If the coordinator were accessing Band Karaoke Platform 299 through the TV as the interface device rather than the phone, these selections appear on the TV rather than the phone. However, if other alternative display mechanisms are used as the interface, then the band members see the instructions through those alternative display mechanisms. The interface device may take any form.

In another embodiment, the coordinator (VIP/Band Director) who is arranging the session of the players has an icon of a phone grouped together with the person's picture. This simply indicates that this person is the coordinator. As mentioned above, the interface with the system may use various computing devices but can also be arranged by the system using defaults or randomized selections and not necessarily by one individual in the group.

The Band Karaoke Platform 299 may further indicate that the sounds of the instruments are audible ambiently, as well as the sound from the TV-like device is audible ambiently, with icons or squares on the bottom of the TV screen represents the proficiency reported by each player when joining the session similar to the proficiency depictions at element 264 of FIG. 2F. The system may indicate those instruments, stems, parts or tracks of a song or musical composition for which no one in the band has selected to play them, so those stems are played by the Band Karaoke Platform 299 from pre-recorded baseline stems to round out the full sound of the song. The players can elect to remove these back-fill stems or reduce or increase the volume if they wish, depending on the preferences of the band members.

If the players want the underlying stem of their part to be played out from a pre-recorded baseline alongside their live rendition, then it is audible ambiently through the speakers of the display device.

In another embodiment, starting a band session through an exemplary interface relies upon one member of the band to administer the system on behalf of the group of players, despite each player having access to their own personal display.

The Band Karaoke Platform 299 may further share identification data for a given a band session through an exemplary interface in a scenario where one member of the band administers the system on behalf of the group of players when each player has access to their own personal display. In this case, the method of informing the other members of the band through a personal smart device the identity of the band session may take any number of alternative forms. There may be some other methods such as QR codes, phone cameras looking at a particular image, or via a wireless protocol.

The Band Karaoke Platform 299 further broadcasts instruction data to a display device that all members of the band can see during a given band session through an interface in which one member of the band administers the system on behalf of the group of players when each player has access to their own personal display. Thus, there may be a common screen showing the musical arrangements, players, and instruments in an aggregated format, as well individualized display GUIs output to each of the respective player's individual devices.

Because the Band Karaoke Platform 299 registers the profile of all the members of the band, or uses default guest profiles where necessary, the platform can utilize the proficiency rating information directly out of the players'profiles without prompting for such data prior to each session, assuming it has some prior knowledge of proficiency from the profile or from a prior session of a guest's profile. From the perspective of the players, this is a more efficient method to interface with the Band Karaoke Platform 299 because there is no need to enter their data in a format the system can use to determine what modifications are needed for each player and the overall arrangement to make it accessible to all the members of the band session.

There are numerous advantages to each player of having their own interface device for a band session, when available, because the interface device can display the instructions to the player in a way that the player can see it best. The user-specific interface device also allows the player to modulate the volume of the underlying stem to match the player's preference. The interface devices connect directly with the instrument, either wired or wirelessly, or via audible pickups, to enhance the functionality of the overall system. The interface device is further able to rate the proficiency of the player's performance and use that for scoring or tracking proficiency matching in future band sessions. For instance, the interface device may capture a recording of the player's part to be mixed with the other players'parts and underlying stems for a fully produced recording of the song.

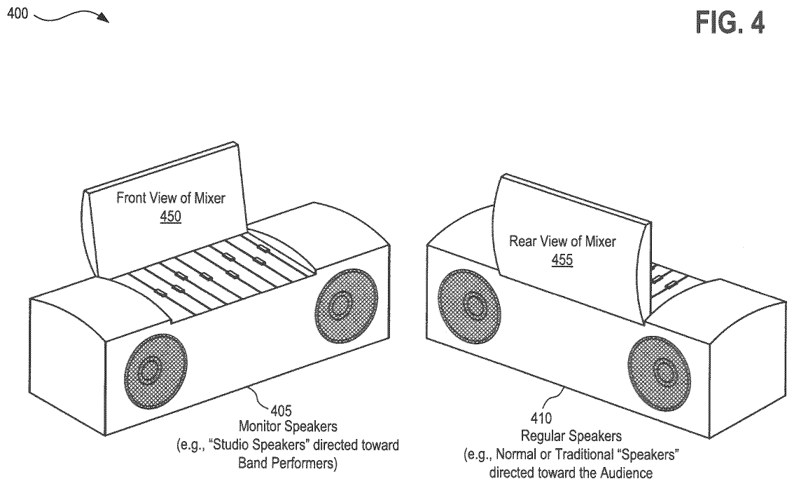

FIG. 4 depicts another exemplary architecture 400 of “Band Karaoke” as a music platform, in accordance with described embodiments.

This configuration has speakers on both sides 405 and 410 and a flip up screen for the players to read 450 and 455, and a mix board below to create a custom mix of original parts/stems and player performance. Jacks for instruments and other devices may be added to front, back, or sides. A configuration of this type lends itself to portability and playing on the go with friends one meets outside of the house.

User Interaction/Game Play: The Band Karaoke's unique focus is on enabling group band play among several payers of differing skill levels. The idea is that everyone can now join the band. To do this, the Band Karaoke platform invites each player to create a profile that it uses to log and track a player's proficiency in each instrument.

A master account holder can open a band session. This individual might have a paid subscription that gives them full access to the Band Karaoke platform library and feature set. Maybe a family shares a master account. The master account can always mix and match personal profiles to create its band.

When a player joins a band session, he or she logs into his/her free personal profile allowing the Band Karaoke platform to calculate through its software which combination of assistive technologies, transpositions, simplifications and capo placements allow all the players to participate in a given song.

The Band Karaoke platform hub is a simple device where all the instruments plug in. Because the Band Karaoke platform receives a pure signal from each player's instrument, it can dial up or down the volume of each player's part, mixing it with the original stem for the instrument they are playing to create a lovely final mix that everyone enjoys.

Players can all play their part as displayed together from the hub to an on-board screen, the family's large screen TV, or they can connect their personal smart device to sync with the system and display their personal part (via wired or wireless connections).

All the while the Band Karaoke platform tracks the proficiency growth of each player and offers that player (on the large screen or through their own interconnected smart device and personal account) the arrangement that is most appropriate for their skill level.

Players can choose if they want arrangements that they can easily play, or if they prefer arrangements that challenge them by dialing up or down their personal difficulty rating with regard to one or more pieces of music that indexes to their personal proficiency.

While the Band Karaoke platform can provide feedback to the group on how well they played by delivering a score or playing applause louder or softer, this feedback is optional. The unique experience of the Band Karaoke platform is that it transforms music from an observed experience into a participatory one. The Band Karaoke platform allows us to jump in on a song and take part. We are no longer forced to simply sit on our hands from the sidelines and only listen.

Furthermore, this participatory experience is one we can share with our friends and family-making this a legitimate shared group experience in an age when more and more individuals retreat from group interaction into the screens of their personal digital devices.

### The Band Karaoke Platform Technology Stack

The Camozzi music philosophy that enables group play
The hub to integrate and coordinate each part's stem and instrument (including any necessary modifications to any or all parts/stems that allow the creation of a real-time arrangement of the song and personalized notation instructions that is compatible with the proficiency of each player.)
The app for each player with a personalized interface
   a. Artificial Intelligence (AI) provides personalized encouragement and guidance
The curated music library and all the music on the internet
   a. Individual stems for curated selections
The curated portfolio of assistive technologies that empower early learners to overcome the initial difficulty of playing instruments until their conditioning grows
Tutorial content that trains players to be accepting, compassionate and inclusive, (a la Sesame Street) while developing technical skills
Adaptive performance feedback and social broadcast/performances

### Advantages Over Competition

There is no known solution that makes group music creation into a family and friends “game.” Components of an integrated system each exist separately.

### In-Home and/or “Boom Box” Model

Marketed to families, schools, and/or groups of friends.
   a. Sold from Band Indatruck birthday parties.
Sold through music stores and websites where they can sell the instruments from their own inventory to new customers who are excited about this game experience.
Expands to “Pro” model with a rack-mounted model with a foot controller for performers

### Karaoke Cafes

Full kits with instruments developed and sold into existing karaoke cafes with private rooms.
People are already accustomed to going to sing songs together.
The Band Karaoke platform quick-start process that gives new players the simplest ways to participate in the performance of a song allows other guests besides the one singing the karaoke song to participate as well while the singer sings.
This is an enhanced karaoke experience—“Music is more fun when we make it together.”

### Business Model

Game truck—per event hire
Freemium access to app and initial content library
   a. “Sesame Street” tutorials
Premium subscription to additional licensed content
   a. Premium tutorials & content/tutorial marketplace
Hub sales—outright purchase or with subscription (like cell-phone plan)
Hub hardware and software infrastructure as platform to other apps
   a. SDK enables other music tutorial apps to expand into “band” mode
When musicians use the system to perform or distribute commercially, royalty management functionality streamlines royalty compliance
   a. (Analog: in the age of Napster, iTunes made it easy to legally buy digital music.)
The system is instrument-agnostic, but we sell Band Karaoke-branded instruments OEM'ed from existing white-label manufacturers

### The Underlying Logic of Music Accessibility

When a player begins with a new instrument, they have a limited repertoire of notes, chords and techniques that they know. As their experience grows, their repertoire expands.
   In almost all popular songs there are melodies and accompanying chords. While playing a melody might take cultivated expertise on an instrument, playing the accompanying chords is less technically taxing. For example, in many arrangements with guitar, the rhythm guitar plays the accompanying chords and the performer sings the melody.
There are many ways to frame a given song in a complex or simple way. For starters, there are complicated and simplified arrangements. Additional modifications like assistive technologies like ChordBuddy or Fret Zealot can make some notes and chords easier for early learners to remember and play. In the music itself, modifications like changing the key or using a capo on the guitar can bring easier chord formations to the player.
For example, a song like Colbie Caillat's “Try” uses difficult bar chords without a capo to play the four principal chords of A-flat, B-flat minor 7th, G-flat and D-flat. But using a capo on the first fret allows one to play those same notes/chords with the formations for the much simpler chords of G, A minor 7th, F and C.
Add a ChordBuddy-like device and a new guitar learner can play those four chords by simply pushing a button on the device and strumming the strings.
This makes the experience of playing a guitar highly accessible, even before a learner has built the musculature to play bar chords or grown the calluses that protect the fingers from the abrasion of metal strings.
By finding and delivering the best configuration of adjustments to any player, the Band Karaoke platform meets that player where they are and guides them to be able to participate in the group performance contributing all that they are able.
All the while, the support of the system and the underlying original stems for each part make the performance sound good even if the players are only contributing basic chords in time. The players are always in control of how much of their raw performance they wish to mix into the final mix versus the original stem for their part.

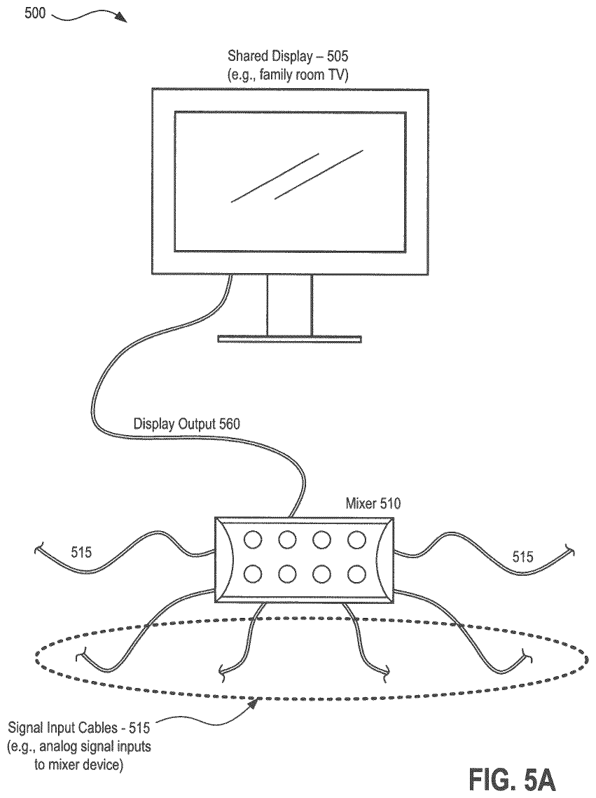

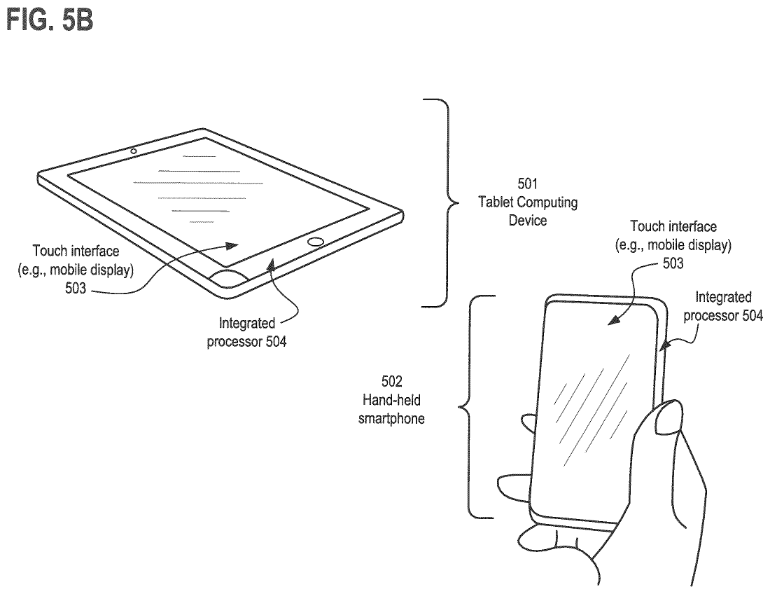

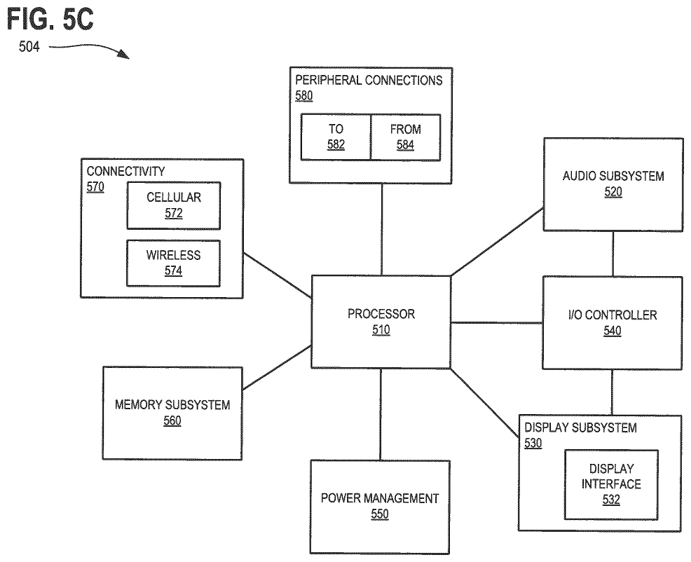

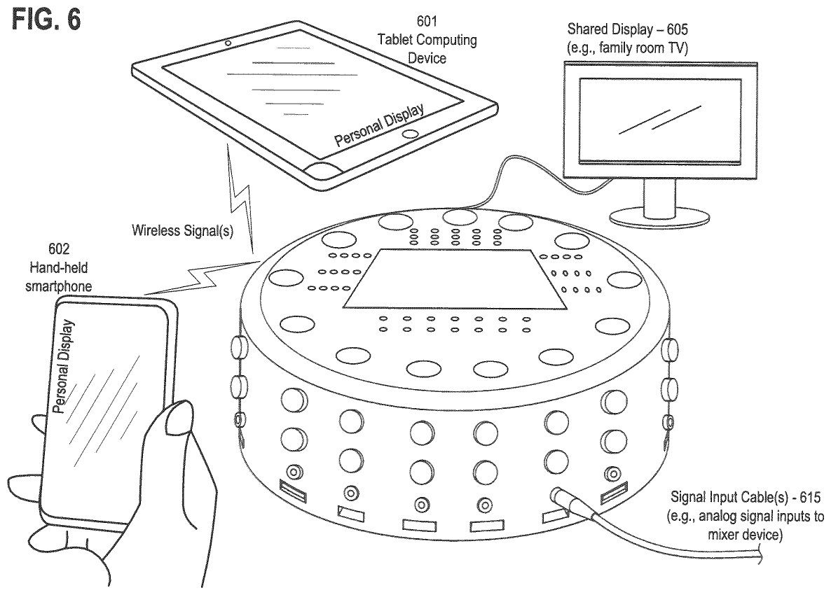

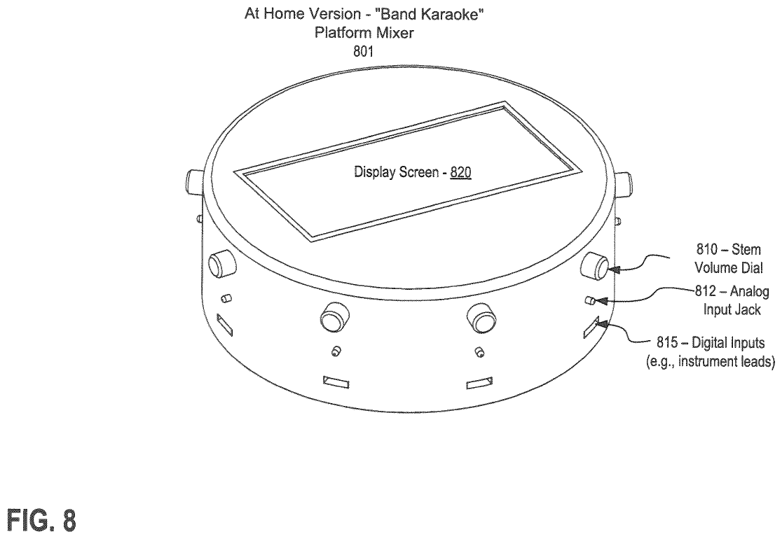

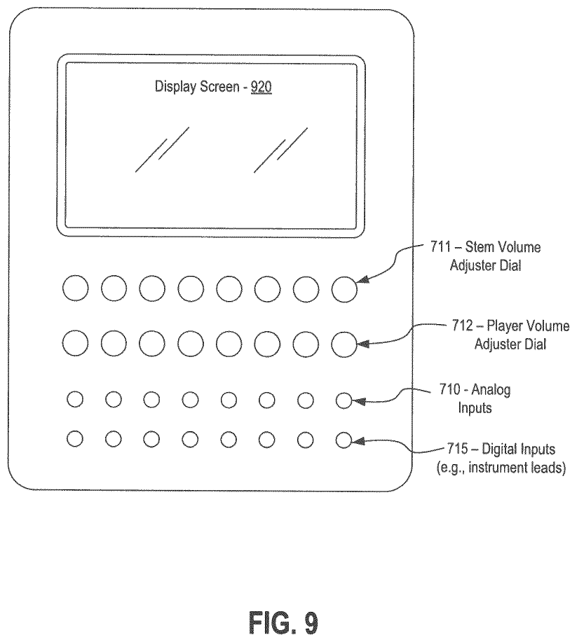

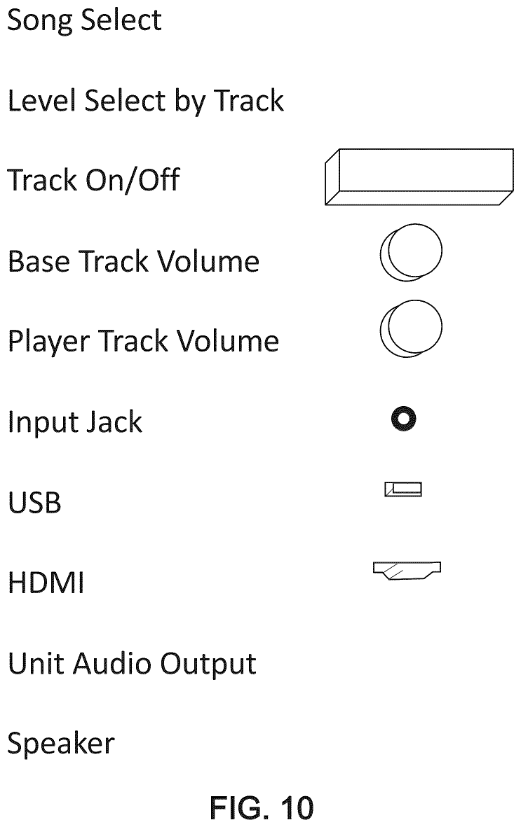

FIGS. 5, 6, 7, 8, 9, and 10 Depict Additional Exemplary Architectures and components of the “Band Karaoke” music platform, in accordance with described embodiments.

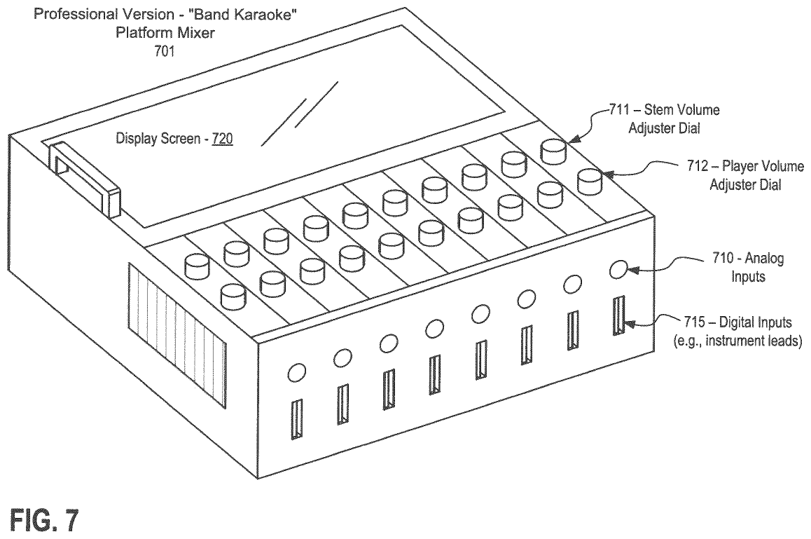

FIG. 7 again depicts a mixer, provided here as a professional version of the band karaoke platform mixer 701, with a display screen 720 and various inputs and dials for connecting the feeds from the musical instruments or audio pickups into the mixer 701. For instance, there is specifically depicted here both the stem volume adjuster dial 711 for each feed as well as a player volume adjuster dial 712 for each feed. On the lower portion of the mixer 701, there are depicted both analog and digital inputs for each of the eight feeds, identified here as analog inputs 710 and digital inputs 715.

The mixer 701 operates on the principle of isolating the stem from each instrument, which is constrained to only the sound of that particular instrument's sound, and then permitting the user to adjust only the volume of that particular stem for the specific instrument in question. Consider therefore having a novice which may wish to play at a lower volume whereas a more experienced player may set the volume of their specific stem at a normal or even greater volume. The mixer 701 as well as the “Band Karaoke” music platform generally, can also manipulate the volume prior to the start of the session or even during the recording itself. For example, if a particular instrument player is having difficulty playing a piece of music, as identified by the “Band Karaoke” music platform due to a lack of synchronizing in time, missed notes, or inaccurate production of notes, chords, etc., then the “Band Karaoke” music platform may adjust downward the volume of that particular player's stem and additional configure other stems to back-fill the void, which may include increasing or adding a pre-recorded part for that song (e.g., if a player on the saxophone is struggling then a pre-recorded saxophone part may be introduced), or alternatively, the “Band Karaoke” music platform may increase the part of a different player, such as increasing the vocals or increasing the contribution of the drums track, or increasing multiple other stems marginally and decreasing the stem of the struggling player slightly.

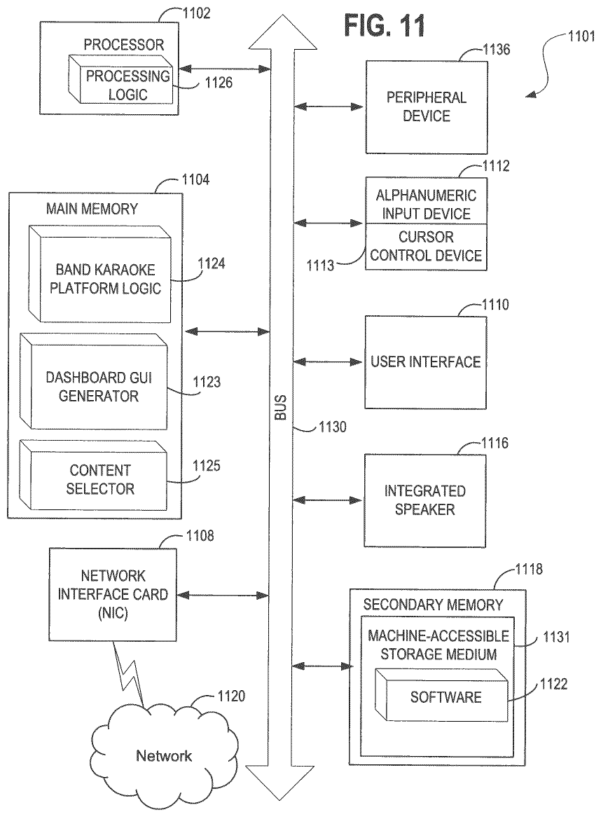

FIG. 11 illustrates a diagrammatic representation of a machine 1101 in the exemplary form of a computer system, in accordance with one embodiment, within which a set of instructions, for causing the machine/computer system 1101 to perform any one or more of the methodologies discussed herein, may be executed. In alternative embodiments, the machine may be connected (e.g., networked) to other machines in a Local Area Network (LAN), an intranet, an extranet, or the public Internet. The machine may operate in the capacity of a server or a client machine in a client-server network environment, as a peer machine in a peer-to-peer (or distributed) network environment, as a server or series of servers within an on-demand service environment. Certain embodiments of the machine may be in the form of a personal computer (PC), a tablet PC, a set-top box (STB), a Personal Digital Assistant (PDA), a cellular telephone, a web appliance, a server, a network router, switch or bridge, computing system, or any machine executing a set of instructions (sequential or otherwise) that specify and mandate the specifically configured actions to be taken by that machine pursuant to stored instructions. Further, while only a single machine is illustrated, the term “machine” shall also be taken to include any collection of machines (e.g., computers) that individually or jointly execute a set (or multiple sets) of instructions to perform any one or more of the methodologies discussed herein.

The exemplary computer system 1101 includes a processor 1102, a main memory 1104 (e.g., read-only memory (ROM), flash memory, dynamic random access memory (DRAM) such as synchronous DRAM (SDRAM) or Rambus DRAM (RDRAM), etc., static memory such as flash memory, static random access memory (SRAM), volatile but high-data rate RAM, etc.), and a secondary memory 1118 (e.g., a persistent storage device including hard disk drives and a persistent database and/or a multi-tenant database implementation), which communicate with each other via a bus 1130. Main memory 1104 includes various specialized components and computing architecture circuitry including the Band Karaoke Platform logic 1124, the dashboard GUI generator 1123, and the content selector 1125 selecting the appropriate interactive multi-media content for transmission to a connected computing device, all of which is operable in conjunction with the (“Band Karaoke Platform”) 299 in support of the methodologies and techniques described herein. Main memory 1104 and its sub-elements are further operable in conjunction with processing logic 1126 and processor 1102 to perform the methodologies discussed herein.

Processor 1102 represents one or more specialized and specifically configured processing devices such as a microprocessor, central processing unit, or the like. More particularly, the processor 1102 may be a complex instruction set computing (CISC) microprocessor, reduced instruction set computing (RISC) microprocessor, very long instruction word (VLIW) microprocessor, processor implementing other instruction sets, or processors implementing a combination of instruction sets. Processor 1102 may also be one or more special-purpose processing devices such as an application-specific integrated circuit (ASIC), a field programmable gate array (FPGA), a digital signal processor (DSP), network processor, and the like. Processor 1102 is configured to execute the processing logic 1126 for performing the operations and functionality which is discussed herein.

The computer system 1101 may further include a network interface card 1108. The computer system 1101 also may include a user interface 1110 (such as a video display unit, a liquid crystal display, etc.), an alphanumeric input device 1112 (e.g., a keyboard), a cursor control device 1113 (e.g., a mouse), and a signal generation device 1116 (e.g., an integrated speaker). The computer system 1101 may further include peripheral device 1136 (e.g., wireless or wired communication devices, memory devices, storage devices, audio processing devices, video processing devices, (Augmented Reality/Virtual Reality (AR/VR) tech, wearables, haptic tech, etc.).

The secondary memory 1118 may include a non-transitory machine-readable storage medium or a non-transitory computer readable storage medium or a non-transitory machine-accessible storage medium 1131 on which is stored one or more sets of instructions (e.g., software 1122) embodying any one or more of the methodologies or functions described herein. The software 1122 may also reside, completely or at least partially, within the main memory 1104 and/or within the processor 1102 during execution thereof by the computer system 1101, the main memory 1104 and the processor 1102 also constituting machine-readable storage media. The software 1122 may further be transmitted or received over a network 1120 via the network interface card 1108.

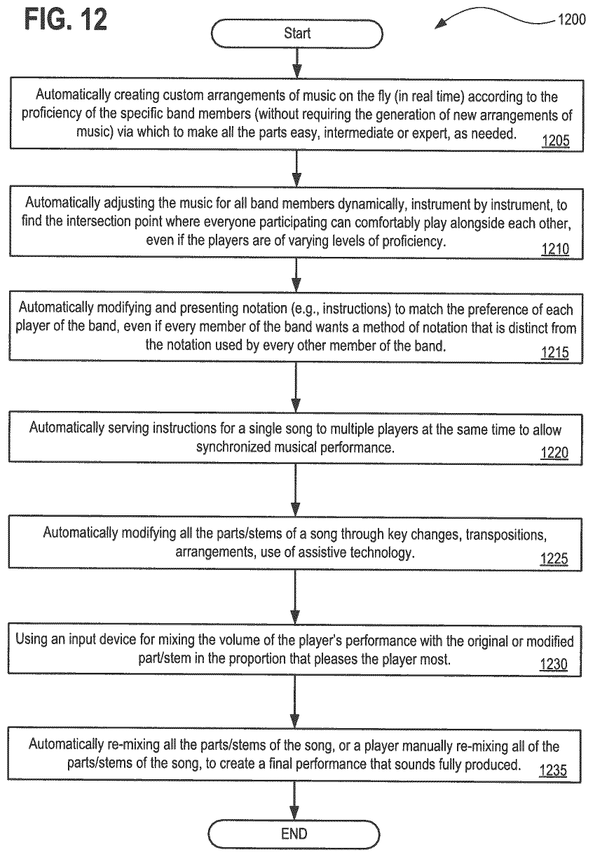

FIG. 12 depicts a flow diagram illustrating a method 1200 for implementing “Band Karaoke” as a platform to make music creation (alone or in groups) more accessible to novice level participants, in accordance with disclosed embodiments. Method 1200 may be performed by processing logic that may include hardware (e.g., circuitry, dedicated logic, programmable logic, microcode, etc.), software (e.g., instructions run on a processing device) to perform various operations such as designing, defining, retrieving, parsing, persisting, exposing, loading, executing, operating, receiving, generating, storing, maintaining, creating, returning, presenting, interfacing, communicating, transmitting, querying, processing, providing, determining, triggering, displaying, updating, sending, etc., in pursuance of the systems and methods as described herein. For example, machine 1101 (see FIG. 11) and the other supporting systems and components as described herein may implement the described methodologies. Some of the blocks and/or operations listed below are optional in accordance with certain embodiments. The numbering of the blocks presented is for the sake of clarity and is not intended to prescribe an order of operations in which the various blocks must occur.

With reference to the method 1200 depicted at FIG. 12, there is a method performed by a “Band Karaoke” platform having at least a processor and memory therein, in which the method includes some or all the following operations:

At block 1205, processing logic automatically creates custom arrangements of music on the fly (in real time) according to the proficiency of the specific band members (without requiring the generation of new arrangements of music) via which to make all the parts easy, intermediate or expert, as needed.

At block 1210, processing logic automatically adjusts the music for all band members dynamically, instrument by instrument, to find the intersection point where everyone participating can comfortably play alongside each other, even if the players are of varying levels of proficiency.

At block 1215, processing logic optionally automatically modifies and presents notation (e.g., instructions) to match the preference of each player of the band, even if every member of the band wants a method of notation that is distinct from the notation used by every other member of the band.

At block 1220, processing logic automatically serves or renders instructions for a single song to multiple players at the same time to allow synchronized musical performance.

Optional: at block 1225, processing logic automatically modifies all the parts/stems of a song through key changes, transpositions, arrangements, and use of assistive technology. (This block and the following blocks 1230, and 1235 of FIG. 12 are optional if the band does not want any underlying stem mixed into the performance. If the group of musicians is sufficiently skilled to perform without the stem playing alongside, or otherwise mixed in, a stem need not be played at all. The invention still stands even if the stem playback functionality is turned off or not included in a given embodiment.)

Optional: at block 1230, player use of an input device mixes the volume of the player's performance with the original or modified part/stem in the proportion that pleases the player most either through formal audio remixing or with a simple modulation of the volume of each part/stem ambiently.

Optional: at block 1235, processing logic automatically remixes all the parts/stems of the song, or a player manually remixes all the parts/stems of the song, to create a final performance that sounds fully produced either through formal audio remixing or with a simple ambient performance of stems and live contributions from players.

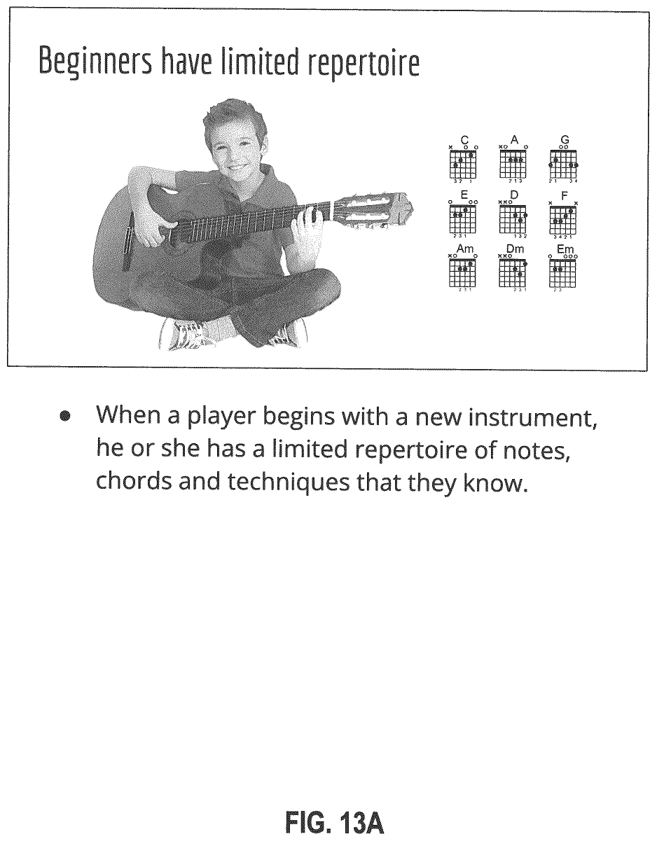

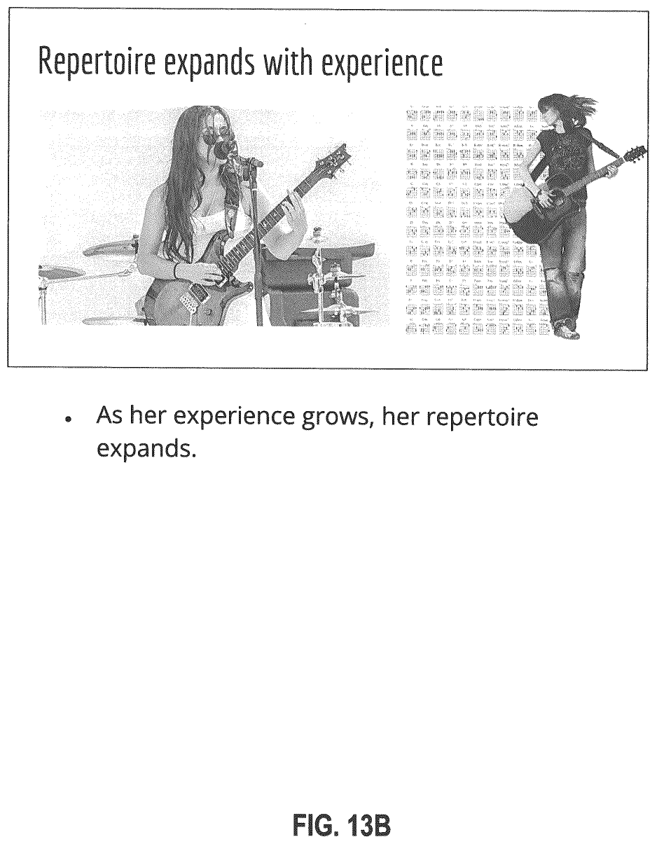

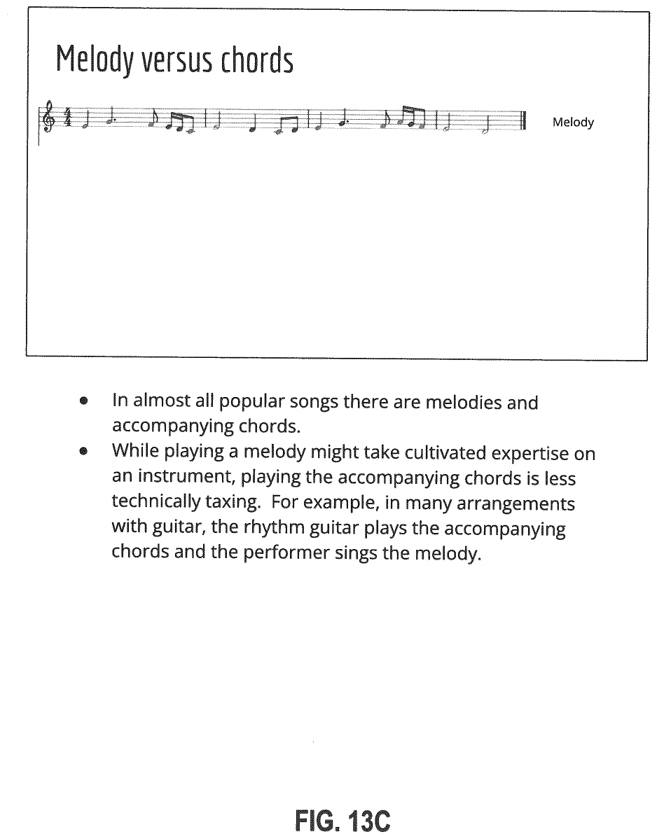

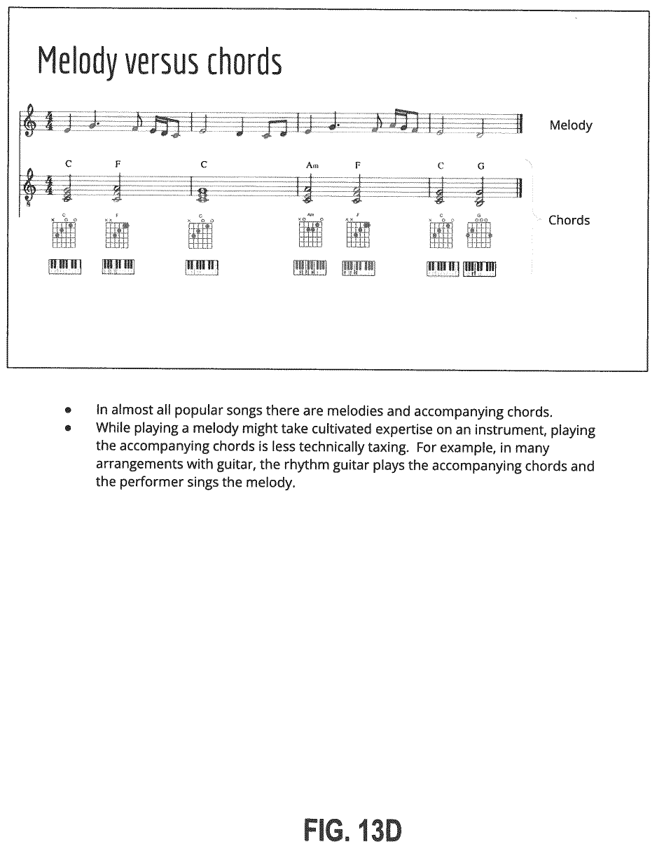

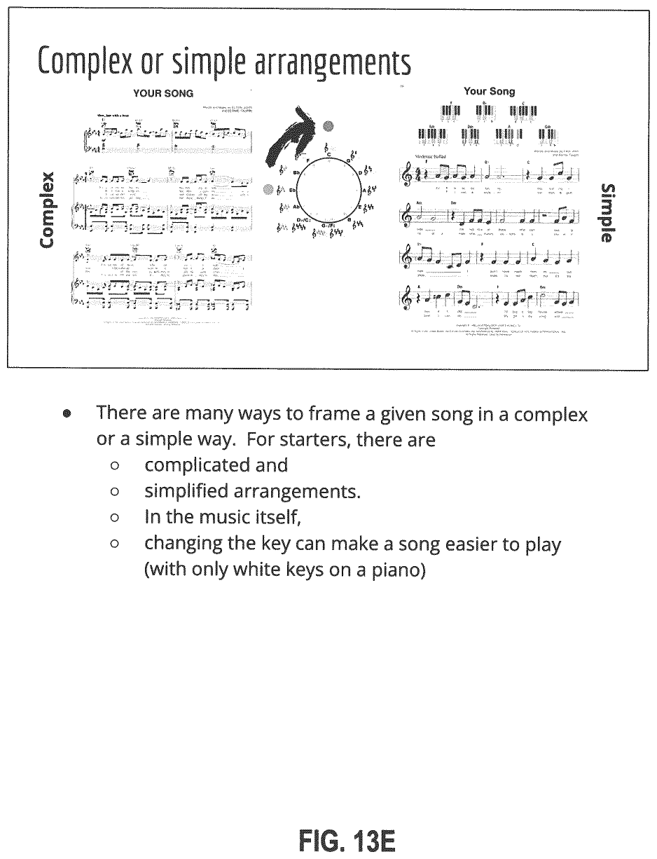

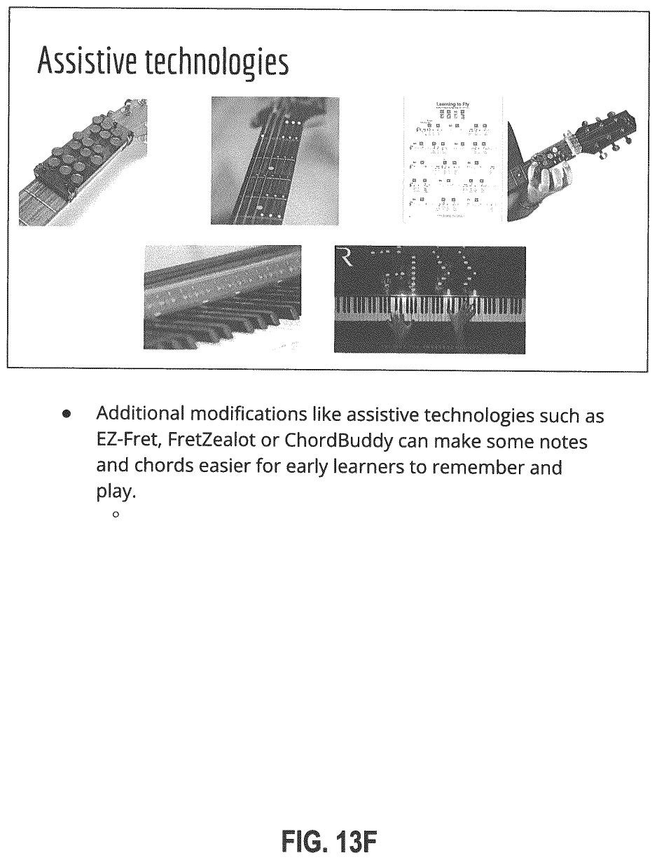

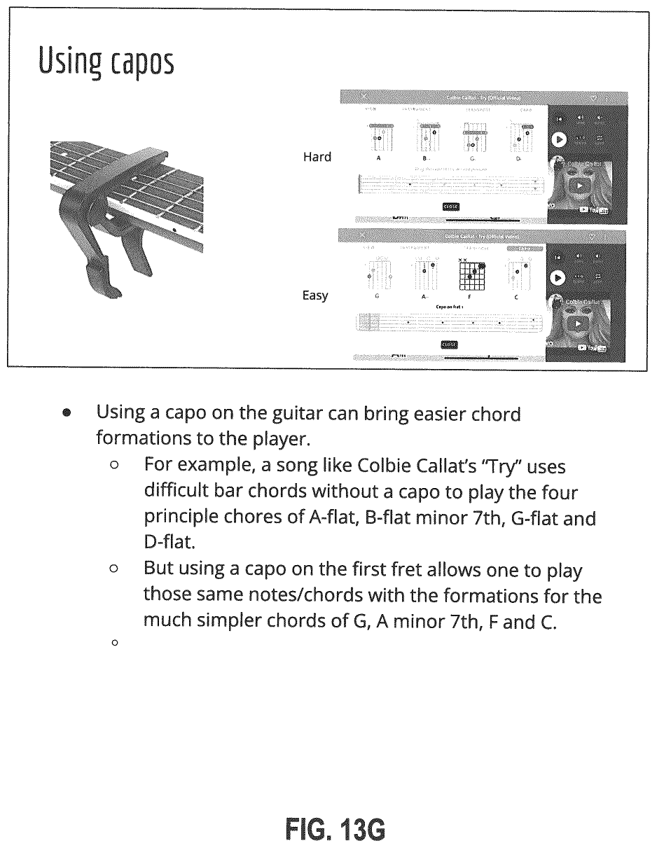

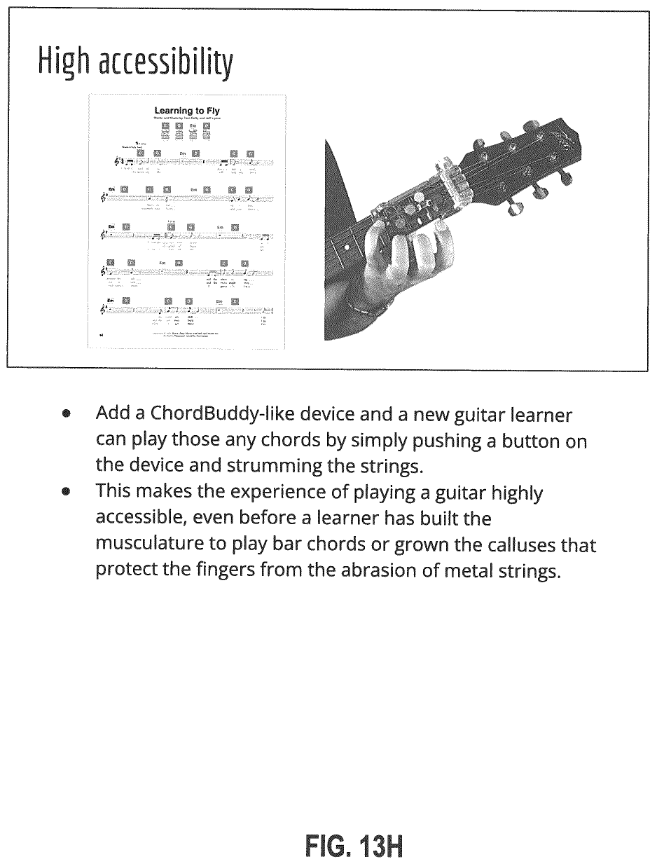

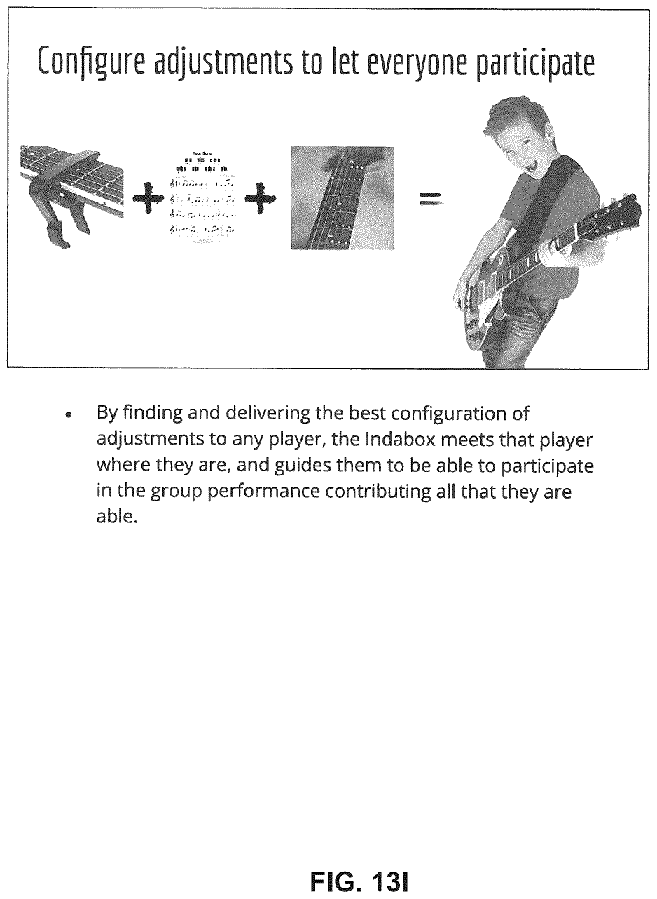

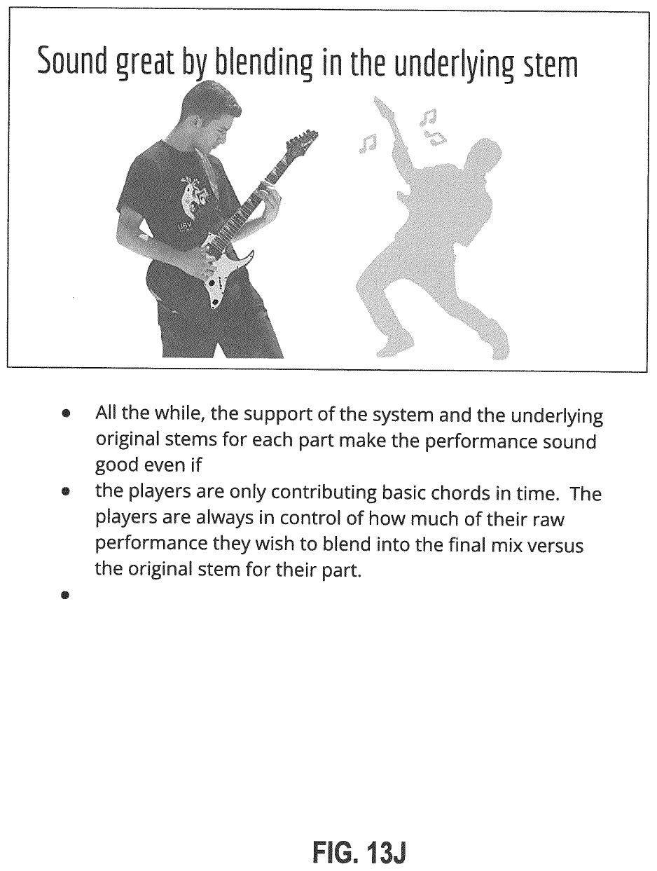

FIGS. 13A, 13B, 13C, 13D, 13E, 13F, 13G, 13H, 13I, and 13J describe the logic of music accessibility and the various components employed by the Band Karaoke Platform 299.

FIG. 13A depicts an example of someone who is beginning to play an instrument but who only knows a limited amount about how to play that instrument and represents someone of limited proficiency with this instrument, in accordance with described embodiments.

The image illustrates that a new learner on the guitar might know only a small handful of chords. The image lists the chords of C, A, G, E, D, F, A minor, D minor and E minor. These chords on strictly suggestive of the first chords someone might learn. Also, some of these chords are easier than others to form. Typically, the F chord on the guitar is not easy for first-time players. In actuality, the first chords a guitar student learns may be different from these.

FIG. 13B depicts an example of someone who has mastered many aspects of playing a given instrument and represents someone of substantial proficiency with this instrument, in accordance with described embodiments.

The image illustrates by comparison with FIG. 13A the difference between the repertoire of chords a more experienced guitarist might be able to comfortably play. The first column on the left in the matrix of chords depicted in FIG. 13B is the base note, and then each position to the right is a derivative chord of that same note. Finger placement for many of the chords is difficult to do accurately, and even harder to hold for a clear sound. This comes with continued practice. Assistive technologies, capos and transpositions can help a musician avoid some of these more difficult chord formations.

FIG. 13C depicts an example of how a song typically has a discernable melody, in accordance with described embodiments, as distinct from the accompanying chords which are introduced in FIG. 13D.

FIG. 13D depicts an example of how a song with a melody can have an accompaniment of chords that are compatible with the harmony, and which together comprises the essential nature of a given song, in accordance with described embodiments.

This image illustrates how chords accompany a melody to round out a piece of music to make it more pleasing and richer to listen to. The images of the guitar chart and the piano keyboard below represent how these two instruments are chord instruments, and able to play multiple notes at once to create a chord. Instruments like the bass are not typically played using chords. Rather, the bass is like the drums in that it keeps beat with the drums but also often plays the root note of the chord alongside the rhythm to give greater depth to the instrumentation.

FIG. 13E depicts an example of two additional methods of simplifying songs or making songs complex—changing the key and simplifying the arrangement itself, in accordance with described embodiments.

The image seeks to illustrate two additional aspects of instrumentation that can impact how accessible a given song is. The score for the song “Your Song” on the left is a piano accompaniment to the singer's melody. The notes above the lyrics of each verse represent that singer's melody as they sing the words. The right hand of the piano appears in the treble clef below the lyrics, and the left hand appears in the bass clef below the treble clef. In general, the right hand on the piano plays the melody, and the left hand plays the accompany chords. This arrangement is fairly complex. As will be addressed below, this arrangement is also in the key of E-flat.

By contrast, the arrangement on the right is much simpler. Only the melody is depicted in the treble clef. If players of the right arrangement wanted to add chords, they may play the chords depicted at the top of the page that correspond to the chord letters that appear above the treble clef. A guitarist may play those same chords in those places and also accompany a singer using this arrangement. To simplify the arrangement, it has been transposed into the key of C.

The image in the middle is the Circle of Fifths that illustrates how the scales for the keys that appear at each point around the circle starting at the 12:00 position that lists C have half steps at an increasing number of locations along the scale. The key of G at the 1:00 location has one half step up at F for an F-sharp. The key of E-flat has three notes with half steps down that translate into B-flat, E-flat, and A-flat. This is meaningful to someone playing keyboard because all these flat notes fall on black keys. If an early learner of piano is intimidated by the black keys, the key of E-flat is by definition more difficult for that player than the key of C which has no black keys. In short, one way to simplify an arrangement is to change its key into one with fewer half steps up or down. By this logic, C is the easiest key. G-flat/F-sharp is the most difficult key for an early piano learner.

FIG. 13F depicts several exemplary features and devices (assistive technologies) that augment conventional musical instruments to assist the player play the correct notes, in accordance with described embodiments.

This image depicts several assistive technologies that early learners can use to bridge themselves to a point where they have greater independent proficiency on an instrument. The list of items that appear in this figure is not comprehensive, but merely representative of the types of devices that exist to support early learners until their skills and conditioning grows to be able to play the instruments on their own.

In the upper left corner is a device called EZ Fret that allows a player to press buttons to depress the strings in a way that reduces the likelihood of dead notes that come from failing to cleanly press the appropriate strings or not press those strings that should stay open.

In the upper middle is technology called Fret Zealot that pastes small LED lights on the fret board that illuminate to show which strings should be pressed at which points. This is an aid to early learners who are not familiar with which notes correspond to which positions on the guitar neck.

In the upper right is Chord Buddy that reduces the complexity of pressing the right strings even further by grouping all the positions to form a given chord under a single color-coded button. More information on the Chord Buddy follows the description for FIG. 13H.

In the lower left is an image of the Piano Maestro device that is a strip of lights that lie across the top of the piano keys and illuminate to indicate which keys to press in time.

The image in the lower right is inspired by the game Synthesia for piano that indicates finger placement and timing by showing bars of light flow down to the appropriate keys in time with the music.

When Band Karaoke Platform 299 references interfacing with assistive technologies, it proposes to integrate the modifications to the music with these or other assistive technologies in a way that accelerates a player's ability to participate in the performance of a song. The instructions given for a new learner that might not feel comfortable with the instrument alone can be adjusted to incorporate the instructions from the perspective of using a given curated, endorsed and incorporated assistive technology. A new learner to guitar might not be able to participate in a song with friends if still unsure about how to form cords, but a Chord Buddy-like device allows them to participate with the press of a single button if all the other instructions have been automatically generated to be in sync with the other members of the band session.

Because Band Karaoke Platform 299 is finding the best fit arrangement for a given group of individual band session members, it can generate instructions that reflect the needed modifications in real time so that the band members themselves do not need to figure that out for themselves on behalf of a friend who is just beginning to learn one of the instruments of the band. New learners can enjoy the group band experience from the very beginning of their musical journey.

FIG. 13G depicts an exemplary device used with guitars and other stringed instruments called a capo shortens the musical length of the strings on the neck and allows the instrument to be played with key changes and different chord formations, in accordance with described embodiments.

This image illustrates how a capo allows a guitarist to play chords of a given note with formations of a different chord. The capo is a clamp that presses the strings of a guitar against the neck, essentially shortening the strings to the length of the fret just below the capo. When one clamps the neck at the first fret, one can play a chord for A-flat with the formation for the chord for G, which is one half step higher than A-flat. Since A-flat is a bar chord which requires substantial hand strength to successfully play, being able to play the same chord with the formation for a G chord is a great assistance to the new learner of guitar.

As is illustrated in FIGS. 15A-C, 16, 17, 18, 19 and 20A-C, enabling the guitar player to play chords of one note with formations of notes that are easier can make the difference between the player being able to participate in a band session or not.

FIG. 13H depicts an exemplary device used with a guitar as an assistive technology that simplifies the pressing of the guitar string to form a chord down to pressing a single button of a given color, which also corresponds to chord letters and color patches on musical notation to facilitate players'ability to strum out the cords of a song on a guitar, in accordance with described embodiments.

The Chord Buddy reduces the complexity of pressing the right strings by grouping all the positions to form a given chord under a single color-coded button. The Chord Buddy device aligns the color of its buttons to the colors on the sheet music so that an early learner need not even think about the chords as a letter, but rather as a color. In this example, the C chord is played with the green button, the G with the blue, the E-minor with the yellow and the D with the red. The music reads only the melody line and lyrics for the player to sing. At each point in the song, the colored boxes show where to strum the accompanying chord, and which color button to depress.

FIG. 13I depicts an example of how combining various elements and modifications using transpositions, capos, arrangements, assistive technologies, a new player can generate music more quickly, in accordance with described embodiments.

The specific modifications that might be needed for a particular player on a particular instrument are a function of the song being played and who else is participating in the band session. FIGS. 15A-38C outline examples of how the various permutations of player proficiency, song, and instrument can translate into requiring distinct combinations of modifications for any given band session.

By extension, this illustrates why Band Karaoke Platform 299 enables people to have a completely new experience than they have been able to previously.

FIG. 13J depicts an example of how a person playing a part on an instrument can more greatly enjoy the playing of the instrument when they accompany themselves with a recording of someone else playing that part that they can model, and modulate the volume of, to create a more pleasing-sounding playing session, in accordance with described embodiments.

This image is a graphic representation of a player focused on playing his instrument. What is key about the silhouette to his right is that the modifications alone may not be sufficient to enable the player to feel confident in playing with others in a band. The presence of the underlying stem is essentially a safety net for the player. They can still participate even if they don't feel comfortable, or they are not able to play the full instrumentation of the original song. The underlying stem is always there to complement their part. If they don't want to attract attention, they can keep the stem playing at high volume and simply enjoy the personal (and essentially private) experience of participating in the song along with others. If they feel confident and want their playing to feature in bigger part of the group's performance, they can turn down the stem and turn up themselves. The proper balance point is an individual choice for every individual on a song-by-song basis, so having this safety net and this control is a key part of cultivating the enjoyment in the experience of the Band Karaoke platform experience.

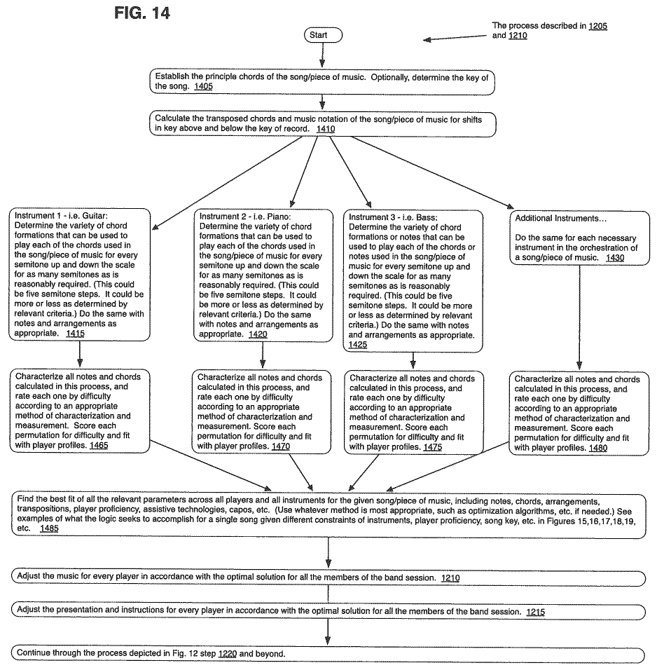

FIG. 14 depicts an exemplary process for practicing the logic of the Band Karaoke Platform 299 with a focus on steps 1205 and 1210 (of FIG. 12) to determine which modifications of a particular song/piece of music are needed for the members of a given band session, in accordance with the described embodiments.

This figure explains how the system determines what modifications are needed. Once the group has registered with the system so that it knows each player's proficiency on the instrument they are using for that session, it then actively analyzes (or refers to a record of a previously analyzed song) to determine the notes, chords and arrangements of a given song/piece of music (block 1405). There are myriad means of determining the notes, chords and arrangements. All are contemplated. Examples include referring to the song's sheet music. Another is analyzing a sound file and extracting the key and notes, chords and arrangements from computational analysis. Many other approaches exist.

Once it determines the notes, chords and arrangements, it transposes each note, chord and arrangement up a given number of semitones above and a similar number below the key of record (block 1410). The number of additional transpositions required depends on the specific circumstances of the song and the players, so the specific count of transpositions is not a feature of this invention.

Next the system characterizes each of these notes, chords and arrangements characterized in (block 1410) by each of the relevant instruments the members choose to play (blocks 1415, 1420, 1425, and 1430). In some cases where there are multiple ways of playing the same note, chord or arrangement, all are identified.

All these notes, chords and arrangements are then classified by absolute difficulty and difficulty in relation to the other notes, chords and arrangements that surround it (blocks 1465, 1470, 1475, and 1480).

The system then uses the difficulty ratings from different keys for each instrument to calculate a combination of transpositions, adjustments, assistive technologies, etc. that give every player instruction that match their proficiencies and preferences in a way that is compatible with all the other members of the band session (block 1485). Any number of methods may be used to assess the best fit of the different possible modifications. Optimization algorithms may be employed, but illustrations like FIGS. 15A, 15B and 15C reveal that methods need not be complicated.

FIGS. 15A-15C depict an exemplary breakdown of the keys and constituent chords of one single song (“Try” by Colbie Caillat) for an exemplary set of core instruments of a band: vocal, rhythm guitar, keyboards, bass and drums, in accordance with described embodiments.

FIGS. 15A-15C lay out the structure of the Band Karaoke Platform Logic.

The row denoted by the “0” in the far left column outlined in bold is the row reflecting the key of record. The rows above indicate how the keys of the chords of the song change when the pitch is increased by 1-5 semitones. The rows below indicate how the keys of the chords of the song change when the pitch is decreased by 1-5 semitones. The major and minor keys that contain these chords appear in the next two columns of the figures. The relative difficulty of playing each of those corresponding chords or notes on guitar in FIG. 15A, piano in FIG. 15B and bass in FIG. 15C appear in the tables to the right.

Chord instruments are generally easier to play for novice musicians in accompaniment with an underlying song than playing a melody instrument without extensive training. Many popular songs use 3-5 chords throughout the song to accompany the melody. Changing the key of the song or using a capo to change the effective length of the strings allows the player to play the song with different chord formations. In some cases, the alternative chord formations can be easier to play.

A player can increase the sophistication of their chord accompaniment by their picking pattern on the guitar or arpeggiation and other flourishes on the keyboard. Playing the melody line of a song may require more technical skill derived from regular training. Strumming along to a song with just the chords can be fairly straightforward. Despite its relative simplicity, doing so can be a highly gratifying experience. Beginners might start participating with songs by accompanying the chords of the song with the Band Karaoke Platform 299. As their skills and conditioning grow, they may expand to more difficult chords or even study how to play melodies and more complex phrasings.

The parts for melody instruments like lead guitar, and melody lines on the keyboard can be made more accessible by reducing the complexity of the arrangements or even changing the key of the arrangement. This illustration seeks to explain how the system modifies the chord accompaniment of songs to make musical and instrumental participation with the song accessible.

Many people can sing the melody of a vocal part if they can sing on pitch. Singers typically struggle when the notes at the top or bottom of the melody range are outside of the singer's range. In these cases, shifting the song up or down in key can accommodate the singer. Players who choose to play vocals but who cannot carry a tune can still use the Band Karaoke Platform 299, but can elect to drown themselves out by keeping the volume of the underlying stem high. Drums are independent of the other instruments because they don't have a key. The player determines if he/she wants Beginner/Intermediate/Advanced rhythm patterns. All are compatible with the song performance.

The principles embodied in FIGS. 15A-15C illustrate the types of adjustments that the Band Karaoke Platform 299 does in order to make a given song accessible to all players by deriving a best fit of modifications to key, capo, assistive technologies, and arrangements to match each player's proficiency. The Band Karaoke Platform 299 automates all these calculations and gives players the instructions they need without further thought or significant wait so they can spend their time enjoying participating in music together.

The following example illustrates the method on a single song (“Try” by Colbie Caillat) and describes the logic the Band Karaoke Platform 299 executes to generate the appropriate instructions for each player. The song is nominally in the key of B-flat minor but D-flat is the corelating major key that is compatible with the song's basic chords (block 1405). The primary chords of the song are A-flat, B-flat minor 7, G-flat and D-flat (block 1405). As guitar chords go, they are difficult to play because they bar chords and require significant muscular conditioning. These four chords repeat sequentially throughout the duration of the song.

Note that the same four chords (A-flat, B-flat minor 7, G-flat and D-flat) appear across from the nominal position of a zero shift in semitones. This is the key of record outlined in bold. If one increases the pitch of the song by one semitone, the key changes from a D-flat to a D and the four principal chords of the song become A, B minor 7, G and D. If one decreases the pitch by one semitone, the key changes from a D-flat to a C. With this change, the four principal chords of the song also drop one semitone each and go from A-flat to G, B-flat minor 7 to A minor 7, G-flat to F and D-flat to C. The relative shifts in semitones appear on the far left of the table (block 1410).

To the right of this matrix that illustrate the principal four chords for the song “Try” by Colbie Caillat for five steps up and down, the next column reflects the key for the song if it moves up or down. If the key is minor, that is indicated in the next column to the right.

The table entitled “Rhythm Guitar Difficulty” in FIG. 15A is a summary of how difficult each of the chords are at every point in the shift up and down the semitones (block 1415). The overall score is a simple total of the score for each chord. By way of example, the +3 and +4 semitone cases have the same overall score of 8. From the standpoint of difficulty, the +3 case is more difficult than the +4 case because it has two chords classified as a 3 difficulty, whereas the +4 case has only one “3” chord and two “2” chords.

The table entitled “Piano Difficulty” in FIG. 15B reveals that the chords for the nominal 0 case (in the key of record) are generally difficult because they are chords in the key of D-flat that is in the 7:00 position on the Circle of Fifths with the second to most half steps along the scale, second only to G-flat (block 1420). As a result, these chords have a lot of black keys and are generally more difficult for early learners of piano. By dropping the pitch by one semitone to the key of C, the cords are much easier on the piano with fewer black keys.

Coincidentally the “Bass Difficulty” table in FIG. 15C reveals the same trend, but this is simply because more of the root notes for the chords of the song can be found on the fourth string when the key of the song is dropped by one semitone (block 1425).

The same process is repeated for any instrument that performs in the song, or any instrument that a member of the band session wishes to play (block 1430).

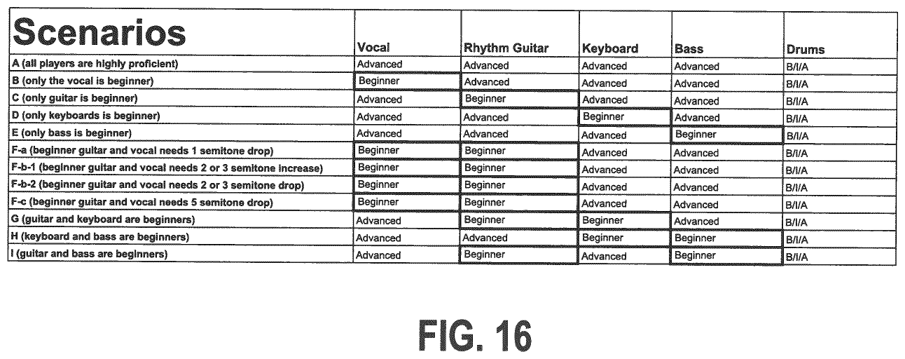

FIG. 16 depicts an exemplary variety of scenarios where the players of a given band session have varying levels of proficiency across different instruments, in accordance with described embodiments.

The letter that describes each scenario is followed by a plain description of the scenario's characteristics. The table to the right enumerates which instrument has a player of what level of proficiency. In some cases, there is only one beginner-class player. In some cases, there are two beginner-class players. These scenarios are not exhaustive. They only allude to the fact that there are many permutations for any one group of band player members who have chosen particular instruments.

The Band Karaoke Platform 299 ascertains which combination applied to any given band session when presented with various combinations of band members of varying skill levels across an exemplary set of core instruments in a band: vocal, rhythm guitar, keyboards, bass and drums.

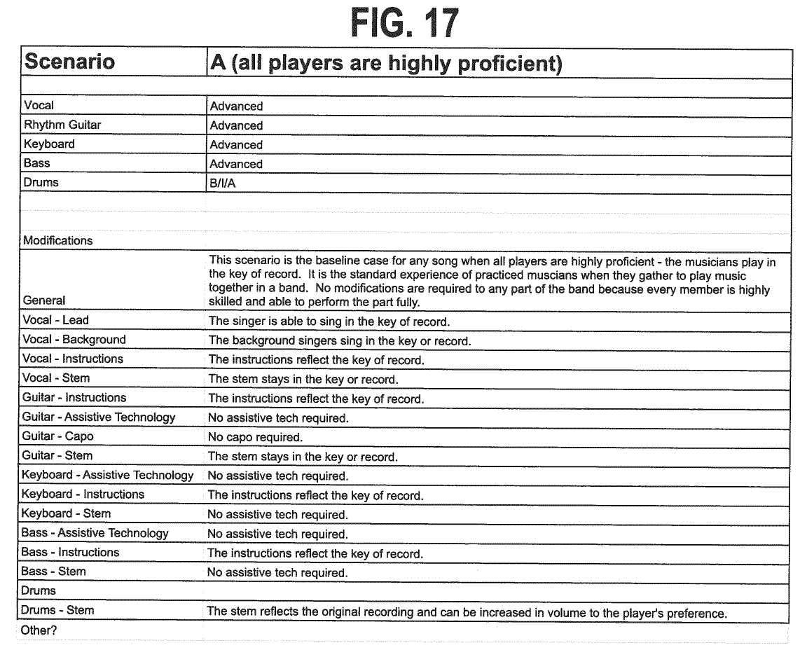

The commentary in FIGS. 17 through 38A-C illustrate how the logic of the Band Karaoke Platform 299 responds to the scenarios enumerated in FIG. 16 in order to search for the best, most accessible arrangement to this song given the players who have joined the band session. The scenarios presented are exemplary but not comprehensive. Other permutations of skill level exist. The best fit modification is determined by the Band Karaoke Platform 299 in this fashion even for combinations of skill set not explicitly mentioned here.

Proficiency levels for each player are specific to each type of instrument. Players can be advanced on one instrument and beginner on a different instrument, so it is important that skill level is defined by instrument. Each permutation of player proficiency combination has its own scenario letter and related figures. In each related figure there is a description of exemplary ways the Band Karaoke Platform 299 modifies the song or the instructions to guide players to be able to participate in an enjoyable band session. These scenarios are for illustrative purposes only. There is likely greater variance in skill level across a group of players, including intermediate players who can do some advanced techniques but not others.

Each song presents its own unique profile of modification opportunities to find the best fit that serves a given group of players best. These calculations of which modification to recommend are provided for each combination of song, players and instruments.

Each scenario reflects a different combination of player proficiency levels on the given instrument. The Band Karaoke Platform 299 optimizes the many variables for every song using this basic exemplary approach to arrive at the instructions it generates for each player. Someone practiced in the art may understand the underlying logic of this approach and may deploy any variety of methods to implement the system. For every song a similar process may be generated, starting with determining the basic chords from the song, the key of the song, the transpositions for each chord, the difficulty rating of each chord and passage for guitar, piano, bass and vocals. The Band Karaoke Platform 299 might also generate instructions for the drums, including ways to stratify instructions from beginner to advanced skill sets. When a group of players joins into a band session and selects a song, the Band Karaoke Platform 299 profiles the song in this way, and finds the appropriate modifications based on all the parameters of song, players, and instruments.

FIGS. 17, 18, 19, 21, 23, 25, 27, 29, 31, 33, 35, and 37 enumerate the scenario letter and description of the scenario characteristics. Each example instrument is listed and next to it is also noted the example levels of proficiency of the players playing those instruments in the given band session.

The rows below then catalog the specific modifications required to support the band members on the indicated instruments when playing the song “Try”.

The lower rows of the table describe how the Band Karaoke Platform 299 modifies and adjusts the instructions or not, how it modifies the stem, whether it recommends an assistive technology, if it wants a capo applied to the guitar and if so where, for each of the members of the band session and their instruments. (The drums do not influence the key or chords of the other instruments, so the only option for the drummer is whether to play a beginner, intermediate or advanced rhythm arrangement.)

These modifications are not comprehensive, but rather illustrative of the types of modifications that the Band Karaoke Platform 299 does computationally and quickly on behalf of the players in the band session so that they focus on the camaraderie that comes from making music together.

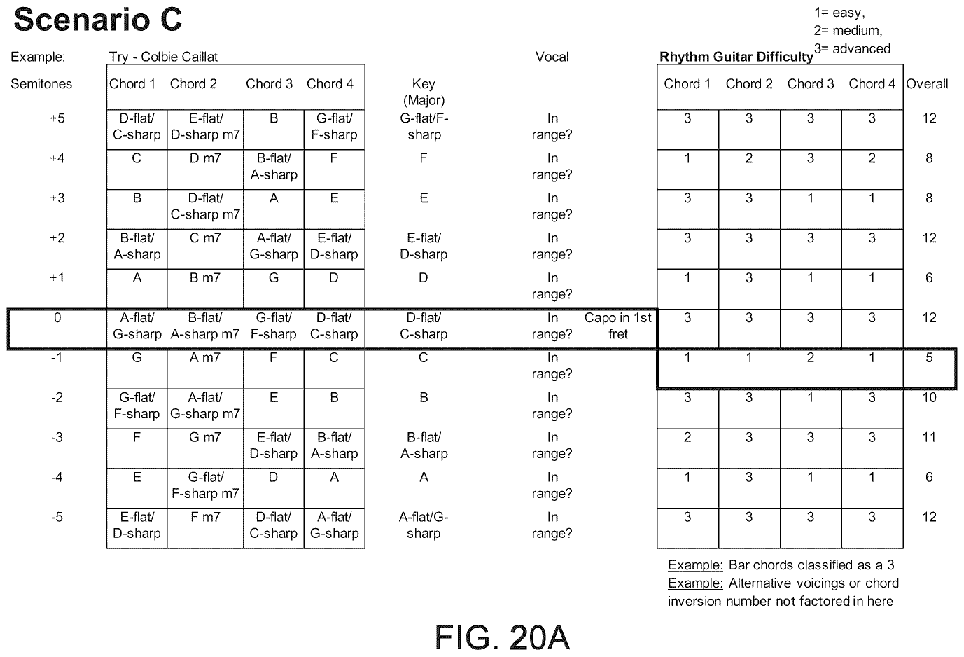

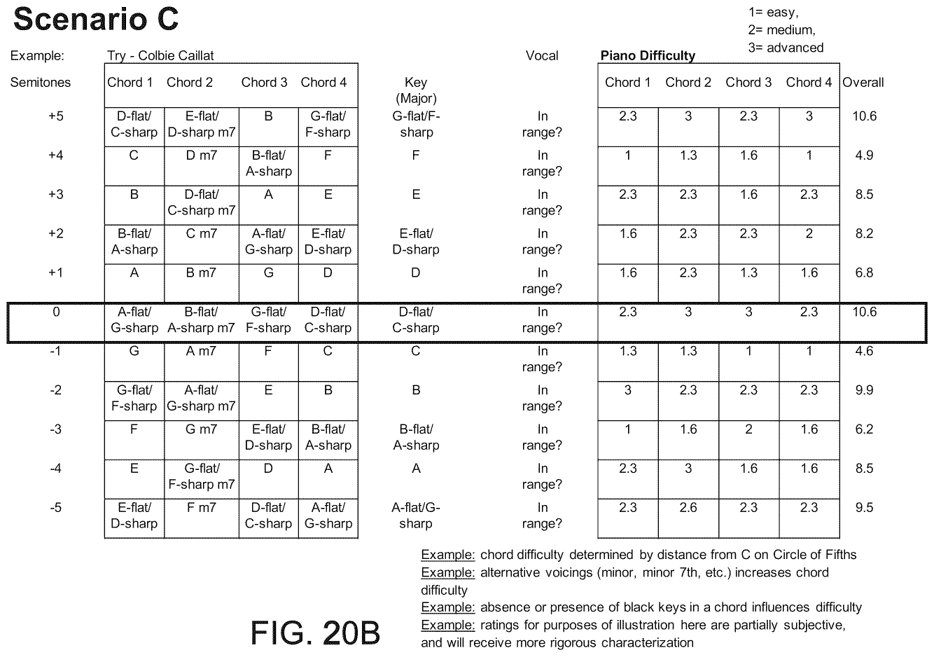

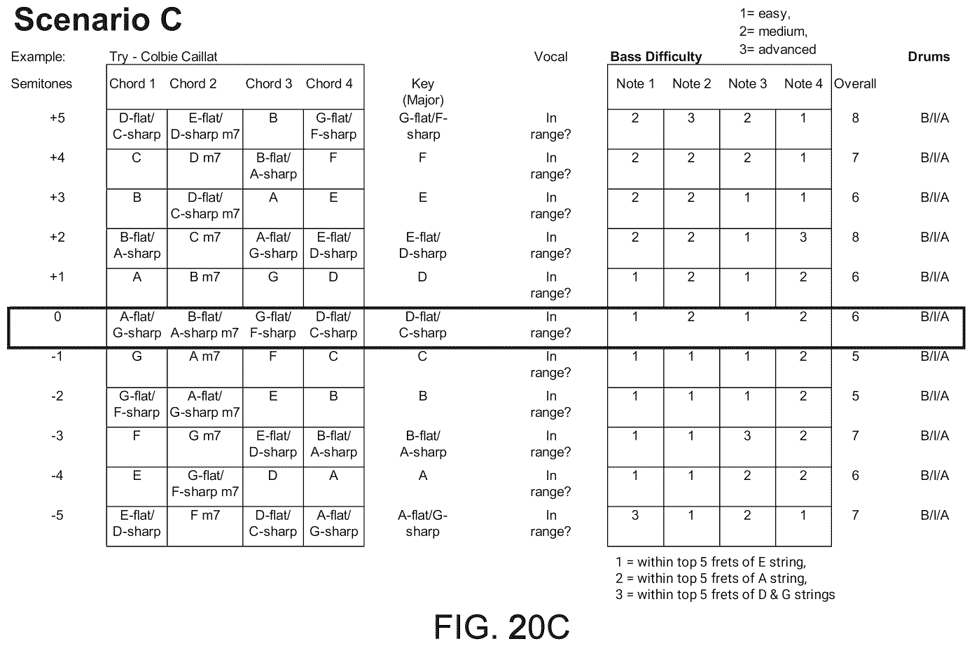

FIGS. 20A-C, 22A-C, 24A-C, 26A-C, 28A-C, 30A-C, 32A-C, 34A-C, 36A-C, and 38A-C are also each specific to a given scenario (C through I) and provide a visual to the commentary given in the preceding figure. Read both figures for a given scenario together to get a fuller picture of what modifications allow the band members to join the band session and receive instructions that are appropriate to their level of proficiency.

FIG. 17 depicts an exemplary combination of modifications and adjustments that the Band Karaoke Platform 299 logic enacts across the system in response to the example song (“Try” by Colbie Caillat) for the proficiency combination indicated in FIG. 16 for Scenario A where all players are highly proficient, in accordance with described embodiments.

This scenario is the baseline case for any song when all players are highly proficient—the musicians play in the key of record. It is the standard experience of practiced musicians when they gather to play music together in a band. No modifications are required to any part of the band because every member is highly skilled and able to perform the part fully.

The rows in the bottom half of the figure enumerate what changes the system enacts for each instrument in the areas of instructions, stem transpositions, and assistive technologies for this scenario.

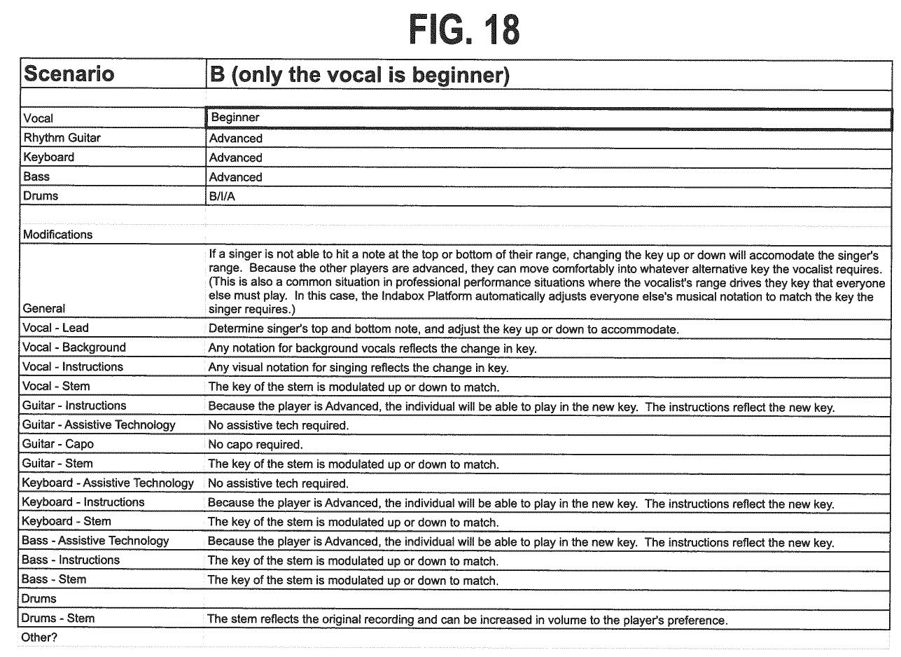

FIG. 18 depicts an exemplary combination of modifications and adjustments that the Band Karaoke Platform 299 logic enacts across the system in response to the example song (“Try” by Colbie Caillat) for the proficiency combination indicated in FIG. 16 for Scenario B where only the vocal is a beginner (or the song is out of range), in accordance with described embodiments.

If a singer is not able to hit a note at the top or bottom of their range, changing the key up or down accommodates the singer's range. Because the other players are advanced, they can move comfortably into whatever alternative key the vocalist requires. (This is also a common situation in professional performance situations where the vocalist's range drives the key that everyone else must play. In this case, the Band Karaoke Platform automatically adjusts everyone else's musical notation to match the key the singer requires.)

The rows in the bottom half of the figure enumerate what changes the system enacts for each instrument in the areas of instructions, stem transpositions, and assistive technologies for this scenario.

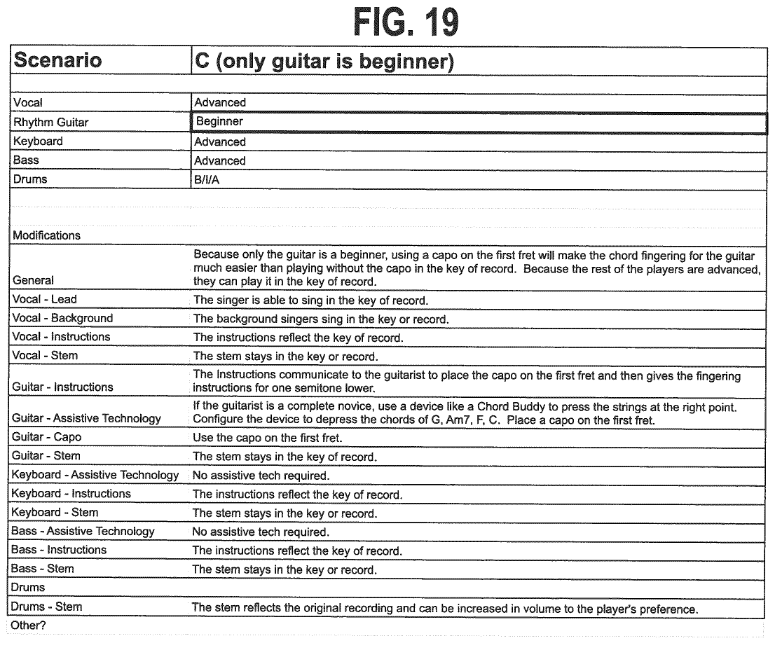

FIG. 19 depicts an exemplary combination of modifications and adjustments that the Band Karaoke Platform 299 logic enacts across the system in response to the example song (“Try” by Colbie Caillat) for the proficiency combination indicated in FIG. 16 for Scenario C where only the guitar is a beginner, in accordance with described embodiments.

Because only the guitar is a beginner, using a capo on the first fret makes the chord fingering for the guitar much easier than playing without the capo in the key of record. Because the rest of the players are advanced, they can play it in the key of record.

The rows in the bottom half of the figure enumerate what changes the system enacts for each instrument in the areas of instructions, stem transpositions, and assistive technologies for this scenario.

FIGS. 20A, 20B and 20C depict an exemplary deconstruction of the example song (“Try” by Colbie Caillat) to illustrate the methods by which the Band Karaoke Platform 299 logic calculates the best fit modifications for a given group of players who possess the proficiency combination indicated in FIG. 16 for Scenario C where only the guitar is a beginner, in accordance with described embodiments.

Because only the guitar is a beginner, using a capo on the first fret makes the chord fingering for the guitar much easier than playing without the capo in the key of record outlined in bold. The note in FIG. 20A “capo in 1st fret” which is outlined in bold indicates this instruction. The cells in the “Rhythm Guitar Difficulty” table in FIG. 20A that are outlined in bold are the chord formations that play the key of record when a capo is placed on the first fret. The difficulty for the guitar player of these chords with a capo in the first fret is significantly less than the player attempting to play without the capo. Because the rest of the players are advanced, they can play it in the key of record.

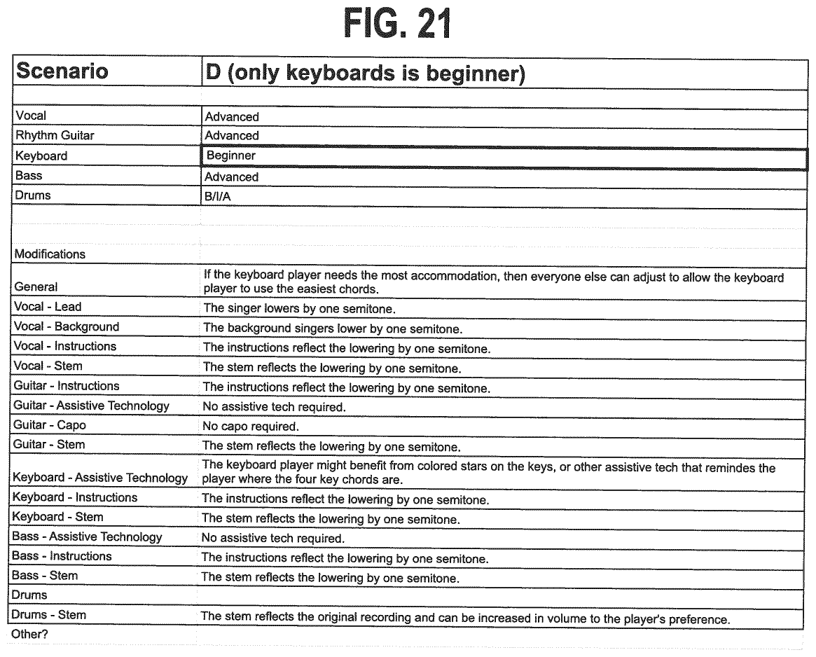

FIG. 21 depicts an exemplary combination of modifications and adjustments that the Band Karaoke Platform 299 logic enacts across the system in response to the example song (“Try” by Colbie Caillat) for the proficiency combination indicated in FIG. 16 for Scenario D where only the keyboard is a beginner, in accordance with described embodiments.

If the keyboard player needs the most accommodation, then everyone else can adjust to allow the keyboard player to use the easiest chords by dropping down one semitone.

The rows in the bottom half of the figure enumerate what changes the system enacts for each instrument in the areas of instructions, stem transpositions, and assistive technologies for this scenario.

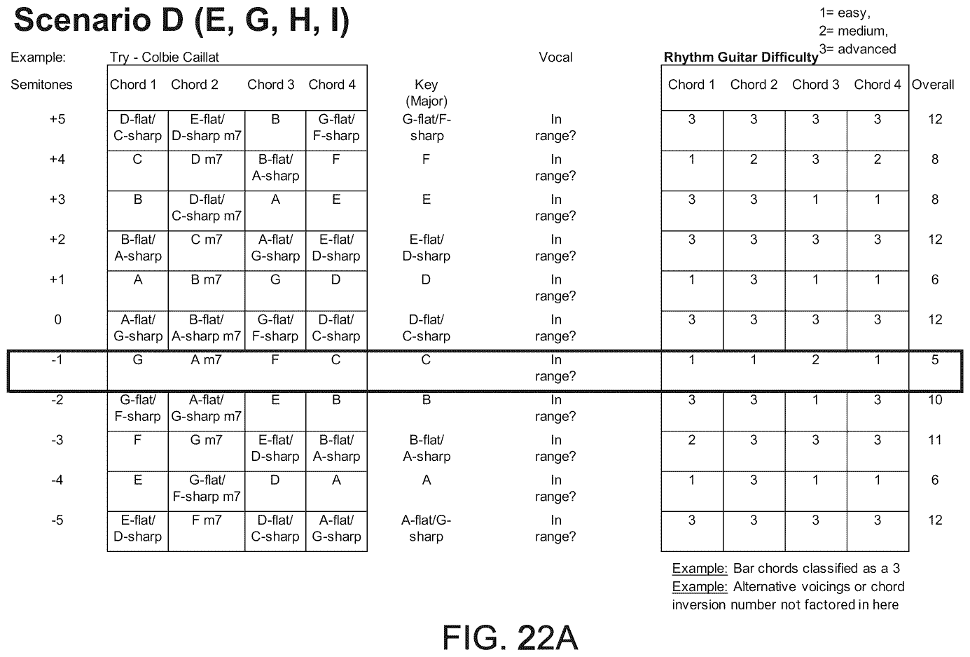

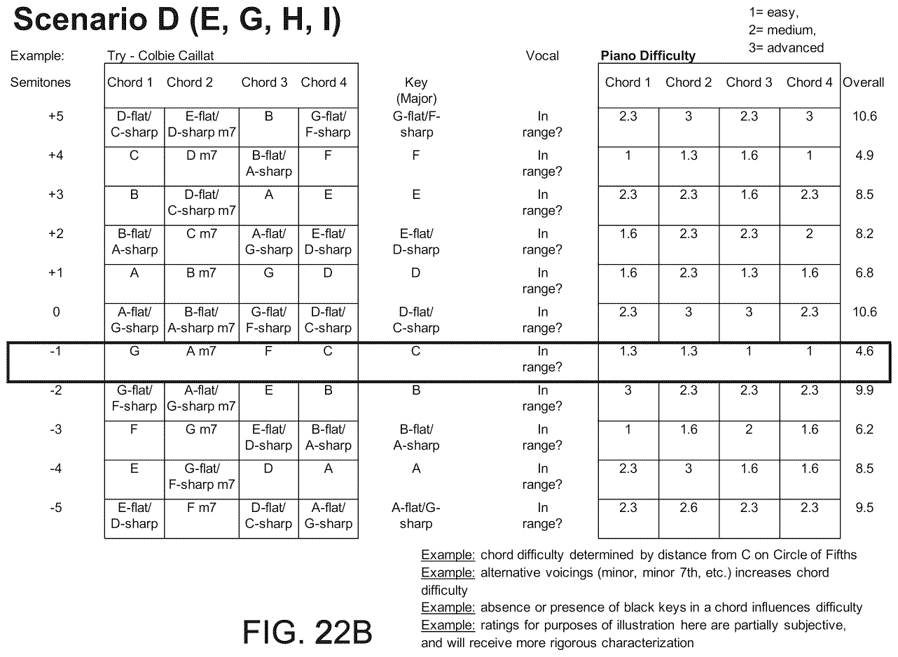

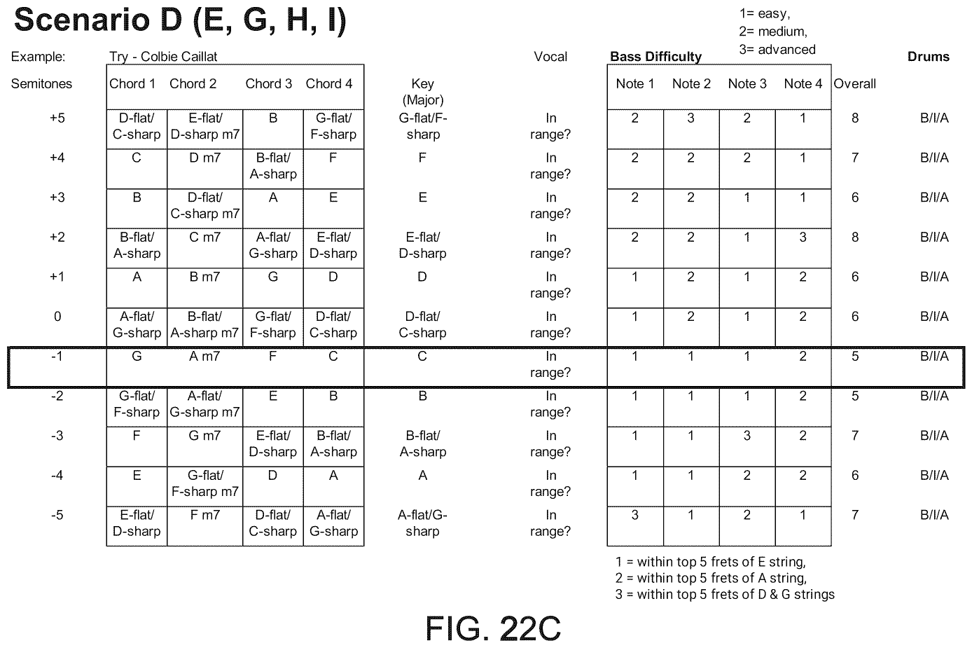

FIGS. 22A, 22B and 22C depict an exemplary deconstruction of the example song (“Try” by Colbie Caillat) to illustrate the methods by which the Band Karaoke Platform 299 logic calculates the best fit modifications for a given group of players who possess the proficiency combination indicated in FIG. 16 for Scenario D where only the keyboard is a beginner, in accordance with described embodiments.

In Scenario D the beginner is on piano. The rest are advanced. If the keyboard player needs the most accommodation, then everyone else can adjust to allow the keyboard player to use the easiest chords.

The row outlined in bold indicates that all players drop the pitch by one semitone. As depicted in FIG. 22A, the overall difficulty rating for the guitar drops from twelve (12) to five (5. As depicted in FIG. 22B, the overall difficulty rating for the piano drops from 10.6 to 4.6. As depicted in FIG. 22C, the overall difficulty rating for the bass drops from six (6) to five (5).

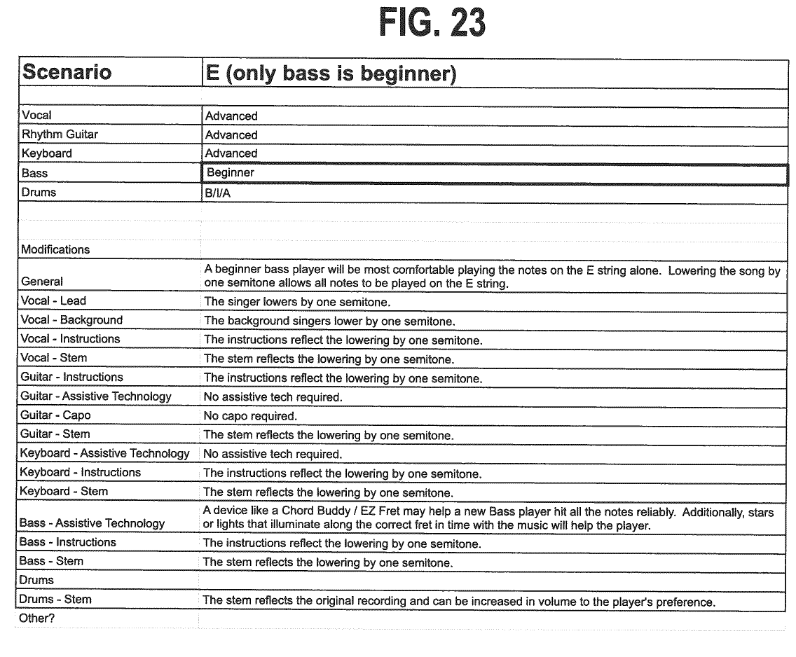

FIG. 23 depicts an exemplary combination of modifications and adjustments that the Band Karaoke Platform 299 logic enacts across the system in response to the example song (“Try” by Colbie Caillat) for the proficiency combination indicated in FIG. 16 for Scenario E where only the bass is a beginner, in accordance with described embodiments.

A beginner bass player is most comfortable playing the notes on the E string alone. Lowering the song by one semitone allows all notes to be played on the E string.

The rows in the bottom half of the figure enumerate what changes the system enacts for each instrument in the areas of instructions, stem transpositions, and assistive technologies for this scenario.

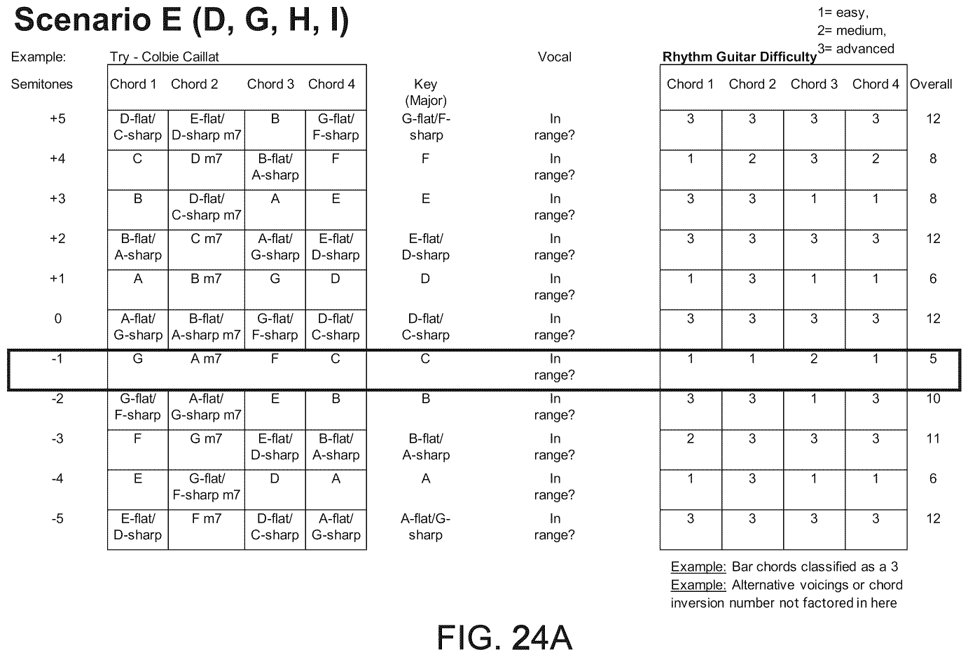

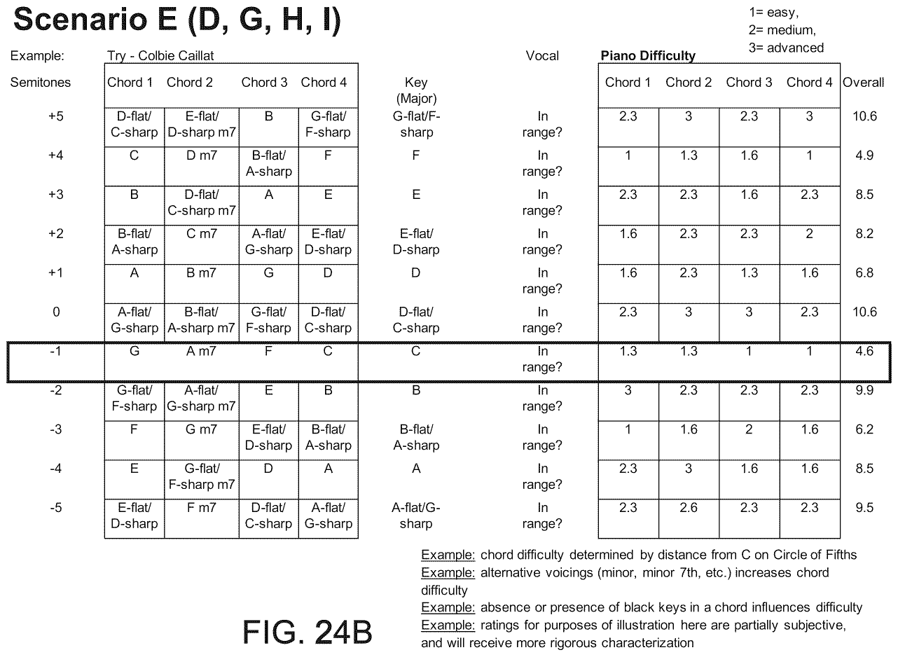

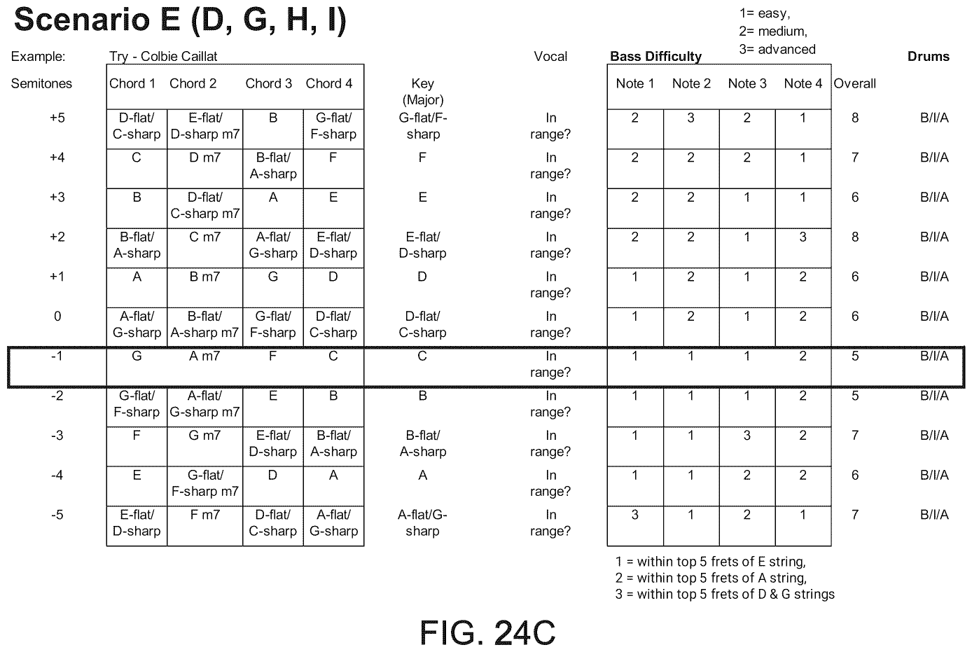

FIGS. 24A, 24B and 24C depict an exemplary deconstruction of the example song (“Try” by Colbie Caillat) to illustrate the methods by which the Band Karaoke Platform 299 logic calculates the best fit modifications for a given group of players who possess the proficiency combination indicated in FIG. 16 for Scenario E where only the bass is a beginner, in accordance with described embodiments.

In Scenario E, the beginner is on bass. The rest are advanced. A beginner bass player is most comfortable playing the notes on the E string alone. Lowering the song by one semitone allows all notes to be played on the E string.

The row outlined in bold indicates that all players drop the pitch by one semitone. As depicted in FIG. 24A, the overall difficulty rating for the guitar drops from twelve (12) to five (5). As depicted in FIG. 24B, the overall difficulty rating for the piano drops from 10.6 to 4.6. As depicted in FIG. 24C, the overall difficulty rating for the bass drops from six (6) to five (5).

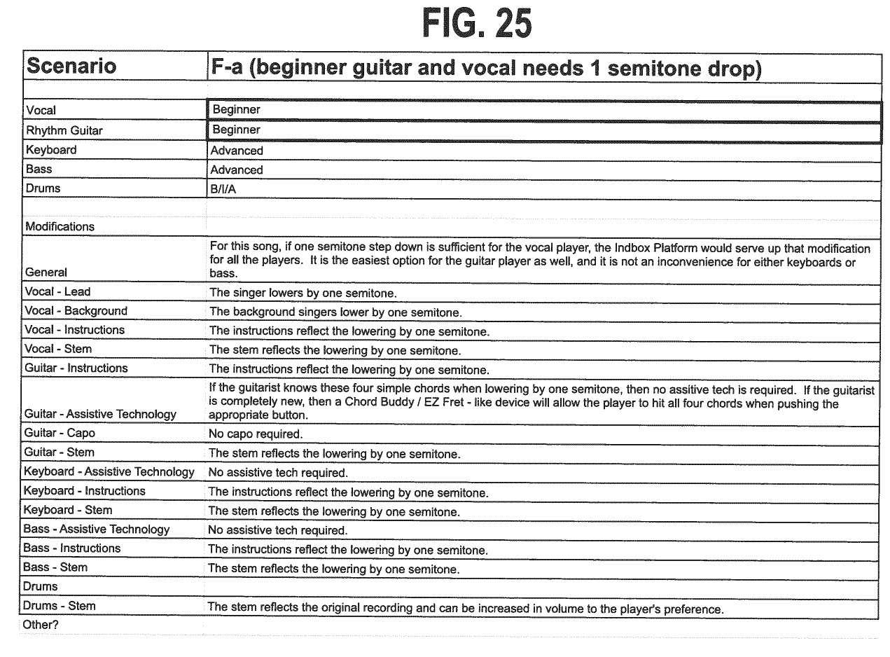

FIG. 25 depicts an exemplary combination of modifications and adjustments that the Band Karaoke Platform 299 logic enacts across the system in response to the example song (“Try” by Colbie Caillat) for the proficiency combination indicated in FIG. 16 for Scenario F-a where the guitar is a beginner and the vocal needs one semitone drop, in accordance with described embodiments.

For this song, if one semitone step down is sufficient for the vocal player, the Indbox Platform serves up that modification for all the players. It is the easiest option for the guitar player as well, and it is not an inconvenience for either keyboards or bass.

The rows in the bottom half of the figure enumerate what changes the system enacts for each instrument in the areas of instructions, stem transpositions, and assistive technologies for this scenario.

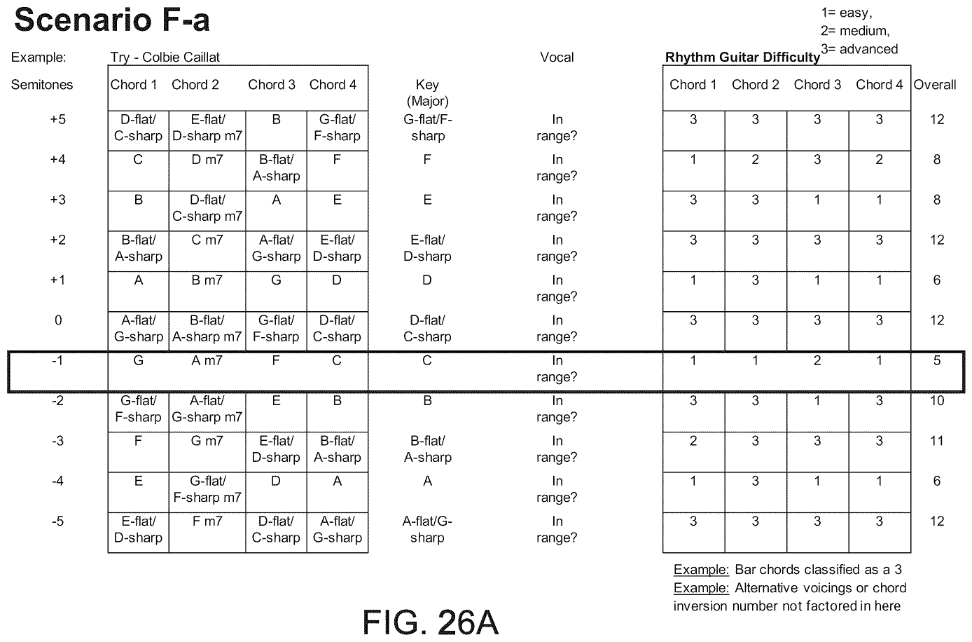

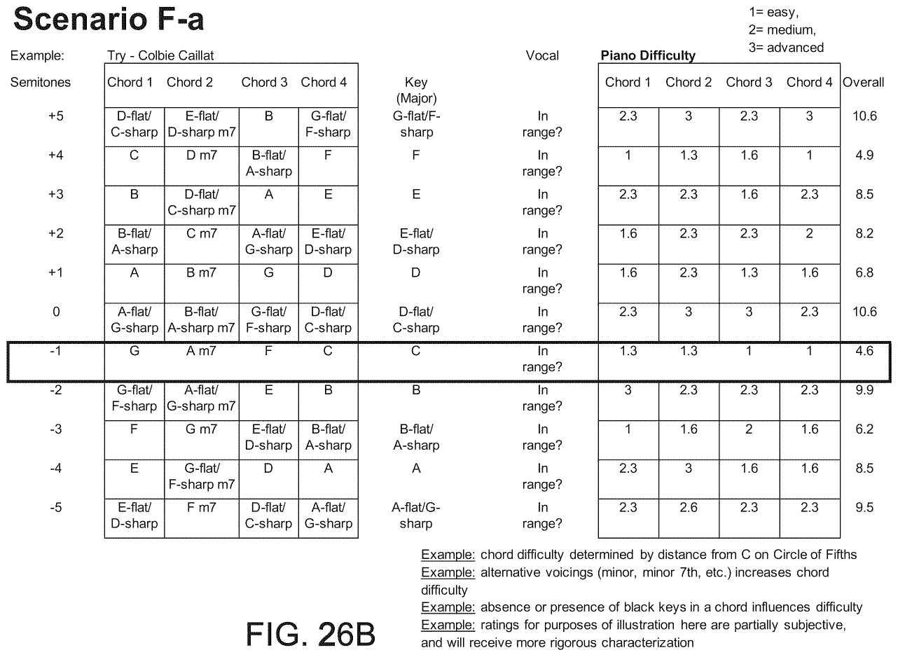

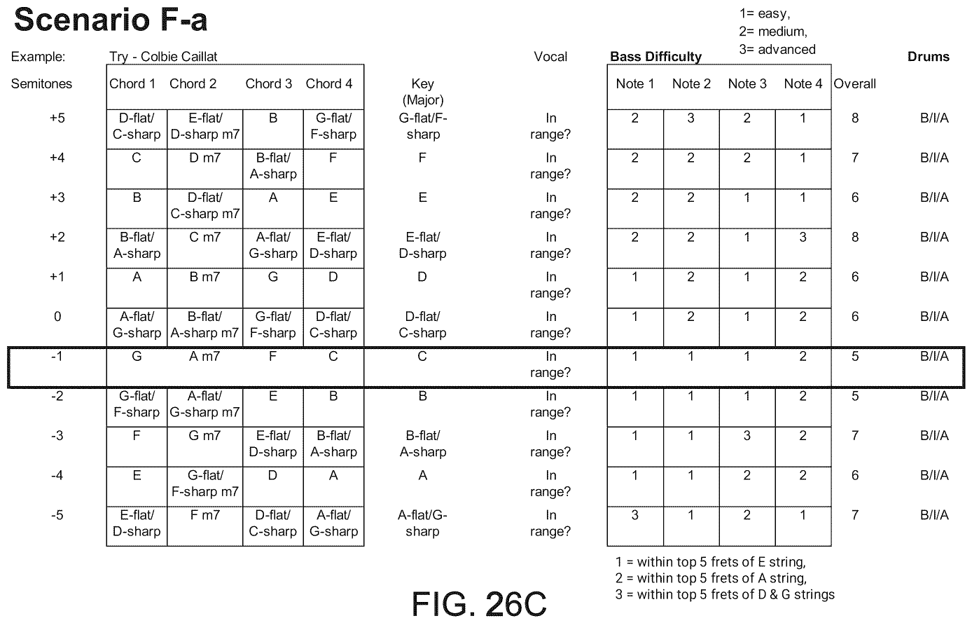

FIGS. 26A, 26B and 26C depict an exemplary deconstruction of the example song (“Try” by Colbie Caillat) to illustrate the methods by which the Band Karaoke Platform 299 logic calculates the best fit modifications for a given group of players who possess the proficiency combination indicated in FIG. 16 for Scenario F-a where the guitar is a beginner and the vocal needs one semitone drop, in accordance with described embodiments.

The row outlined in bold indicates that all players drop the pitch by one semitone. As depicted in FIG. 26A, the overall difficulty rating for the guitar drops from twelve (12) to five (5). As depicted in FIG. 26B, the overall difficulty rating for the piano drops from 10.6 to 4.6. As depicted in FIG. 26C, the overall difficulty rating for the bass drops from six (6) to five (5).

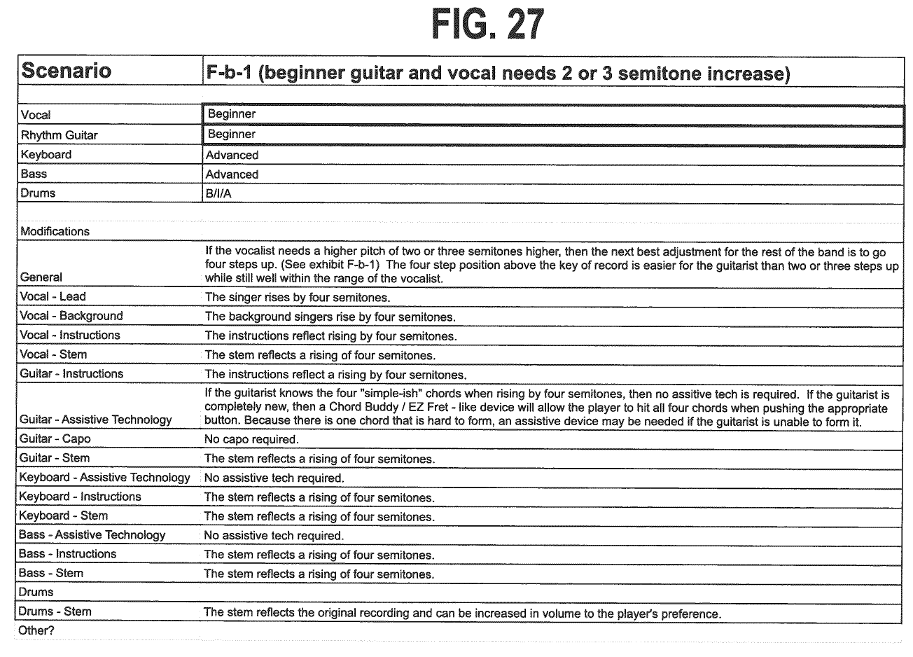

FIG. 27 depicts an exemplary combination of modifications and adjustments that the Band Karaoke Platform 299 logic enacts across the system in response to the example song (“Try” by Colbie Caillat) for the proficiency combination indicated in FIG. 16 for Scenario F-b-1 where the guitar is a beginner and the vocal needs two or three semitone increases, in accordance with described embodiments.

If the vocalist needs a higher pitch of two or three semitones higher, then the next best adjustment for the rest of the band is to go four steps up. (See exhibit F-b-1) The four step position above the key of record is easier for the guitarist than two or three steps up while still well within the range of the vocalist.

The rows in the bottom half of the figure enumerate what changes the system enacts for each instrument in the areas of instructions, stem transpositions, and assistive technologies for this scenario.

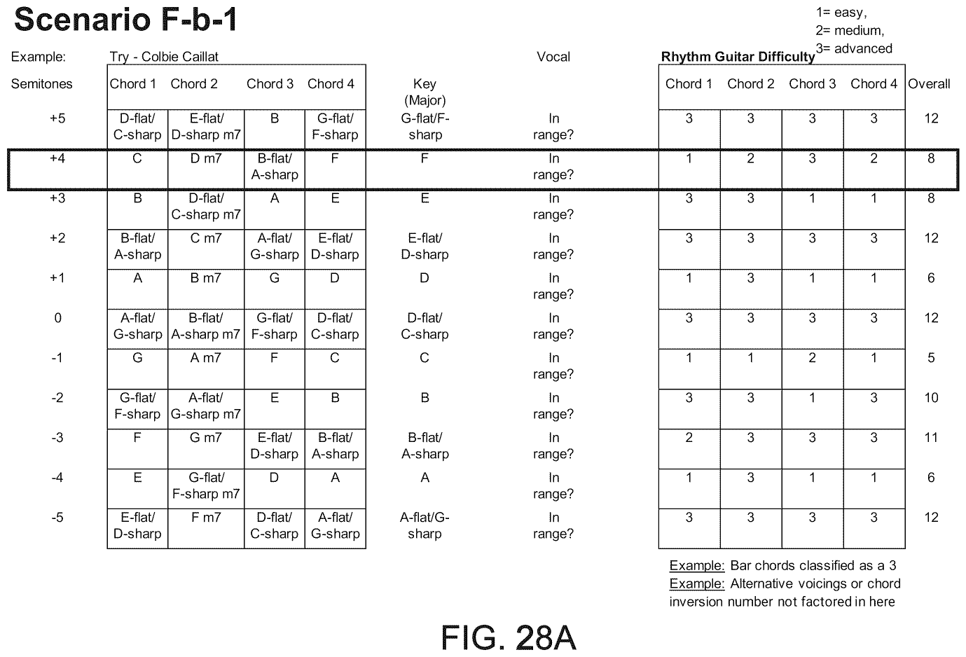

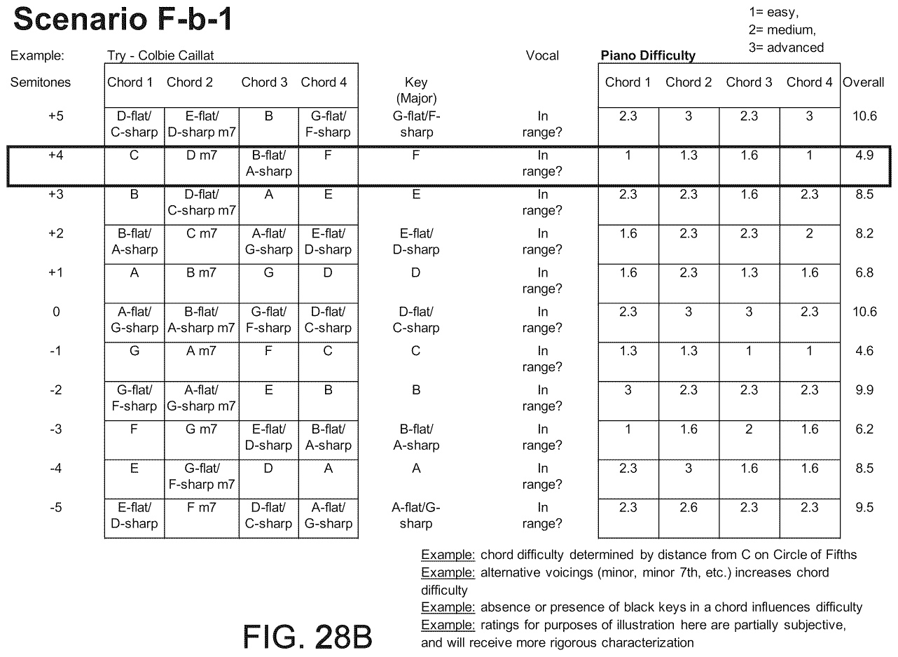

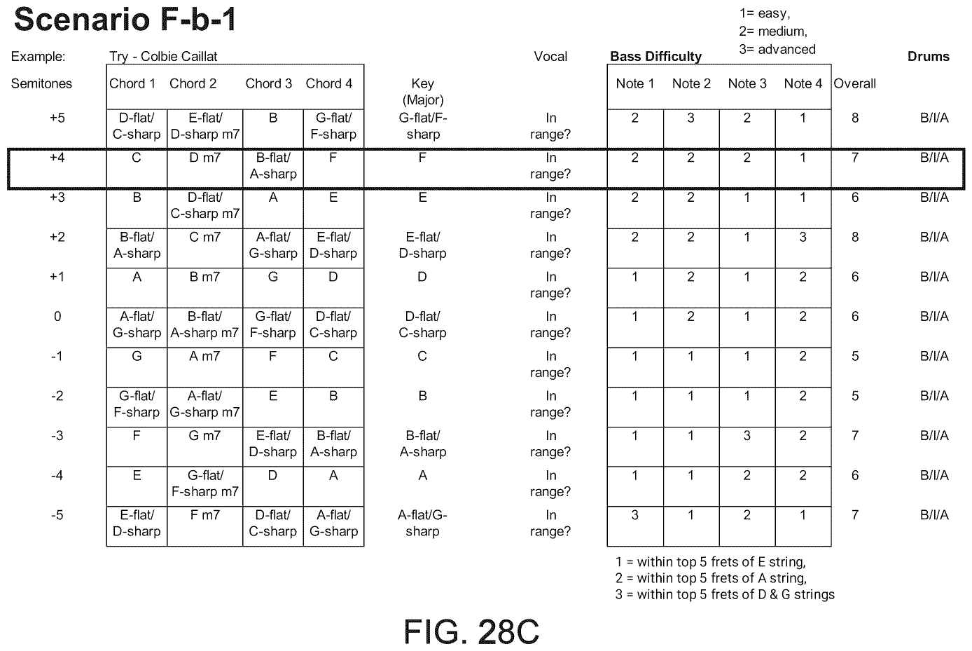

FIGS. 28A, 28B and 28C depict an exemplary deconstruction of the example song (“Try” by Colbie Caillat) to illustrate the methods by which the Band Karaoke Platform 299 logic calculates the best fit modifications for a given group of players who possess the proficiency combination indicated in FIG. 16 for Scenario F-b-1 where the guitar is a beginner and the vocal needs two or three semitone increases, in accordance with described embodiments.

The row outlined in bold represents the adjustments for a shift up in pitch of four semitones. The overall difficulty for the guitar of two (2) semitones shifted up is twelve (12) and three semitones up is eight (8). The overall difficulty of the four (4) semitones shifted up is also eight (8), but closer examination reveals that the four (4) semitone case is preferable for the guitarist than the three (3) semitone case because the three (3) semitone case has two chords of difficulty (3), versus the four (4) semitone case which has only one chord of difficulty three (3).

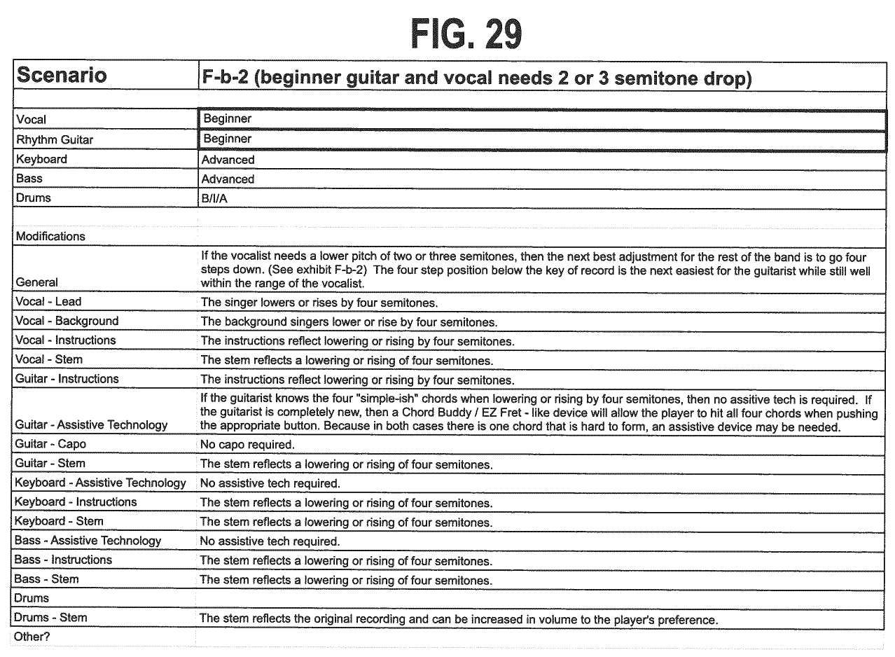

FIG. 29 depicts an exemplary combination of modifications and adjustments that the Band Karaoke Platform 299 logic enacts across the system in response to the example song (“Try” by Colbie Caillat) for the proficiency combination indicated in FIG. 16 for Scenario F-b-2 where the guitar is a beginner and the vocal needs a two or three semitone drop, in accordance with described embodiments.

If the vocalist needs a lower pitch of two or three semitones, then the next best adjustment for the rest of the band is to go four steps down. (See Scenario F-b-2) The four step position below the key of record is the next easiest for the guitarist while still well within the range of the vocalist.

The rows in the bottom half of the figure enumerate what changes the system enacts for each instrument in the areas of instructions, stem transpositions, and assistive technologies for this scenario.

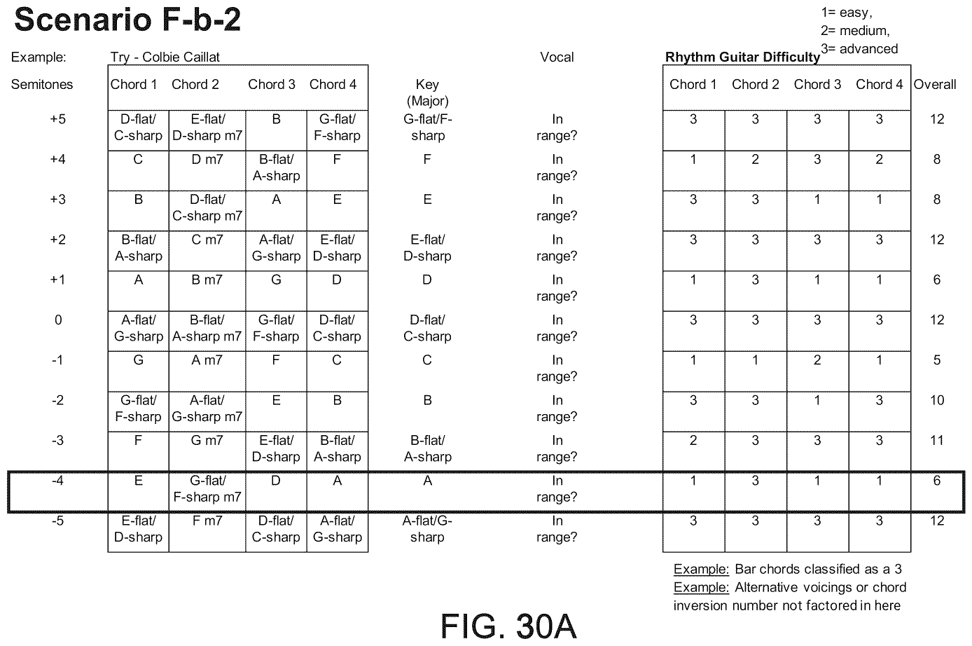

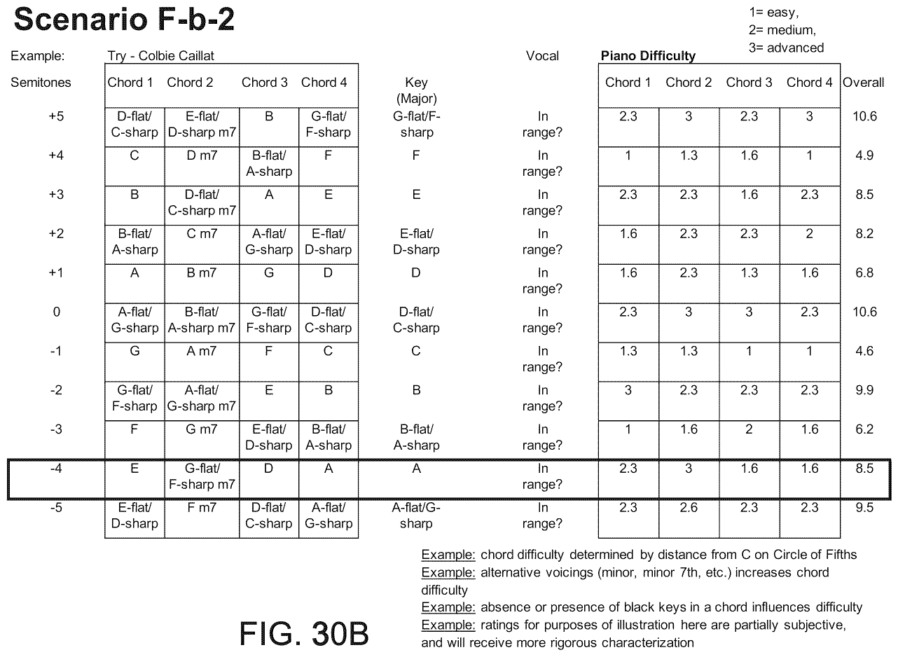

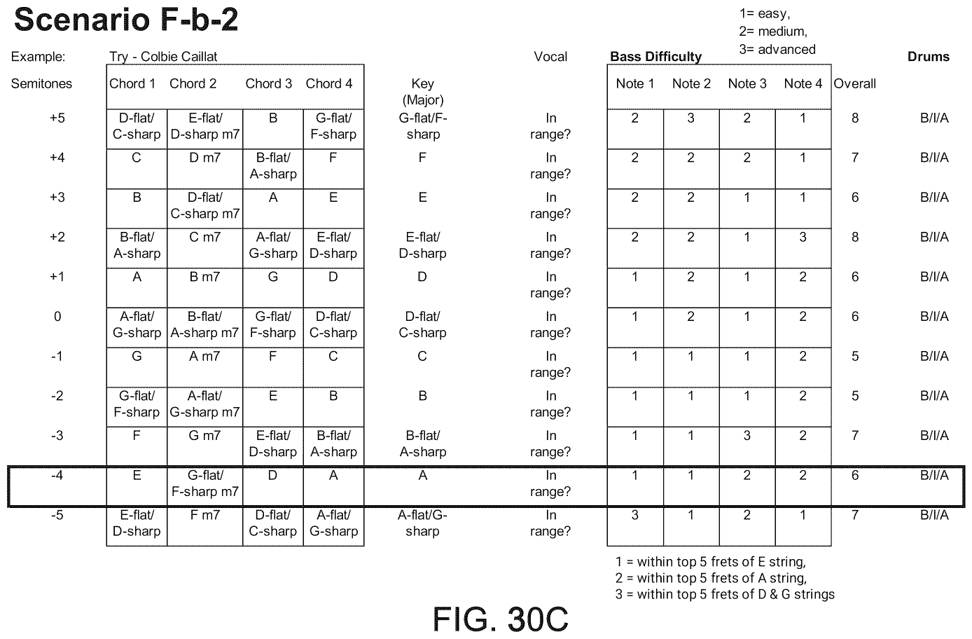

FIGS. 30A, 30B and 30C depict an exemplary deconstruction of the example song (“Try” by Colbie Caillat) to illustrate the methods by which the Band Karaoke Platform 299 logic calculates the best fit modifications for a given group of players who possess the proficiency combination indicated in FIG. 16 for Scenario F-b-2 where the guitar is a beginner and the vocal needs a two or three semitone drop, in accordance with described embodiments.

The row at the negative four (−4) semitone location that is the preferred transposition for Scenario F-b-2 is outlined in bold. As depicted in FIG. 30A, the overall difficulty rating for the guitar drops from twelve (12) to six (6). This is better for the guitar than the −2 semitone row which has an overall difficulty of ten (10) and the −3 semitone row which has an overall difficulty of eleven (11).

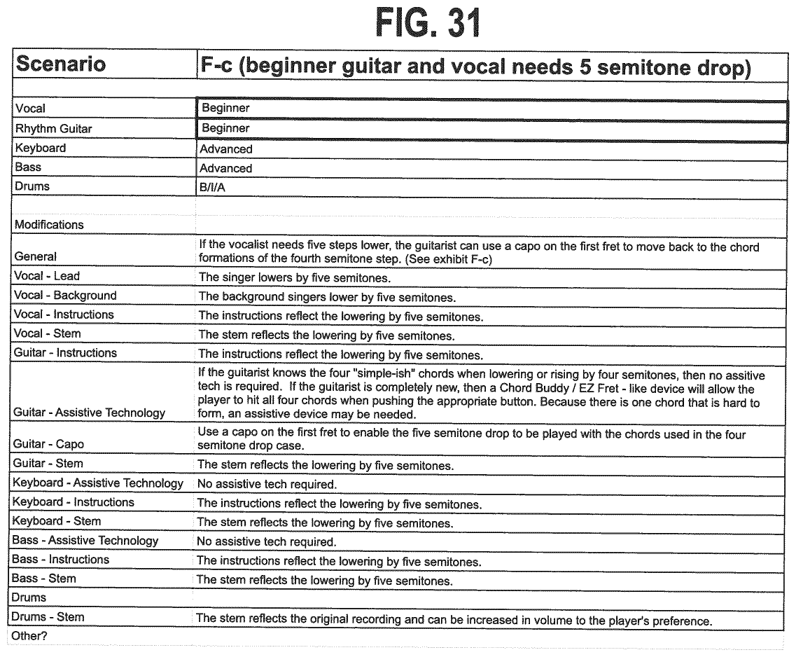

FIG. 31 depicts an exemplary combination of modifications and adjustments that the Band Karaoke Platform 299 logic enacts across the system in response to the example song (“Try” by Colbie Caillat) for the proficiency combination indicated in FIG. 16 for Scenario F-c where the guitar is a beginner and the vocal needs a five semitone drop, in accordance with described embodiments.

If the vocalist needs five steps lower, the guitarist can use a capo on the first fret to move back to the chord formations of the fourth semitone step.

The rows in the bottom half of the figure enumerate what changes the system enacts for each instrument in the areas of instructions, stem transpositions, and assistive technologies for this scenario.

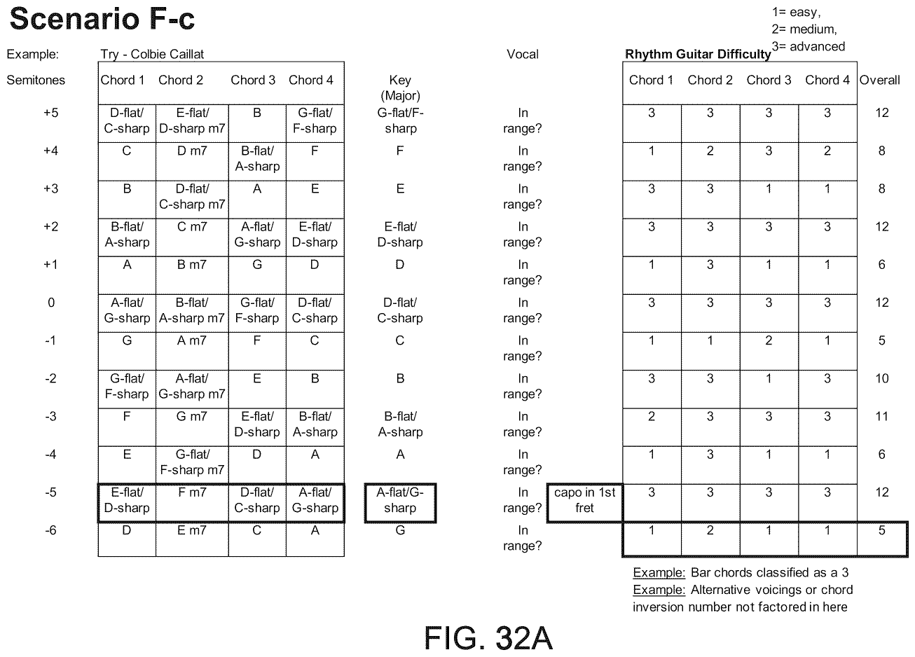

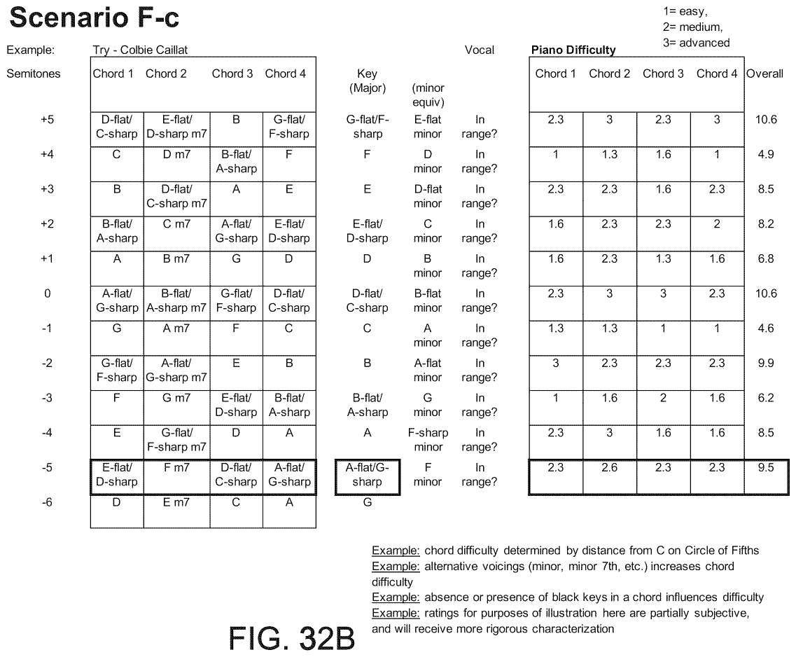

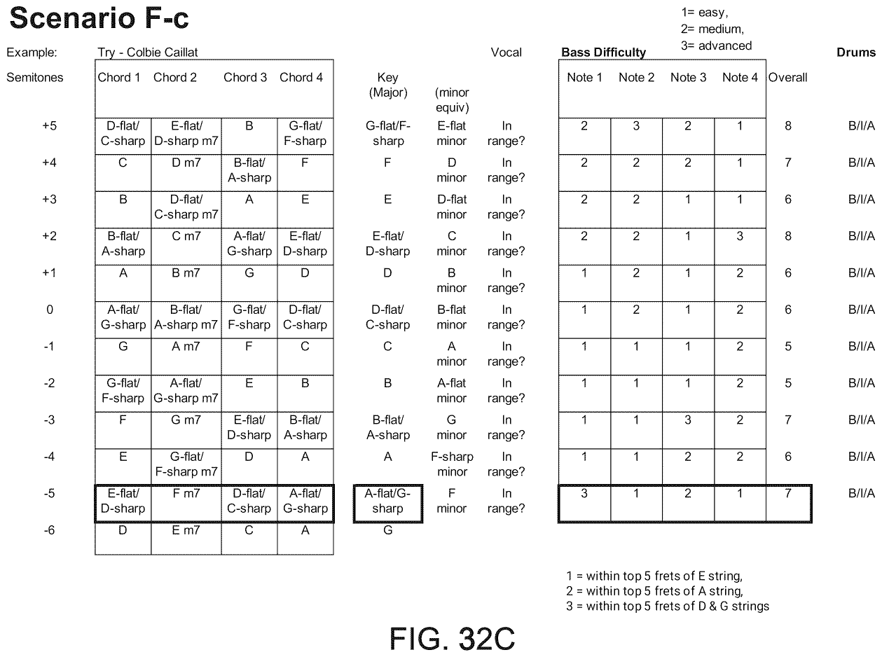

FIGS. 32A, 32B and 32C depict an exemplary deconstruction of the example song (“Try” by Colbie Caillat) to illustrate the methods by which the Band Karaoke Platform 299 logic calculates the best fit modifications for a given group of players who possess the proficiency combination indicated in FIG. 16 for Scenario F-c where the guitar is a beginner and the vocal needs a five semitone drop, in accordance with described embodiments.

The circumstances in Scenario F-c are particularly complex because the singer needs a drop of five semitones down from the key of record. To do this, the guitar nominally finds itself playing four chords of a 3 difficulty that have an overall difficulty rating of 12.

Instead, the guitar can enjoy playing much simpler chord formations on a five semitone drop if the player uses a capo on the first fret and uses the chord formations listed in the −6 semitone line: D, E minor 7, C and A.

The −5 semitone row is outlined in bold, but in FIG. 32A, the guitar has a notation of “capo in 1st fret” on that same row and outlined in bold that allows the chords to be played to be those that appear in the −6 row position. These collectively have an overall difficulty rating of five (5) so they are much easier than the overall difficulty of twelve (12) in row −5. To notate this, the chords of row −6 semitones are outlined in bold in FIG. 32A.

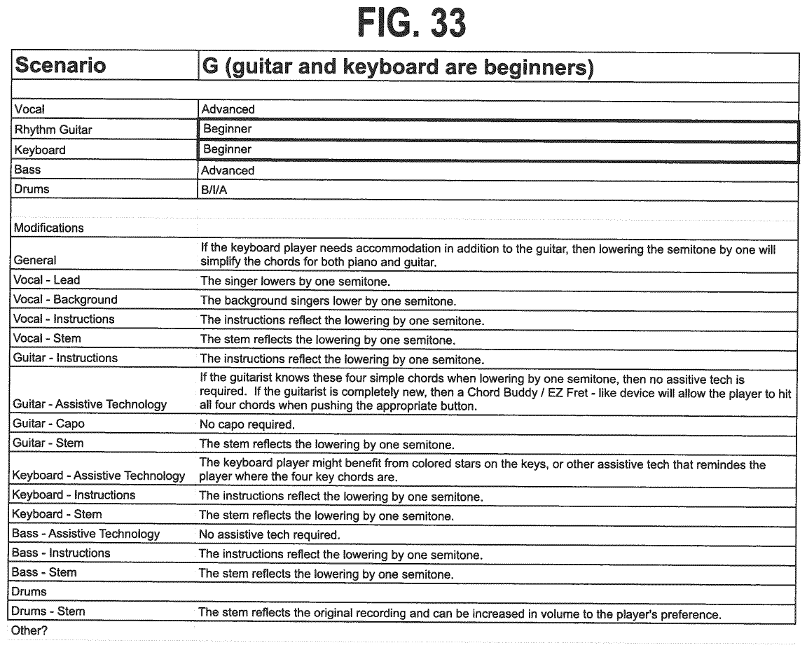

FIG. 33 depicts an exemplary combination of modifications and adjustments that the Band Karaoke Platform 299 logic enacts across the system in response to the example song (“Try” by Colbie Caillat) for the proficiency combination indicated in FIG. 16 for Scenario G where guitar and keyboard are beginners, in accordance with described embodiments.

If the keyboard player needs accommodation in addition to the guitar, then lowering the semitone by one simplifies the chords for both piano and guitar.

The rows in the bottom half of the figure enumerate what changes the system enacts for each instrument in the areas of instructions, stem transpositions, and assistive technologies for this scenario.

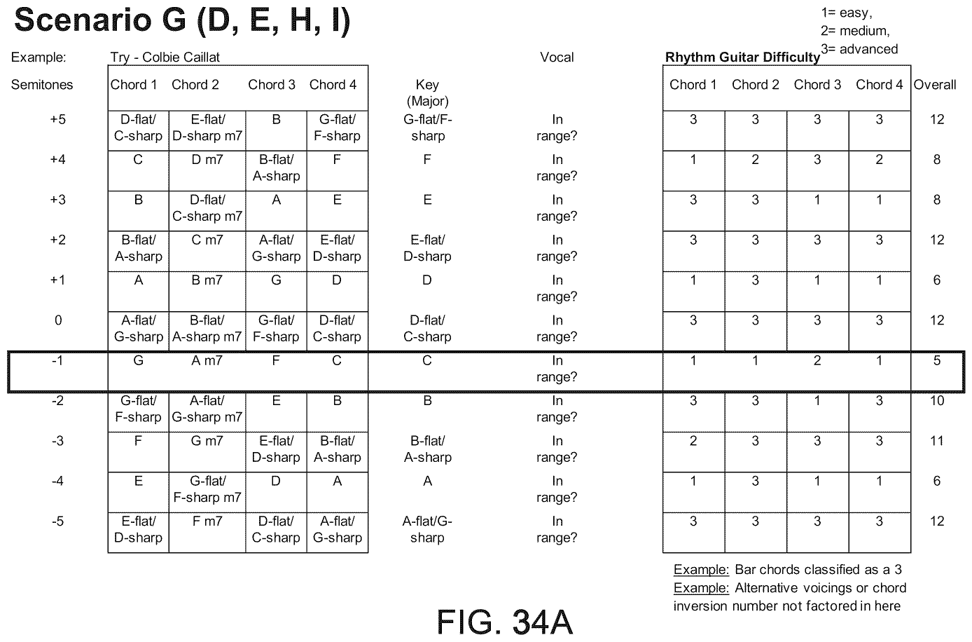

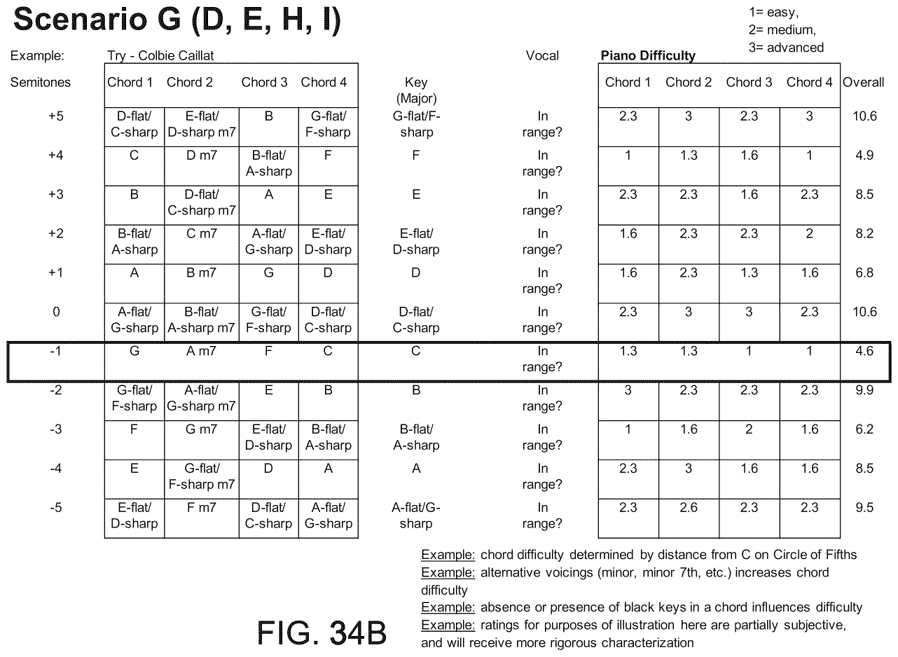

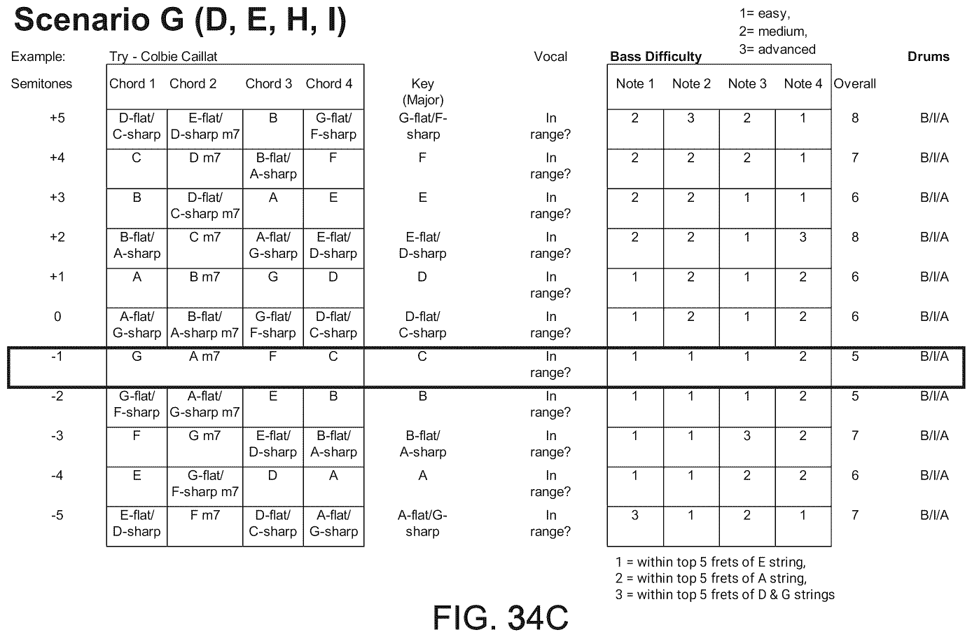

FIGS. 34A, 34B and 34C depict an exemplary deconstruction of the example song (“Try” by Colbie Caillat) to illustrate the methods by which the Band Karaoke Platform 299 logic calculates the best fit modifications for a given group of players who possess the proficiency combination indicated in FIG. 16 for Scenario G where guitar and keyboard are beginners, in accordance with described embodiments.

The row outlined in bold indicates that all players drop the pitch by one semitone. As depicted in FIG. 34A, the overall difficulty rating for the guitar drops from twelve (12) to five (5). As depicted in FIG. 34B, the overall difficulty rating for the piano drops from 10.6 to 4.6. As depicted in FIG. 34C, the overall difficulty rating for the bass drops from six (6) to five (5).

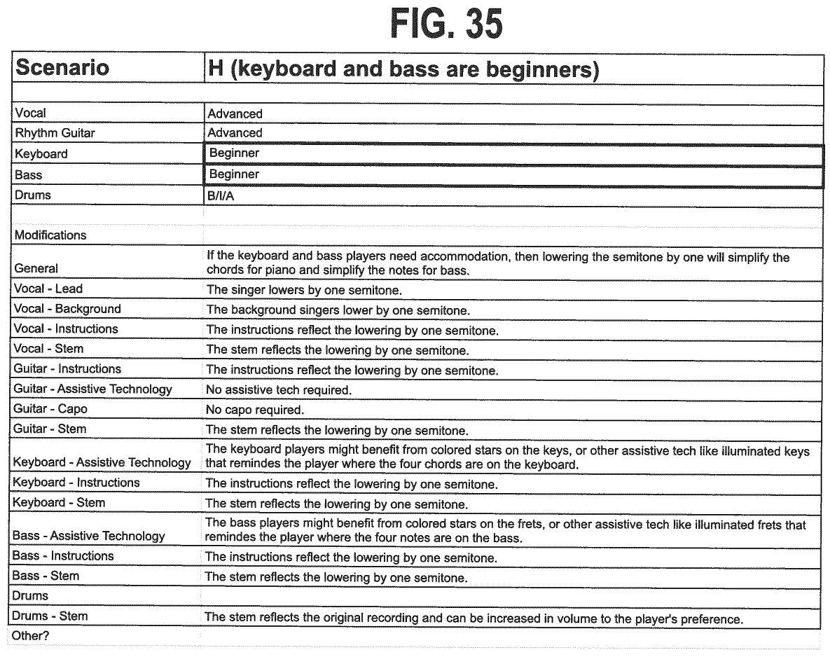

FIG. 35 depicts an exemplary combination of modifications and adjustments that the Band Karaoke Platform 299 logic enacts across the system in response to the example song (“Try” by Colbie Caillat) for the proficiency combination indicated in FIG. 16 for Scenario H where keyboard and bass are beginners, in accordance with described embodiments.

If the keyboard and bass players need accommodation, then lowering the semitone by one simplifies the chords for piano and simplify the notes for bass.

The rows in the bottom half of the figure enumerate what changes the system enacts for each instrument in the areas of instructions, stem transpositions, and assistive technologies for this scenario.

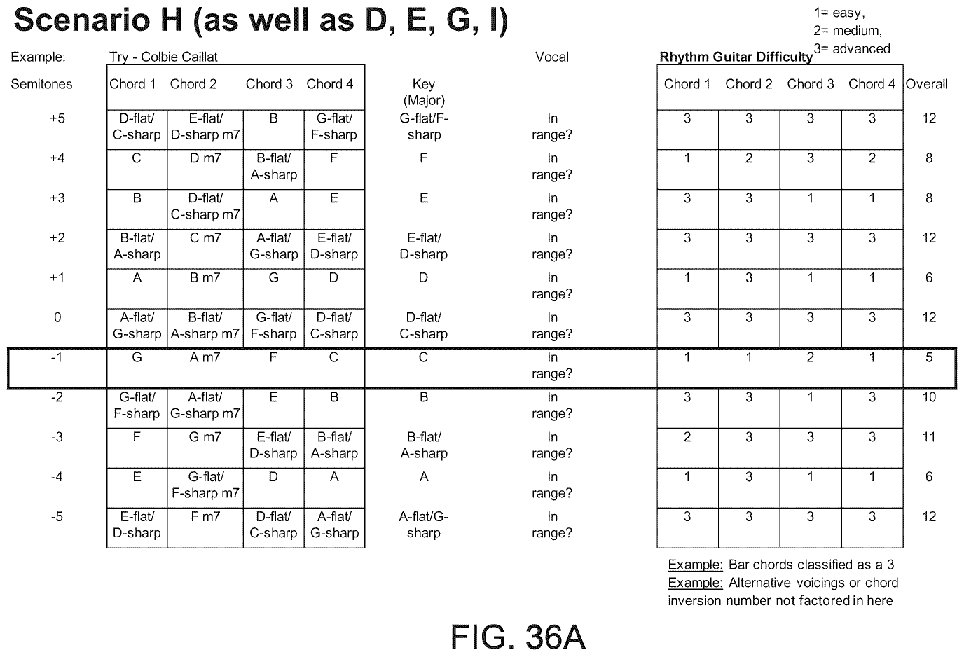

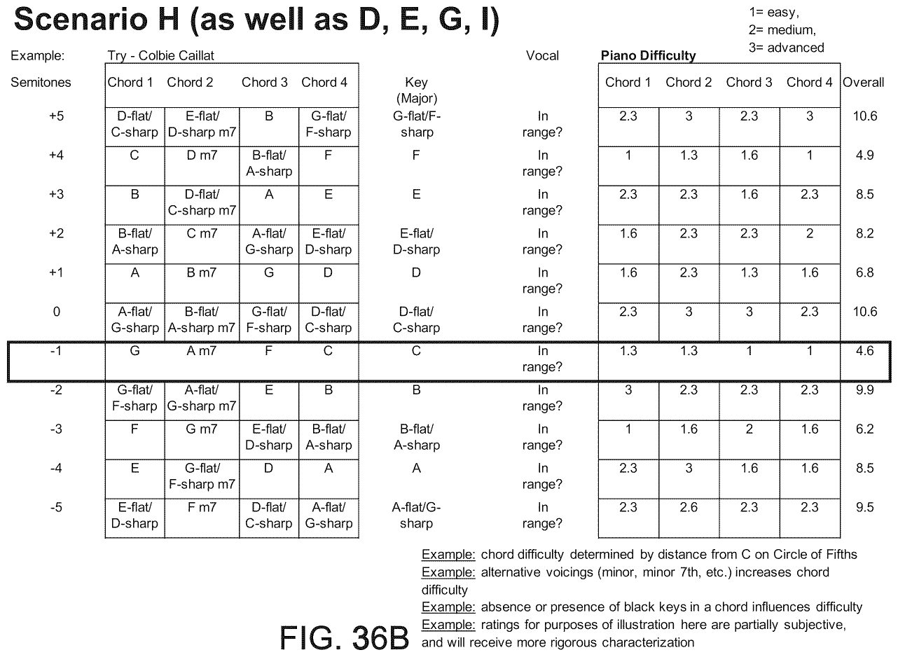

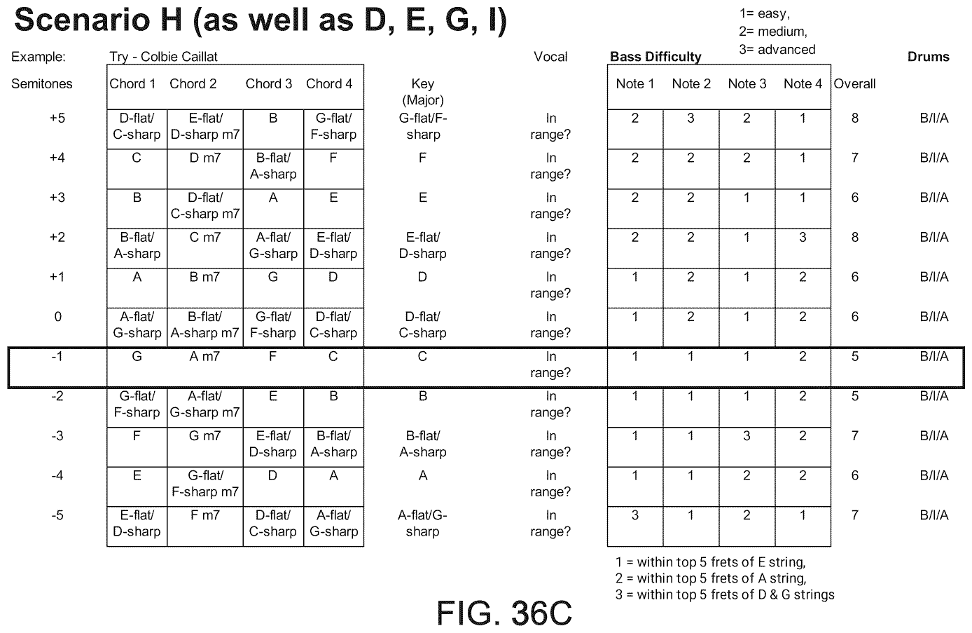

FIGS. 36A, 36B and 36C depict an exemplary deconstruction of the example song (“Try” by Colbie Caillat) to illustrate the methods by which the Band Karaoke Platform 299 logic calculates the best fit modifications for a given group of players who possess the proficiency combination indicated in FIG. 16 for Scenario H where keyboard and bass are beginners, in accordance with described embodiments.

The row outlined in bold indicates that all players drop the pitch by one semitone. As depicted in FIG. 36A, the overall difficulty rating for the guitar drops from twelve (12) to five (5). As depicted in FIG. 36B, the overall difficulty rating for the piano drops from 10.6 to 4.6. As depicted in FIG. 36C, the overall difficulty rating for the bass drops from six (6) to five (5).

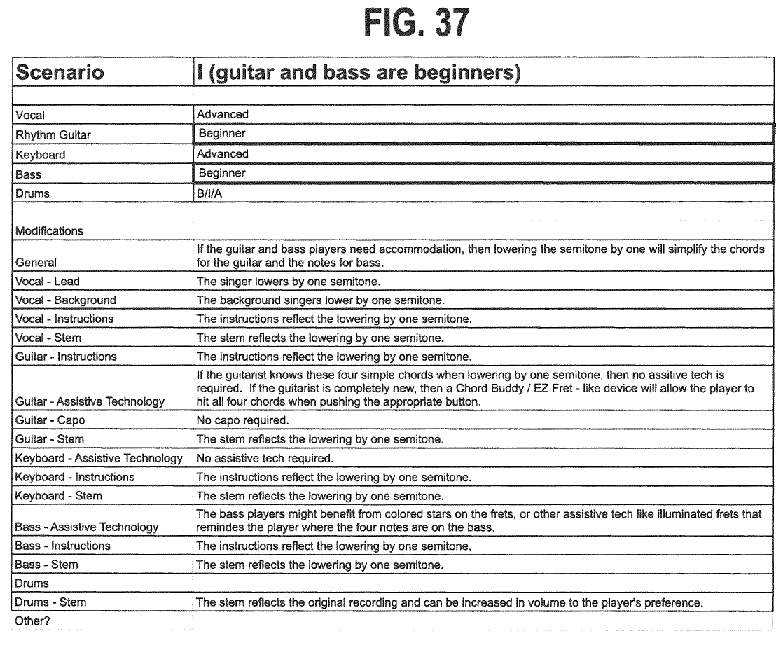

FIG. 37 depicts an exemplary combination of modifications and adjustments that the Band Karaoke Platform 299 logic enacts across the system in response to the example song (“Try” by Colbie Caillat) for the proficiency combination indicated in FIG. 16 for Scenario I where guitar and bass are beginners, in accordance with described embodiments.

If the guitar and bass players need accommodation, then lowering the semitone by one simplifies the chords for the guitar and the notes for bass.

The rows in the bottom half of the figure enumerate what changes the system enacts for each instrument in the areas of instructions, stem transpositions, and assistive technologies for this scenario.

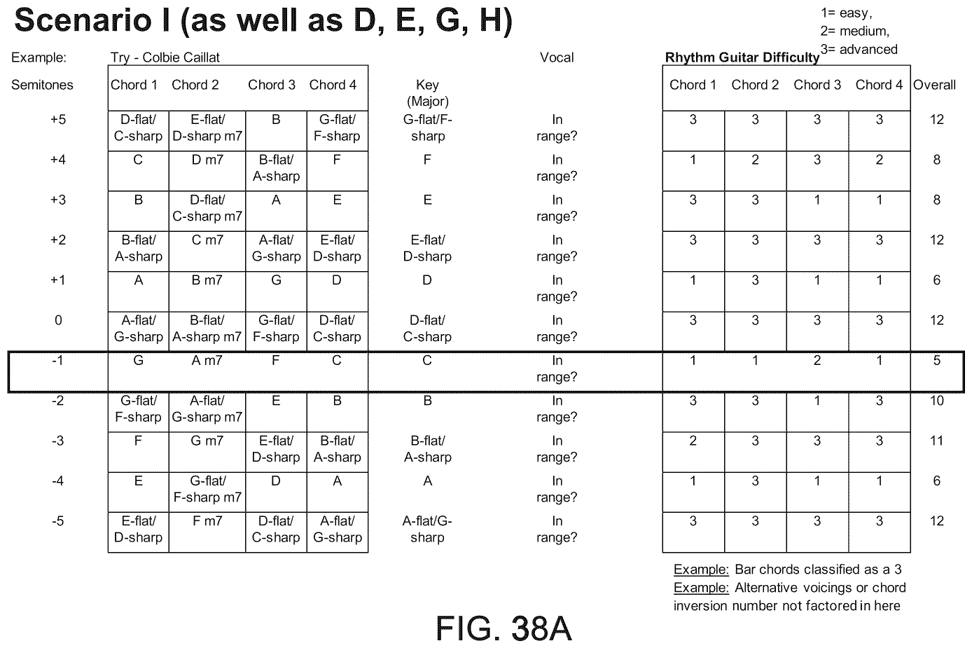

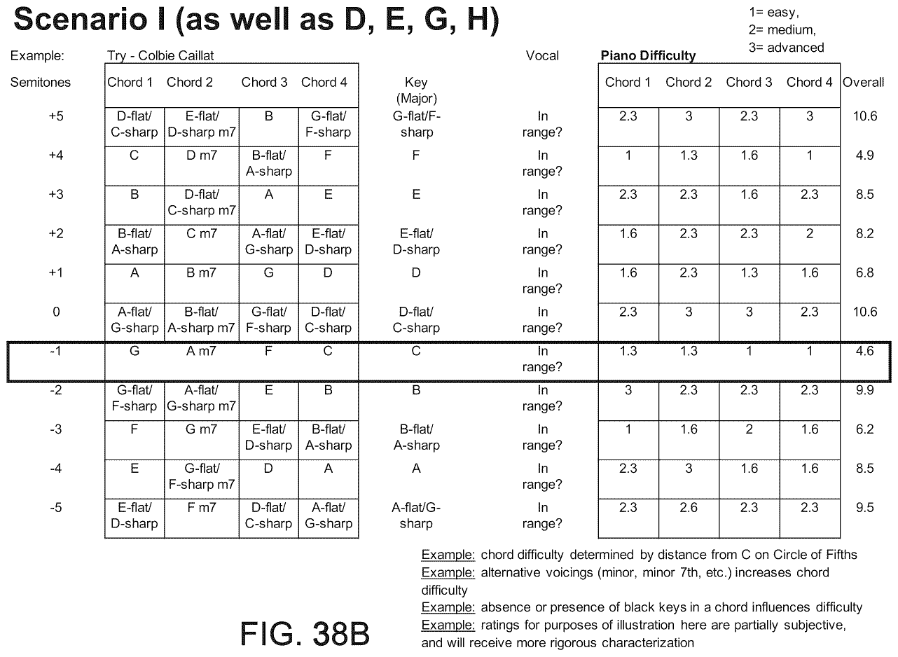

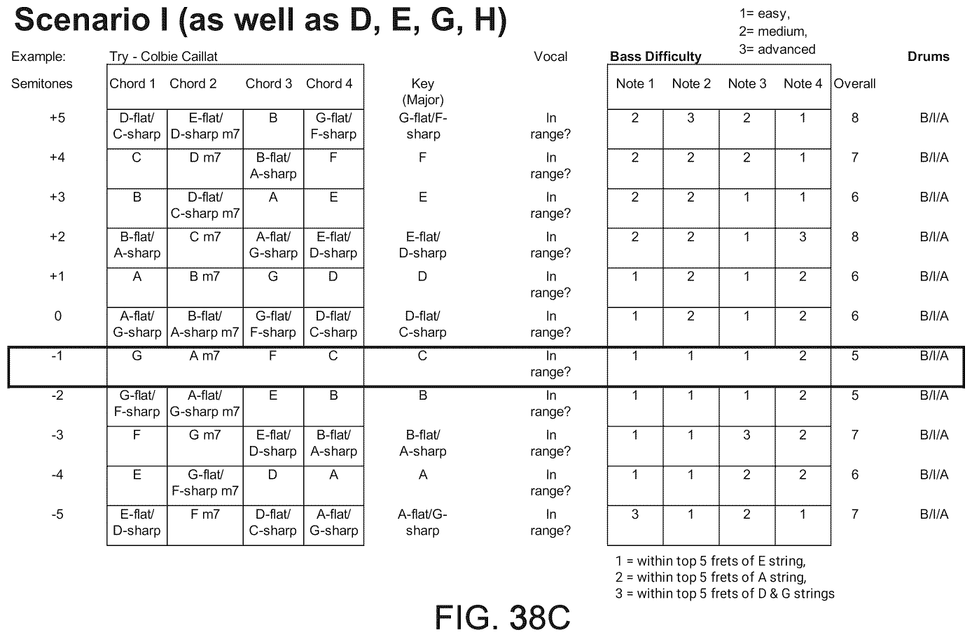

FIGS. 38A, 38B and 38C depict an exemplary deconstruction of the example song (“Try” by Colbie Caillat) to illustrate the methods by which the Band Karaoke Platform 299 logic calculates the best fit modifications for a given group of players who possess the proficiency combination indicated in FIG. 16 for Scenario I where guitar and bass are beginners, in accordance with described embodiments.

The row outlined in bold indicates that all players drop the pitch by one semitone. As depicted in FIG. 38A, the overall difficulty rating for the guitar drops from twelve (12) to five (5). As depicted in FIG. 38B, the overall difficulty rating for the piano drops from 10.6 to 4.6. As depicted in FIG. 38C, the overall difficulty rating for the bass drops from six (6) to five (5).

FIG. 39 depicts an exemplary illustration of how fully produced songs are comprised of separate stems for each part, in accordance with described embodiments.

This image shows a recording of the Stevie Nicks song, “Edge of Seventeen”. As can be seen by the listing of instruments in the lower half of the figure, the instrumentation of the song consists of eight distinct stems: drums, congas, bass, electric guitar (left), electric guitar (right), piano, backing vocals, and lead vocals. These music files can be purchased from a company called karaoke-version.com, but there are many other sources of stems such as these that create a fully produced song when they are mixed together into a single recording like the ones we might hear on the radio.

The purpose of this image is to illustrate that it is standard practice within the industry to record separate stems for each part (instrument) and then mix it together into final fully produced song.

While the subject matter disclosed herein has been described by way of example and in terms of the specific embodiments, it is to be understood that the claimed embodiments are not limited to the explicitly enumerated embodiments disclosed. To the contrary, the disclosure is intended to cover various modifications and similar arrangements apparent to those skilled in the art. Therefore, the scope of the appended claims should be accorded the broadest interpretation to encompass all such modifications and similar arrangements. It is to be understood that the above description is intended to be illustrative, and not restrictive. Many other embodiments will be apparent to those of skill in the art upon reading and understanding the above description. The scope of the disclosed subject matter is therefore to be determined in reference to the appended claims, along with the full scope of equivalents to which such claims are entitled.

What is claimed is:

1. A system comprising:
one or more processors to execute instructions to:
select a level of musical difficulty of a piece of music for each of a plurality of musical instruments or human voices;
generating a musical arrangement of the piece of music including notations for each of the plurality of musical instruments or human voices based on the selected level of music difficulty of the piece of music for each of the plurality of musical instruments or human voices; and
presenting the musical arrangement of the piece of music to a respective plurality of musicians for performing the musical arrangement of the piece of music using the plurality of musical instruments or their human voices.

2. The system of claim 1, further comprising:
a plurality of audio inputs via which to receive in real time a live session of a plurality of a series of sounds produced by the plurality of musical instruments or human voices; and
wherein the one or more processors are coupled to the plurality of audio inputs to execute instructions to receive in real time from the plurality of audio inputs the live session of the plurality of the series of sounds produced by the plurality of musical instruments or human voices.

3. The system of claim 2, wherein the one or more processors coupled to the plurality of audio inputs to execute instructions to select the level of musical difficulty of the piece of music for each of the plurality of musical instruments or human voices, comprises the one or more processors coupled to the plurality of audio inputs to execute instructions to select, based on user input or system detection of, the level of musical difficulty of the piece of music for each of the plurality of musical instruments or human voices.

4. The system of claim 1, wherein the one or more processors is coupled to a plurality of audio inputs to execute instructions to adapt in real time a plurality of the series of sounds produced by the respective plurality of musical instruments or human voices according to the selected level of musical difficulty of the piece of music for each of the plurality of musical instruments or human voices.

5. The system of claim 1, further comprising:
an audio input device coupled to the one or more processors to receive a performance comprising the respective plurality of musicians playing the plurality of musical instruments or singing with their human voices according to the musical arrangement of the piece of music;
the one or more processors further to execute instructions to adjust the performance of the musical arrangement of the piece of music in real time; and
an audio output coupled to the one or more processors to receive therefrom and transmit in real time the adjusted performance of the musical arrangement of the piece of music in real time.

6. The system of claim 1, wherein the one or more processors is coupled to a plurality of audio inputs, wherein the one or more processors that execute instructions to select the level of musical difficulty of the piece of music for each of the plurality of the plurality of musical instruments or human voices, comprises the one or more processors coupled to the plurality of audio inputs to execute instructions to detect in real time a level of musical difficulty of the piece of music for each of a plurality of a series of sounds produced by the plurality of musical instruments or human voices.

7. The system of claim 6, wherein the one or more processors that execute instructions to detect in real time the level of musical difficulty of the piece of music for each of the plurality of the series of sounds produced by the respective plurality of musical instruments or human voices, comprises the one or more processors to execute instructions to detect in real time one or more of musical notes, chords, and skills detected in each of the plurality of the series of sounds produced by the respective plurality of musical instruments or human voices.

8. The system of claim 1, further comprising the one or more processors to execute instructions to:
determine based upon one or more factors including timing, pace, synchronization, tonal quality, pitch, intensity, duration of tones, precision of tone or a deviation from an optimized baseline thereof for each of a plurality of the series of sounds produced by the respective plurality of musical instruments or human voices; and
attribute based thereon the level of musical difficulty of the piece of music for each of the plurality of the series of sounds produced by the respective plurality of musical instruments or human voices.

9. The system of claim 1, further comprising the one or more processors to execute
instructions to:
generate in real time instructions for playing each of the respective plurality of musical instruments or guiding human voices corresponding to the musical arrangement of the piece of music; and
transmit in real time the instructions for playing each of the respective plurality of musical instruments or guiding human voices corresponding to the musical arrangement of the piece of music to one or more display devices accessible to users producing the plurality of series of sounds.

10. The system of claim 9, wherein the one or more processors to execute instructions to generate in real time instructions for playing each of the respective plurality of musical instruments or guiding the human voices corresponding to the musical arrangement of the piece of music, comprises the one or more processors to execute instructions to generate in real time instructions for playing each of the respective plurality of musical instruments or guiding the human voices based on the level of musical difficulty of the piece of music selected for each of the plurality of the series of sounds produced by the respective plurality of musical instruments or human voices.

11. The system of claim 9, further comprising:
the one or more display devices to display in real time the instructions for playing each of the respective plurality of musical instruments or guiding human voices corresponding to the musical arrangement of the piece of music; and
the plurality of audio inputs to receive in real time a subsequent plurality of a series of sounds produced by the respective plurality of musical instruments or human voices as instructed by the instructions for playing each of the respective plurality of musical instruments or guiding human voices corresponding to the musical arrangement of the piece of music.

12. The system of claim 9, wherein the one or more processors to execute instructions to generate in real time instructions for playing each of the plurality of musical instruments or guiding human voices corresponding to the musical arrangement of the piece of music, comprises the one or more processors to execute instructions to generate in real time one or more of classic clef instructions, tablature instructions, key diagram instructions, fret diagram instructions, color diagram instructions, or combinations thereof, for playing each of the plurality of musical instruments or guiding human voices corresponding to the musical arrangement of the piece of music.

13. The system of claim 1, further comprising the one or more processors to execute instructions to activate an assistive aid or technology on at least one of the plurality of musical instruments or for a human voice responsive to the musical arrangement of the piece of music and the selected level of musical difficulty of the piece of music for each of the plurality of the series of sounds produced by the plurality of musical instruments or human voices.

14. The system of claim 1, wherein the one or more processors to execute instructions to adapt in real time a plurality of a series of sounds produced by the plurality of musical instruments or human voices according to the selected level of musical difficulty of the piece of music for each of the plurality of the series of sounds produced by the plurality of musical instruments or human voices.

15. The system of claim 14, wherein the one or more processors to execute instructions to adapt in real time the plurality of the series of sounds produced by the plurality of musical instruments or human voices according to the selected level of musical difficulty of the piece of music for each of the plurality of the series of sounds produced by the plurality of musical instruments or human voices, comprises the one or more processors to execute instructions to adjust one or more of a volume, a pitch, a tone, a key, and a pace of one or more of the plurality of the series of sounds produced by the plurality of musical instruments or human voices according to the selected level of musical difficulty of the piece of music for each of the plurality of the series of sounds produced by the plurality of musical instruments or human voices.

16. The system of claim 14, wherein the one or more processors to execute instructions to adapt in real time the plurality of the series of sounds produced by the plurality of musical instruments or human voices according to the selected level of musical difficulty of the piece of music for each of the plurality of the series of sounds produced by the plurality of musical instruments or human voices, comprises the one or more processors to execute instructions to adapt in real time the plurality of the series of sounds produced by the plurality of musical instruments or human voices further according to one of a song, an instrument, or both, being played during the live session.

17. The system of claim 1, further comprising:
an audio input device coupled to the one or more processors to receive a performance comprising the respective plurality of musicians playing the plurality of musical instruments or singing with their human voices according to the musical arrangement of the piece of music;
the one or more processors further to execute instructions to select a volume of the performance for at least one of the plurality of musicians playing a respective one of the plurality of musical instruments or singing with their human voice according to the musical arrangement of the piece of music; and
an audio output coupled to the one or more processors to receive therefrom and transmit the selected volume of the performance for the at least one of the plurality of musicians playing the respective one of the plurality of musical instruments or singing with their human voice according to the musical arrangement of the piece of music.

18. The system of claim 17, further comprising:
the one or more processors further to execute instructions to mix with a playback of a corresponding original soundtrack of the piece of music the selected volume of the performance for at least one of the plurality of musicians playing the respective one of the plurality of musical instruments or singing with their human voice according to the musical arrangement of the piece of music; and
wherein the audio output coupled to the one or more processors to receive therefrom and transmit the selected volume of the performance for the at least one of the plurality of musicians playing the respective one of the plurality of musical instruments or singing with their human voice according to the musical arrangement of the piece of music, comprises the audio output coupled to the one or more processors to receive therefrom and transmit the mix of the playback of the corresponding original soundtrack of the piece of music and the selected volume of the performance for at least one of the plurality of musicians playing the respective one of the plurality of musical instruments or singing with their human voice according to the musical arrangement of the piece of music.

19. The system of claim 17, further comprising:
an interface to receive user or machine input to select the volume of the performance for at least one of the plurality of musicians playing the respective one of the plurality of musical instruments or singing with their human voice according to the musical arrangement of the piece of music; and
wherein the one or more processors further to execute instructions to select the volume of the performance for at least one of the plurality of musicians playing the respective one of the plurality of musical instruments or singing with their human voice according to the musical arrangement of the piece of music, comprises the one or more processors further to execute instructions to select the volume of the performance for at least one of the plurality of musicians playing the respective one of the plurality of musical instruments or singing with their human voice according to the musical arrangement of the piece of music, responsive to the user or machine input to select the volume of the performance for at least one of the plurality of musicians playing the respective one of the plurality of musical instruments or singing with their human voice according to the musical arrangement of the piece of music.

20. The system of claim 19, further comprising:
the one or more processors further to execute instructions to mix with a playback of a corresponding original soundtrack of the piece of music the selected volume of the performance for at least one of the plurality of musicians playing the respective one of the plurality of musical instruments or singing with their human voice according to the musical arrangement of the piece of music, responsive to the user or machine input to select the volume of the performance for at least one of the plurality of musicians playing the respective one of the plurality of musical instruments or singing with their human voice according to the musical arrangement of the piece of music; and
wherein the audio output coupled to the one or more processors to receive therefrom and transmit the selected volume of the performance for the at least one of the plurality of musicians playing the respective one of the plurality of musical instruments or singing with their human voice according to the musical arrangement of the piece of music, comprises the audio output coupled to the one or more processors to receive therefrom and transmit the mix of the playback of the corresponding original soundtrack of the piece of music and the selected volume of the performance for at least one of the plurality of musicians playing the respective one of the plurality of musical instruments or singing with their human voice according to the musical arrangement of the piece of music.

21. The system of claim 1, further comprising:
the one or more processors that calculates or reads chords and notes for the piece of music for a plurality of instruments and human voices in the corresponding original soundtrack of the piece of music.

22. The system of claim 1, further comprising:
the one or more processors that calculates chords and notes for the corresponding original soundtrack of the piece of music and several semitones above and below the key of record for a the plurality of instruments and human voices in the corresponding original soundtrack of the piece of music.

23. The system of claim 1, further comprising:
the one or more processors that calculates the difficulty level of chords and notes of the original soundtrack of the piece of music and chords and notes for each transposition of the original soundtrack of the piece of music at each calculated semitone above and below the original key of record.

24. The system of claim 1, further comprising:
the one or more processors that calculates a best match between the skill or difficulty level of the plurality of players of musical instruments and human voices and the difficulty level of the original soundtrack of the piece of music and each of the different semitones above and below the original key or record.

25. The system of claim 1, further comprising:
the one or more processors that selects a transposition and/or an arrangement of an original soundtrack of the piece of music that best matches a skill level of the plurality of players of musical instruments and human voices as the best fit transposition and/or arrangement.

26. The system of claim 25, further comprising:
the one or more processors that displays a corresponding notation of the selected transposition and/or arrangement of the piece of music that relates to the selected best fit transposition and/or arrangement to the plurality of players of musical instruments and human voices.

27. The system of claim 26, further comprising:
the one or more processors that synchronizes the display of the notation of the selected best fit transposition and/or arrangement of the piece of music to the plurality of players of musical instruments and human voices so that they are in time with each of the other plurality of players musical instruments and human voices and the playback of the original soundtrack of the piece of music.
